(19) United States
(12) Patent Application Publication
(10) Pub. No.: US 2025/0332974 A1
(43) Pub. Date: Oct. 30, 2025

(54) VEHICLE SEAT

(71) Applicant: TS TECH CO., LTD., Asaka-shi, Saitama (JP)

(72) Inventors: Minako OYA, Shioya-gun, Tochigi (JP); Jinichi TANABE, Shioya-gun, Tochigi (JP); Naoya MATSUMOTO, Shioya-gun, Tochigi (JP); Akira MIYOSHI, Shioya-gun, Tochigi (JP); Takuya OZAKI, Shioya-gun, Tochigi (JP); Takuya HARA, Shioya-gun, Tochigi (JP); Takatoshi MURAKAMI, Shioya-gun, Tochigi (JP)

(21) Appl. No.: 18/695,707

(22) PCT Filed: Sep. 27, 2022
(86) PCT No.: PCT/JP2022/035931

§ 371 Date: Oct. 14, 2024

Related U.S. Application Data
(60) Provisional application No. 63/249,668, filed on Sep. 29, 2021.
(60) Provisional application No. 63/262,100, filed on Oct. 5, 2021.
(60) Provisional application No. 63/253,158, filed on Oct. 7, 2021.
(60) Provisional application No. 63/279,285, filed on Nov. 15, 2021.
(60) Provisional application No. 63/288,745, filed on Dec. 13, 2021.

(30) Foreign Application Priority Data
Jan. 17, 2022 (JP) 2022005053
Jan. 17, 2022 (JP) 2022145159
Sep. 16, 2022 (JP) 2022148385
Sep. 19, 2022 (JP) 2022148656

(51) Int. Cl. B60N 2/90; A47C 7/72; B60N 2/68

(52) U.S. Cl. CPC B60N 2/90; A47C 7/727; B60N 2/68

(57) ABSTRACT

[Task] In a vehicle seat, to efficiently transmit vibration to a seated person and to suppress generation of abnormal noise caused by transmission of vibration of a vibration generating device to a seat frame.

[Solution] A vehicle seat 1 includes: left and right side frames 26 extending vertically; an upper frame 27 extending laterally and connecting upper end portions of the side frames to each other; a wire member 51 attached to one of the side frames and to the upper frame; a plate member 52 connected to the wire member and provided with a support surface 58; and a device 41 supported by the support surface.

### TECHNICAL FIELD

The present invention relates to a vehicle seat.

### BACKGROUND ART

Sometimes an in-vehicle member is built in a vehicle seat to improve the comfort of the occupant. As such a vehicle seat, there is known a vehicle seat having a speaker mounted to the seatback frame (for example, Patent Document 1).

### PRIOR ART DOCUMENT(S)

### Patent Document

Patent Document 1: JP2008-92989A

### SUMMARY OF THE INVENTION

### Task to be Accomplished by the Invention

The speaker of Patent Document 1 is fixed to the seatback frame by a support wire. Therefore, there is a problem that it is necessary to change the shape of the support wire in accordance with the shape of the speaker. Also, there is a problem that the mounting of the speaker is cumbersome.

In view of the foregoing background, an object of the present invention is to provide a vehicle which can allow various devices to be mounted thereto and facilitates the mounting of the devices.

### Means to Accomplish the Task

To achieve the above object, one aspect of the present invention is a vehicle seat (1), comprising: left and right side frames (26) extending vertically; an upper frame (27) extending laterally and connecting upper end portions of the side frames to each other; a wire member (51) attached to one of the side frames and to the upper frame; a plate member (52) connected to the wire member and provided with a support surface (58); and a device (41) supported by the support surface.

According to this aspect, various devices can be mounted to the vehicle seat and the mounting of the devices can be facilitated.

In the above aspect, preferably, the plate member is disposed forward of the upper frame and closer to a center of the seat than the one of the side frames is in a left-right direction.

According to this aspect, the device can be compactly disposed in the seat.

In the above aspect, preferably, the wire member is attached to a front portion of the one of the side frames and to a lower portion of the upper frame.

According to this aspect, the device can be compactly disposed in the seat.

In the above aspect, preferably, the plate member is disposed to be spaced from the one of the side frames and the upper frame.

According to this aspect, it is possible to make the device less likely to interfere with the one of the side frames and the upper frame.

In the above aspect, preferably, the wire member and the plate member are formed integrally.

According to this aspect, the number of assembly steps for the device can be reduced.

In the above aspect, preferably, the wire member is welded to the one of the side frames and to the upper frame.

According to this aspect, the wire member can be reliably fixed to the one of the side frames and to the upper frame.

In the above aspect, preferably, the wire member includes a first part (54A) extending from the one of the side frames toward the center of the seat in the left-right direction, a second part (54B) extending forward from the upper frame, and a bent part (55) formed by connection between the first part and the second part, and the plate member is attached to an upper portion of the bent part at a surface thereof opposite from the support surface.

According to this aspect, the plate member is supported by the bent part. Therefore, the plate member can be easily.

In the above aspect, preferably, the support surface is slanted forward and toward the one of the side frames in the left-right direction.

According to this aspect, the device can be disposed to be inclined forward and outward of the seat in the left-right direction.

In the above aspect, preferably, the vehicle seat comprises a pad (23) supported by the side frames and the upper frame, and a skin material (24) covering the pad, wherein the pad has a first hole (71) opened at an upper portion thereof and formed to extend downward, the skin material has a second hole (72) formed in a position corresponding to the first hole in a front-rear direction and the left-right direction, and at least a part of the device is inserted in the first hole and the second hole.

According to this aspect, the device can be mounted in the pad of the seat.

In the above aspect, preferably, the device comprises a speaker (60), a sound absorbing member (62), and a case (61) accommodating the speaker and the sound absorbing member therein and attached to the plate member, and the sound absorbing member is disposed between the speaker and the case.

According to this aspect, it is possible to make the vibration from the speaker less likely to be transmitted to the side frame and the upper frame.

In the above aspect, preferably, the vehicle seat comprises another wire member (51) attached to another of the side frames and to the upper frame; another plate member (52) connected to the wire member and provided with a support surface; and another device (41) supported by the support surface.

According to this aspect, the speakers can be disposed on both of the left and right sides.

A patent document (JP2014-205445A) discloses a door trim provided with a trim holding means that contacts a door inner panel. This trim holding means includes a seat part integrally formed on the back side of the door trim in a protruding manner and a spring part integrally molded to the tip of the seat part and capable of bending deformation.

With the above trim holding means, it is necessary to simultaneously provide the seat part (protruding part) and the spring part (elastic piece) on the door trim. Therefore, there is a problem that the shape of the door inner panel becomes complex, which makes it difficult to manufacture the door inner panel.

One aspect of the present invention is an interior component (101) to be provided on an inboard side of an exterior component (P) of a vehicle, the interior component comprising: a main body (102) having an outer surface (102A) configured to oppose the exterior component via a predetermined gap; a protruding part (122) provided on the outer surface (102A) to protrude toward the exterior component; and an elastic piece (124) protruding from a part of the outer surface of the main body adjacent to the protruding part to extend beyond a top of the protruding part, wherein at least one of the elastic piece and the protruding part is formed as a separate member from the main body and is joined to the main body via a locking structure (132, 162, 172, 179, 182, 191, 194, 197).

According to this aspect, it is possible to configure the interior component by forming at least one of the protruding part and the elastic piece separately from the main body and thereafter locking the at least one of the elastic piece and the protruding part to the main body. Therefore, compared to the case where the elastic piece and the protruding part are integrally molded to the main body, the configuration of the main body can be simplified, and thus, it is possible to provide an interior component that is easy to manufacture.

In the above aspect, preferably, the locking structure includes a columnar body (134) protruding from the outer surface of the main body, and a base portion (136) provided on a base end side of the at least one of the elastic piece and the protruding part, wherein the base portion is provided with a locking hole (146) into which the columnar body protrudes in a lockable manner.

According to this aspect, a locking structure for easily joining at least one of the elastic piece and the protruding part to the main body can be provided.

In the above aspect, preferably, each of the columnar body and the locking hole has a non-circular cross section, and the base portion is displaceable, by rotation relative to the columnar body, between a position where the columnar body is loosely fitted in the locking hole and a position where the columnar body is in pressure contact with a wall surface defining the locking hole so that the base portion is frictionally engaged with the columnar body.

According to this aspect, by rotating the base portion about the axis of the columnar body, the columnar body comes into pressure contact with the wall surface defining the locking hole so that the base portion is frictionally engaged with the columnar body. Therefore, a locking structure that can allow easy assembly of at least one of the elastic piece and the protruding part to the main body can be configured.

In the above aspect, preferably, the columnar body includes a main part (138) protruding from the outer surface of the main body and multiple ribs (140) extending out from an outer circumferential surface of the main part in a direction perpendicular to the outer circumferential surface, wherein the locking hole includes a central part (148) for receiving the main part and multiple wing parts (150) extending outward from a periphery of the central part such that each wing part receives one of the ribs.

According to this aspect, the ribs enhance the stiffness of the columnar body.

In the above aspect, preferably, each of the columnar body and the locking hole is rotationally symmetric about a corresponding axis, and a distance from the axis of the locking hole to at least a part of a wall surface defining each wing part is smaller than a distance from the corresponding axis of the columnar body to a protruding end surface of each rib.

According to this aspect, when the columnar body is inserted into the locking hole and the base portion is rotated about the axis of the columnar body, the wall surface defining each wing part comes into pressure contact with the extension end of one of the ribs, whereby the base portion is frictionally engaged with the columnar body. Thus, a locking structure for easily joining at least one of the elastic piece and the protruding part to the main body can be provided with a simple configuration.

In the above aspect, preferably, the protruding end surface of each rib is inclined in a direction away from the outer circumferential surface of the main part as the protruding end surface extends toward the main body.

According to this aspect, when the base portion is moved toward the main body, the wall surface defining each wing part and the extension end of one of the ribs come into pressure contact with each other more firmly. Thus, by moving the base portion toward the main body, it is possible to make the base portion frictionally engaged with the main body more firmly. Also, the base portion can be engaged with the columnar body at a part of the columnar body positioned closer to the main body, and therefore, the base portion can be supported by the main body more firmly.

In the above aspect, preferably, the wing parts are provided in positions avoiding a region (R) connecting the axis with a base end portion of the at least one of the elastic piece and the protruding part.

According to this aspect, the at least one of the elastic piece and the protruding part can be joined to a part of the base portion that is not thinned by the locking hole, and thus, the at least one of the elastic piece and the protruding part can be firmly joined to the base portion.

In the above aspect, preferably, the base portion is displaceable, by movement along a protruding direction of the columnar body, between a position where the columnar body is loosely fitted in the locking hole and a position where the columnar body is frictionally engaged with the wall surface defining the locking hole.

According to this aspect, a locking structure for easily joining at least one of the elastic piece and the protruding part to the main body can be provided with a simple structure.

In the above aspect, preferably, the locking structure includes a columnar body (134) protruding from the outer surface of the main body, and a base portion (176) provided on a base end side of the at least one of the elastic piece and the protruding part, wherein a protruding end surface of the columnar body is provided with an engagement recess (138A) that is recessed toward the main body, and the base portion is provided with an engagement part (178) protruding into the engagement recess and frictionally engaged with a wall surface defining the engagement recess.

According to this aspect, a locking structure for easily joining at least one of the elastic piece and the protruding part to the main body can be configured with a simple structure.

In the above aspect, preferably, the interior component is disposed on an inboard side of a door panel (P) as the exterior component and forms at least a part of a door trim (101).

According to this aspect, it is possible to suppress generation of sound due to contact of the door panel with the door panel.

To achieve the above object, one aspect of the present invention is a manufacturing method of an interior component (101) to be provided on an inboard side of an exterior component of a vehicle, the interior component comprising: a main body (102) configured to oppose the exterior component via a predetermined gap; a protruding part provided on an outer surface (102A) of the main body to protrude toward the exterior component; an elastic piece (124) protruding from a part of the outer surface of the main body adjacent to the protruding part to extend beyond a top (122A) of the protruding part, wherein the manufacturing method comprises joining at least one of the elastic piece and the protruding part formed as a separate member from the main body to the main body via a locking structure (162, 182, 191, 194, 197).

According to this aspect, the at least one of the elastic piece and the protruding part can be joined to the main body, and thus, manufacture of the interior component is easy.

There is known a vehicle seat provided with a fragrance device for the purpose of improving the comfort of the occupant (for example, JP2020-195429A).

The fragrance device of the Patent Document (JP2020-195429A) is built in the vehicle seat. Therefore, there is a problem that when it becomes necessary to repair or replace the fragrance device, the work therefor is cumbersome.

One aspect of the present invention is a fragrance device (201, 301), comprising: a housing (210) provided with a containment chamber (221) for containing an aromatic substance that emits fragrance; at least one fan (236, 245) for blowing air to guide the fragrance in a predetermined direction; and a mounting device (211, 311) for mounting the housing to a target object (206).

According to this aspect, it is possible to provide a detachable fragrance device.

In the above aspect, preferably, the housing is provided with an introduction passage (240) for introducing air into the containment chamber from outside and a discharge passage (246) for discharging air from the containment chamber to the outside, the fan comprises an introduction fan (236) provided in the introduction passage to blow air into the containment chamber and a discharge fan (245) provided in the discharge passage to blow air from the containment chamber to the outside, and an air cleaning device (238) for removing dust and odor-producing substances in the air passing through the introduction passage is disposed in the introduction passage.

According to this aspect, it is possible to blow fragrant air efficiently. Also, it is possible to remove dust and odor-producing substances from the air to be blown.

In the above aspect, preferably, a holding part (258) is supported in the containment chamber via a load cell (259), a cartridge (225, 325) is detachably supported by the holding part, the load cell transmits a first signal to a control device (270), and the control device calculates a weight of the aromatic substance in the cartridge based on the first signal and causes a calculation result to be displayed on a display device (272).

According to this aspect, the weight of the aromatic substance can be displayed.

In the above aspect, preferably, the holding part has a receiving recess (262) for receiving the cartridge, and the receiving recess is provided with multiple locking pieces (363) for resiliently supporting the cartridge.

According to this aspect, it is possible to resiliently support the cartridge.

In the above aspect, preferably, the cartridge includes a bottle (250) for containing the aromatic substance and a cap (251) for sealing the bottle, the cap includes a cap main body (252) and a convex part (253) that protrudes from the cap main body, the holding part has a receiving recess for receiving the cartridge, and the receiving recess is formed with a holding groove (263) for locking the convex part.

According to this aspect, the cartridge can be supported by the holding groove locking the convex part.

In the above aspect, preferably, the housing is provided with an opening and closing lid (227) for opening and closing an opening (226) of the containment chamber, the receiving recess of the holding part is viewable through the opening, and the cartridge is configured to be displaceable between a replacement position where the cartridge can be inserted/removed and a use position where the opening can be sealed by the opening and closing lid, with the cartridge being accommodated in the receiving recess.

According to this aspect, the cartridge can be detached easily.

In the above aspect, preferably, the holding part has a communication hole (264) for communicating an inside of the bottle with the containment chamber and a shutter (265) for opening and closing the communication hole.

According to this aspect, the emission of the fragrance can be controlled by opening and closing the shutter.

In the above aspect, preferably, the fragrance device comprises a motor (267) for driving the shutter.

According to this aspect, the shutter can be opened and closed by the motor.

In the above aspect, preferably, the control device prohibits an opening operation of the shutter by the motor when the weight is less than or equal to a predetermined threshold value.

According to this aspect, the opening and closing of the shutter can be controlled according to the remaining amount of the aromatic substance.

In the above aspect, preferably, the mounting device comprises an engagement part (280) to be engaged with the target object and a first adjustment mechanism (286) for adjusting a distance between the engagement part and the housing.

According to this aspect, the fragrance device can be mounted appropriately depending on the shape of the target object.

In the above aspect, preferably, the mounting device comprises two engagement parts to be engaged with the target object and a second adjustment mechanism (287) for adjusting a distance between one of the engagement parts and another of the engagement parts.

According to this aspect, the fragrance device can be mounted appropriately depending on the shape of the target object.

A vehicle seat, which is one of the in-vehicle devices, may be equipped with a heater to provide a seated occupant with a comfortable temperature environment. For example, a Patent Document (JPH4-4850U) discloses a seat having a heater provided in an armrest.

In the seat of the Patent Document (JPH4-4850U), when the heater is operated, the temperature of the armrest rises, and thermal energy is stored in the armrest. After the armrest is warmed, when the occupant gets out of the vehicle, the thermal energy stored in the armrest is wasted. Thus, there is a problem that the thermal energy is not effectively used.

One aspect of the present invention is an in-vehicle device (403, 451, 531, 551) installed in a vehicle, the in-vehicle device comprising: a main body (411, 459, 493, 542, 554); and a heat storage device (413, 461, 495, 544, 555) configured to be detachably attached to the main body and capable of storing thermal energy, wherein the heat storage device includes a latent heat storage material capable of storing heat as latent heat by phase change.

According to this aspect, the heat storage device can be attached to and detached from a target object. Therefore, the occupant can carry the heat storage device as necessary and can effectively use the thermal energy at a location where the thermal energy is needed. Also, since the heat storage device includes a latent heat storage material, the heat storage device can be given a high heat storage capacity.

In the above aspect, preferably, the main body (411) and the heat storage device (413) cooperate with each other to configure an armrest (403) of a vehicle seat (401) to be installed in the vehicle, the main body is supported, at a base end thereof, by a seatback (407) of the vehicle seat, and the heat storage device is detachably supported at a free end of the main body.

According to this aspect, the heat storage device can be disposed in a position where the heat storage device can be easily attached and detached.

In the above aspect, preferably, one of the main body and the heat storage device is provided with a magnet (421), and another of them is provided with a magnet or a metal member (441) that is attracted to the magnet.

According to this aspect, the heat storage device can be configured to be freely attached to and detached from the main body with a simple configuration.

In the above aspect, preferably, the main body and the heat storage device cooperate with each other to configure a vehicle seat (451, 531) to be installed in the vehicle.

According to this aspect, the thermal energy stored in the heat storage device can be supplied to the vehicle seat on which the occupant is to be seated, and thus, the thermal energy can be effectively used.

In the above aspect, preferably, the vehicle seat (451, 531) comprises a seat cushion (453) and a seatback (455) provided at a rear end of the seat cushion, the seat cushion and the seatback are respectively provided with receiving recesses (467, 501) for receiving the heat storage devices and ducts (477, 511) connected to the corresponding receiving recesses and connected to each other, the heat storage devices (461, 495) being respectively received in the receiving recesses.

According to this aspect, the thermal energy stored in the heat storage devices can be circulated between the seat cushion and the seatback.

In the above aspect, preferably, the seat cushion and the seatback are each provided with a groove (471, 505) formed in a bottom surface of the receiving recess and a through hole (475, 509) connecting an inside of the groove with an inside of the duct, and an exhaust device (479, 513) is provided in one of the groove, the through hole, and the duct.

According to this aspect, the air inside the grooves can be caused to flow by driving the fans, whereby the thermal energy stored in the heat storage devices can be circulated efficiently between the seat cushion and the seatback.

In the above aspect, preferably, the in-vehicle device comprises two temperature sensors (481, 515) for detecting a temperature inside the groove provided in the seat cushion and a temperature inside the groove provided in the seatback, respectively, and a control device (491) configured to acquire the temperatures detected by the temperature sensors and to control driving of the exhaust devices, wherein when the temperature detected by one of the temperature sensors is higher than the temperature detected by an other of the temperature sensors, the control device drives the exhaust devices so as to send out air inside the groove in which the other of the temperature sensors is provided to the inside of the groove in which the one of the temperature sensors is provided.

According to this aspect, equalization of temperature is achieved between the inside of the groove provided in the seatback and the inside of the groove provided in the seat cushion.

In the above aspect, preferably, the heat storage device comprises a heater (429, 487, 521, 547) and a heat storage part (431, 483, 517, 548) including a latent heat storage material, and the heat storage part is disposed to contact the heater.

According to this aspect, the thermal energy generated by the heater can be efficiently stored in the heat storage part.

In the above aspect, preferably, the heat storage device further comprises a base material (423) supporting the heater, and a Peltier element (570) is provided between the base material and the heat storage part to generate electricity from a temperature difference between the base material and the heat storage part.

According to this aspect, the thermal energy stored in the heat storage device can be converted to electrical energy.

In the above aspect, preferably, the latent heat storage material is composed of a material that can store heat by phase change between solids.

According to this aspect, the structure of the heat storage device can be simplified compared to a case where the latent heat storage material is composed of a material that stores latent heat by phase change between solid and liquid because there is no need to seal.

In the above aspect, preferably, the latent heat storage material is composed of a material whose phase change is induced by application of a pressure.

According to this aspect, it is possible to take out the thermal energy by pressurizing the latent heat storage material.

### Effect of the Invention

One aspect of the present invention is a vehicle seat (1), comprising: left and right side frames (26) extending vertically; an upper frame (27) extending laterally and connecting upper end portions of the side frames to each other; a wire member (51) attached to one of the side frames and to the upper frame; a plate member (52) connected to the wire member and provided with a support surface (58); and a device (41) supported by the support surface.

According to this aspect, various devices can be mounted to the vehicle seat and the mounting of the devices can be facilitated.

In the above aspect, preferably, the plate member is disposed forward of the upper frame and closer to a center of the seat than the one of the side frames is in a left-right direction.

According to this aspect, the device can be compactly disposed in the seat.

In the above aspect, preferably, the wire member is attached to a front portion of the one of the side frames and to a lower portion of the upper frame.

According to this aspect, the device can be compactly disposed in the seat.

In the above aspect, preferably, the plate member is disposed to be spaced from the one of the side frames and the upper frame.

According to this aspect, it is possible to make the device less likely to contact one of the side frames and the upper frame.

In the above aspect, preferably, the wire member and the plate member are formed integrally.

According to this aspect, the number of assembly steps for the device can be reduced.

In the above aspect, preferably, the wire member is welded to the one of the side frames and to the upper frame.

According to this aspect, the wire member can be reliably fixed to the one of the side frames and to the upper frame.

In the above aspect, preferably, the wire member includes a first part (54A) extending from the one of the side frames toward the center of the seat in the left-right direction, a second part (54B) extending forward from the upper frame, and a bent part (55) formed by connection between the first part and the second part, and the plate member is attached to an upper portion of the bent part at a surface thereof opposite from the support surface.

According to this aspect, the plate member is supported by the bent part. Therefore, the plate member can be easily.

In the above aspect, preferably, the support surface is slanted forward and toward the one of the side frames in the left-right direction.

According to this aspect, the device can be disposed to be inclined forward and outward of the seat in the left-right direction.

In the above aspect, preferably, the vehicle seat comprises a pad (23) supported by the side frames and the upper frame, and a skin material (24) covering the pad, wherein the pad has a first hole (71) opened at an upper portion thereof and formed to extend downward, the skin material has a second hole (72) formed in a position corresponding to the first hole in a front-rear direction and the left-right direction, and at least a part of the device is inserted in the first hole and the second hole.

According to this aspect, the device can be mounted in the pad of the seat.

In the above aspect, preferably, the device comprises a speaker (60), a sound absorbing member (62), and a case (61) accommodating the speaker and the sound absorbing member therein and attached to the plate member, and the sound absorbing member is disposed between the speaker and the case.

According to this aspect, it is possible to make the vibration from the speaker less likely to be transmitted to the side frame and the upper frame.

In the above aspect, preferably, the vehicle seat comprises another wire member (51) attached to another of the side frames and to the upper frame; another plate member (52) connected to the wire member and provided with a support surface; and another device (41) supported by the support surface.

According to this aspect, the speakers can be disposed on both of the left and right sides.

A patent document (JP2014-205445A) discloses a door trim provided with a trim holding means that contacts a door inner panel. This trim holding means includes a seat part integrally formed on the back side of the door trim in a protruding manner and a spring part integrally molded to the tip of the seat part and capable of bending deformation.

With the above trim holding means, it is necessary to simultaneously provide the seat part (protruding part) and the spring part (elastic piece) on the door trim. Therefore, there is a problem that the shape of the door inner panel becomes complex, which makes it difficult to manufacture the door inner panel.

One aspect of the present invention is an interior component (101) to be provided on an inboard side of an exterior component (P) of a vehicle, the interior component comprising: a main body (102) having an outer surface (102A) configured to oppose the exterior component via a predetermined gap; a protruding part (122) provided on the outer surface (102A) to protrude toward the exterior component; and an elastic piece (124) protruding from a part of the outer surface of the main body adjacent to the protruding part to extend beyond a top of the protruding part, wherein at least one of the elastic piece and the protruding part is formed as a separate member from the main body and is joined to the main body via a locking structure (132, 162, 172, 179, 182, 191, 194, 197).

According to this aspect, it is possible to configure the interior component by forming at least one of the protruding part and the elastic piece separately from the main body and thereafter locking the at least one of the elastic piece and the protruding part to the main body. Therefore, compared to the case where the elastic piece and the protruding part are integrally molded to the main body, the configuration of the main body can be simplified, and thus, it is possible to provide an interior component that is easy to manufacture.

In the above aspect, preferably, the locking structure includes a columnar body (134) protruding from the outer surface of the main body, and a base portion (136) provided on a base end side of the at least one of the elastic piece and the protruding part, wherein the base portion is provided with a locking hole (146) into which the columnar body protrudes in a lockable manner.

According to this aspect, a locking structure for easily joining at least one of the elastic piece and the protruding part to the main body can be provided.

In the above aspect, preferably, each of the columnar body and the locking hole has a non-circular cross section, and the base portion is displaceable, by rotation relative to the columnar body, between a position where the columnar body is loosely fitted in the locking hole and a position where the columnar body is in pressure contact with a wall surface defining the locking hole so that the base portion is frictionally engaged with the columnar body.

According to this aspect, by rotating the base portion about the axis of the columnar body, the columnar body comes into pressure contact with the wall surface defining the locking hole so that the base portion is frictionally engaged with the columnar body. Therefore, a locking structure that can allow easy assembly of at least one of the elastic piece and the protruding part to the main body can be configured.

In the above aspect, preferably, the columnar body includes a main part (138) protruding from the outer surface of the main body and multiple ribs (140) extending out from an outer circumferential surface of the main part in a direction perpendicular to the outer circumferential surface, wherein the locking hole includes a central part (148) for receiving the main part and multiple wing parts (150) extending outward from a periphery of the central part such that each wing part receives one of the ribs.

According to this aspect, the ribs enhance the stiffness of the columnar body.

In the above aspect, preferably, each of the columnar body and the locking hole is rotationally symmetric about a corresponding axis, and a distance from the axis of the locking hole to at least a part of a wall surface defining each wing part is smaller than a distance from the corresponding axis of the columnar body to a protruding end surface of each rib.

According to this aspect, when the columnar body is inserted into the locking hole and the base portion is rotated about the axis of the columnar body, the wall surface defining each wing part comes into pressure contact with the extension end of one of the ribs, whereby the base portion is frictionally engaged with the columnar body. Thus, a locking structure for easily joining at least one of the elastic piece and the protruding part to the main body can be provided with a simple configuration.

In the above aspect, preferably, the protruding end surface of each rib is inclined in a direction away from the outer circumferential surface of the main part as the protruding end surface extends toward the main body.

According to this aspect, when the base portion is moved toward the main body, the wall surface defining each wing part and the extension end of one of the ribs come into pressure contact with each other more firmly. Thus, by moving the base portion toward the main body, it is possible to make the base portion frictionally engaged with the main body more firmly. Also, the base portion can be engaged with the columnar body at a part of the columnar body positioned closer to the main body, and therefore, the base portion can be supported by the main body more firmly.

In the above aspect, preferably, the wing parts are provided in positions avoiding a region (R) connecting the axis with a base end portion of the at least one of the elastic piece and the protruding part.

According to this aspect, the at least one of the elastic piece and the protruding part can be joined to a part of the base portion that is not thinned by the locking hole, and thus, the at least one of the elastic piece and the protruding part can be firmly joined to the base portion.

In the above aspect, preferably, the base portion is displaceable, by movement along a protruding direction of the columnar body, between a position where the columnar body is loosely fitted in the locking hole and a position where the columnar body is frictionally engaged with the wall surface defining the locking hole.

According to this aspect, a locking structure for easily joining at least one of the elastic piece and the protruding part to the main body can be provided with a simple structure.

In the above aspect, preferably, the locking structure includes a columnar body (134) protruding from the outer surface of the main body, and a base portion (176) provided on a base end side of the at least one of the elastic piece and the protruding part, wherein a protruding end surface of the columnar body is provided with an engagement recess (138A) that is recessed toward the main body, and the base portion is provided with an engagement part (178) protruding into the engagement recess and frictionally engaged with a wall surface defining the engagement recess.

According to this aspect, a locking structure for easily joining at least one of the elastic piece and the protruding part to the main body can be configured with a simple structure.

In the above aspect, preferably, the interior component is disposed on an inboard side of a door panel (P) as the exterior component and forms at least a part of a door trim (101).

According to this aspect, it is possible to suppress generation of sound due to contact of the door panel with the door panel.

To achieve the above object, one aspect of the present invention is a manufacturing method of an interior component (101) to be provided on an inboard side of an exterior component of a vehicle, the interior component comprising: a main body (102) configured to oppose the exterior component via a predetermined gap; a protruding part provided on an outer surface (102A) of the main body to protrude toward the exterior component; an elastic piece (124) protruding from a part of the outer surface of the main body adjacent to the protruding part to extend beyond a top (122A) of the protruding part, wherein the manufacturing method comprises joining at least one of the elastic piece and the protruding part formed as a separate member from the main body to the main body via a locking structure (162, 182, 191, 194, 197).

According to this aspect, the at least one of the elastic piece and the protruding part can be joined to the main body, and thus, manufacture of the interior component is easy.

There is known a vehicle seat provided with a fragrance device for the purpose of improving the comfort of the occupant (for example, JP2020-195429A).

The fragrance device of the Patent Document (JP2020-195429A) is built in the vehicle seat. Therefore, there is a problem that when it becomes necessary to repair or replace the fragrance device, the work therefor is cumbersome.

One aspect of the present invention is a fragrance device (201, 301), comprising: a housing (210) provided with a containment chamber (221) for containing an aromatic substance that emits fragrance; at least one fan (236, 245) for blowing air to guide the fragrance in a predetermined direction; and a mounting device (211, 311) for mounting the housing to a target object (206).

According to this aspect, it is possible to provide a detachable fragrance device.

In the above aspect, preferably, the housing is provided with an introduction passage (240) for introducing air into the containment chamber from outside and a discharge passage (246) for discharging air from the containment chamber to the outside, the fan comprises an introduction fan (236) provided in the introduction passage to blow air into the containment chamber and a discharge fan (245) provided in the discharge passage to blow air from the containment chamber to the outside, and an air cleaning device (238) for removing dust and odor-producing substances in the air passing through the introduction passage is disposed in the introduction passage. According to this aspect, it is possible to blow fragrant air efficiently. Also, it is possible to remove dust and odor-producing substances from the air to be blown.

In the above aspect, preferably, a holding part (258) is supported in the containment chamber via a load cell (259), a cartridge (225, 325) is detachably supported by the holding part, the load cell transmits a first signal to a control device (270), and the control device calculates a weight of the aromatic substance in the cartridge based on the first signal and causes a calculation result to be displayed on a display device (272).

According to this aspect, the weight of the aromatic substance can be displayed.

In the above aspect, preferably, the holding part has a receiving recess (262) for receiving the cartridge, and the receiving recess is provided with multiple locking pieces (363) for resiliently supporting the cartridge.

According to this aspect, it is possible to resiliently support the cartridge.

In the above aspect, preferably, the cartridge includes a bottle (250) for containing the aromatic substance and a cap (251) for sealing the bottle, the cap includes a cap main body (252) and a convex part (253) that protrudes from the cap main body, the holding part has a receiving recess for receiving the cartridge, and the receiving recess is formed with a holding groove (263) for locking the convex part. According to this aspect, the cartridge can be supported by the holding groove locking the convex part.

In the above aspect, preferably, the housing is provided with an opening and closing lid (227) for opening and closing an opening (226) of the containment chamber, the receiving recess of the holding part is viewable through the opening, and the cartridge is configured to be displaceable between a replacement position where the cartridge can be inserted/removed and a use position where the opening can be sealed by the opening and closing lid, with the cartridge being accommodated in the receiving recess.

According to this aspect, the cartridge can be detached easily.

In the above aspect, preferably, the holding part has a communication hole (264) for communicating an inside of the bottle with the containment chamber and a shutter (265) for opening and closing the communication hole.

According to this aspect, the emission of the fragrance can be controlled by opening and closing the shutter.

In the above aspect, preferably, the fragrance device comprises a motor (267) for driving the shutter.

According to this aspect, the shutter can be opened and closed by the motor.

In the above aspect, preferably, the control device prohibits an opening operation of the shutter by the motor when the weight is less than or equal to a predetermined threshold value.

According to this aspect, the opening and closing of the shutter can be controlled according to the remaining amount of the aromatic substance.

In the above aspect, preferably, the mounting device comprises an engagement part (280) to be engaged with the target object and a first adjustment mechanism (286) for adjusting a distance between the engagement part and the housing.

According to this aspect, the fragrance device can be mounted appropriately depending on the shape of the target object.

In the above aspect, preferably, the mounting device comprises two engagement parts to be engaged with the target object and a second adjustment mechanism (287) for adjusting a distance between one of the engagement parts and another of the engagement parts.

According to this aspect, the fragrance device can be mounted appropriately depending on the shape of the target object.

A vehicle seat, which is one of the in-vehicle devices, may be equipped with a heater to provide a seated occupant with a comfortable temperature environment. For example, a Patent Document (JPH4-4850U) discloses a seat having a heater provided in an armrest.

In the seat of the Patent Document (JPH4-4850U), when the heater is operated, the temperature of the armrest rises, and thermal energy is stored in the armrest. After the armrest is warmed, when the occupant gets out of the vehicle, the thermal energy stored in the armrest is wasted. Thus, there is a problem that the thermal energy is not effectively used.

One aspect of the present invention is an in-vehicle device (403, 451, 531, 551) installed in a vehicle, the in-vehicle device comprising: a main body (411, 459, 493, 542, 554); and a heat storage device (413, 461, 495, 544, 555) configured to be detachably attached to the main body and capable of storing thermal energy, wherein the heat storage device includes a latent heat storage material capable of storing heat as latent heat by phase change.

According to this aspect, the heat storage device can be attached to and detached from a target object. Therefore, the occupant can carry the heat storage device as necessary and can effectively use the thermal energy at a location where the thermal energy is needed. Also, since the heat storage device includes a latent heat storage material, the heat storage device can be given a high heat storage capacity.

In the above aspect, preferably, the main body (411) and the heat storage device (413) cooperate with each other to configure an armrest (403) of a vehicle seat (401) to be installed in the vehicle, the main body is supported, at a base end thereof, by a seatback (407) of the vehicle seat, and the heat storage device is detachably supported at a free end of the main body.

According to this aspect, the heat storage device can be disposed in a position where the heat storage device can be easily attached and detached.

In the above aspect, preferably, one of the main body and the heat storage device is provided with a magnet (421), and another of them is provided with a magnet or a metal member (441) that is attracted to the magnet.

According to this aspect, the heat storage device can be configured to be freely attached to and detached from the main body with a simple configuration.

In the above aspect, preferably, the main body and the heat storage device cooperate with each other to configure a vehicle seat (451, 531) to be installed in the vehicle.

According to this aspect, the thermal energy stored in the heat storage device can be supplied to the vehicle seat on which the occupant is to be seated, and thus, the thermal energy can be effectively used.

In the above aspect, preferably, the vehicle seat (451, 531) comprises a seat cushion (453) and a seatback (455) provided at a rear end of the seat cushion, the seat cushion and the seatback are respectively provided with receiving recesses (467, 501) for receiving the heat storage devices and ducts (477, 511) connected to the corresponding receiving recesses and connected to each other, the heat storage devices (461, 495) being respectively received in the receiving recesses.

According to this aspect, the thermal energy stored in the heat storage devices can be circulated between the seat cushion and the seatback.

In the above aspect, preferably, the seat cushion and the seatback are each provided with a groove (471, 505) formed in a bottom surface of the receiving recess and a through hole (475, 509) connecting an inside of the groove with an inside of the duct, and an exhaust device (479, 513) is provided in one of the groove, the through hole, and the duct.

According to this aspect, the air inside the grooves can be caused to flow by driving the fans, whereby the thermal energy stored in the heat storage devices can be circulated efficiently between the seat cushion and the seatback.

In the above aspect, preferably, the in-vehicle device comprises two temperature sensors (481, 515) for detecting a temperature inside the groove provided in the seat cushion and a temperature inside the groove provided in the seatback, respectively, and a control device (491) configured to acquire the temperatures detected by the temperature sensors and to control driving of the exhaust devices, wherein when the temperature detected by one of the temperature sensors is higher than the temperature detected by an other of the temperature sensors, the control device drives the exhaust devices so as to send out air inside the groove in which the other of the temperature sensors is provided to the inside of the groove in which the one of the temperature sensors is provided.

According to this aspect, equalization of temperature is achieved between the inside of the groove provided in the seatback and the inside of the groove provided in the seat cushion.

In the above aspect, preferably, the heat storage device comprises a heater (429, 487, 521, 547) and a heat storage part (431, 483, 517, 548) including a latent heat storage material, and the heat storage part is disposed to contact the heater.

According to this aspect, the thermal energy generated by the heater can be efficiently stored in the heat storage part.

In the above aspect, preferably, the heat storage device further comprises a base material (423) supporting the heater, and a Peltier element (570) is provided between the base material and the heat storage part to generate electricity from a temperature difference between the base material and the heat storage part.

According to this aspect, the thermal energy stored in the heat storage device can be converted to electrical energy.

In the above aspect, preferably, the latent heat storage material is composed of a material that can store heat by phase change between solids.

According to this aspect, the structure of the heat storage device can be simplified compared to a case where the latent heat storage material is composed of a material that stores latent heat by phase change between solid and liquid because there is no need to seal.

In the above aspect, preferably, the latent heat storage material is composed of a material whose phase change is induced by application of a pressure.

According to this aspect, it is possible to take out the thermal energy by pressurizing the latent heat storage material.

### BRIEF DESCRIPTION OF THE DRAWINGS

FIG. 1 is a perspective view of a seat frame of a vehicle seat according to the first embodiment;

FIG. 2 is a perspective view of a bracket;

FIG. 3 is a perspective view of a device supported by the bracket;

FIG. 4 is an exploded perspective view of the device;

FIG. 5 is a front view of the device supported by the bracket;

FIG. 6 is a sectional view of the vehicle seat;

FIG. 7 is a front view of a bracket according to another embodiment;

FIG. 8 is a sectional view taken along line A-A in FIG. 7;

FIG. 9 is a sectional view taken along line B-B in FIG. 7;

FIG. 10 is a perspective view of a door according to the second embodiment;

FIG. 11 is a schematic diagram of the back side of a door trim according to the second embodiment;

FIG. 12 is a perspective view of an abnormal noise suppression structure according to the second embodiment;

FIG. 13 is a sectional view taken along line XIII-XIII in FIG. 11;

FIG. 14 is a side view of the abnormal noise suppression structure according to the second embodiment;

FIG. 15 is an exploded perspective view of the abnormal noise suppression structure according to the second embodiment;

FIG. 16 is an explanatory diagram for explaining a modification of the abnormal noise suppression structure according to the second embodiment;

FIG. 17 is a schematic diagram for explaining an assembly method of the abnormal noise suppression structure according to the second embodiment;

FIGS. 18(A) and 18(B) are a perspective view and a side view of an abnormal noise suppression structure according to the third embodiment;

FIG. 19 is an exploded perspective view of the abnormal noise suppression structure according to the third embodiment;

FIG. 20(A) is a plan view of an abnormal noise suppression structure according to the fourth embodiment, and FIG. 20(B) is a sectional view taken along line XXB-XXB in FIG. 20(A);

FIG. 21(A) is a plan view of an abnormal noise suppression structure according to the fifth embodiment, and FIG. 21(B) is a sectional view taken along line XXIB-XXIB in FIG. 21(A);

FIG. 22 is an explanatory diagram for explaining an assembly method of an interior component according to the fifth embodiment, particularly the abnormal noise suppression structure;

FIGS. 23(A) and 23(B) are a plan view and a side view of an abnormal noise suppression structure according to the sixth embodiment;

FIG. 24(A) is a vertical sectional view of a part XXIVA in FIG. 23, and FIG. 24(B) is a sectional view taken along line XXIIIB-XXIIIB in FIG. 24(A);

FIG. 25 is an exploded perspective view of an abnormal noise suppression structure according to the seventh embodiment;

FIG. 26 is a schematic diagram of the back side of the door trim according to a modification of the above embodiment;

FIG. 27 is a perspective view of the door according to a modification of the above embodiment;

FIG. 28(A) is a schematic diagram of the back side of the door trim according to a modification of the above embodiment, and FIG. 28(B) is a sectional view taken along line XXVIIIB-XXVIIIB in FIG. 28(A);

FIG. 29 shows a modification of the abnormal noise suppression structure according to the second embodiment;

FIG. 30 is a diagram showing a fragrance device mounted to the seat;

FIG. 31 is a perspective view of the fragrance device according to the eighth embodiment;

FIG. 32 is a sectional view taken along line XXXII-XXXII in FIG. 31;

FIG. 33 is a sectional view taken along line XXXIII-XXXIII in FIG. 31;

FIG. 34 is a diagram showing a cartridge;

FIG. 35 is a perspective view of an engagement part;

FIG. 36 is a schematic diagram of a second adjustment mechanism;

FIG. 37 is a schematic diagram of a second adjustment mechanism;

FIG. 38 is a sectional view of an engagement part according to a modification;

FIG. 39 is a diagram showing a cartridge according to the ninth embodiment;

FIG. 40 is a sectional view of a mounting device;

FIG. 41 is a perspective view of a vehicle seat according to the tenth embodiment;

FIG. 42 is a sectional view taken along line XLII-XLII in FIG. 41;

FIG. 43 is a perspective view showing a state in which a heat storage device is detached from an armrest main body of the vehicle seat according to the tenth embodiment;

FIG. 44 is a sectional view of a vehicle seat provided with a heat storage device according to the eleventh embodiment;

FIG. 45 is an exploded perspective view of a seat cushion of the vehicle seat according to the eleventh embodiment;

FIG. 46 is a sectional view showing a vehicle seat according to the twelfth embodiment and a part of the vehicle body of a vehicle provided with the vehicle seat;

FIG. 47 is a perspective view showing a door trim according to the thirteenth embodiment;

FIG. 48 is a sectional view taken along line XLVIII-XLVIII in FIG. 47;

FIG. 49 is a perspective view showing a door trim according to the fourteenth embodiment;

FIG. 50 is a sectional view taken along line L-L in FIG. 49;

FIG. 51 shows a first modification of the heat storage device according to the tenth embodiment;

FIG. 52 shows a second modification of the heat storage device according to the tenth embodiment;

FIG. 53 is an explanatory diagram for explaining locations where the heat storage device according to the present invention can be installed;

FIG. 54 is a diagram showing a seat system according to the fifteenth embodiment;

FIG. 55 is a side view of the seat;

FIGS. 56(A) and 56(B) are diagrams respectively showing a forward facing position and a rearward facing position of the seat;

FIG. 57(A) is a perspective view of a support device, and FIG. 57(B) is a sectional view taken along line LVIIB-LVIIB in FIG. 57(A);

FIG. 58 is a flowchart of a support device control process according to the first embodiment;

FIG. 59 is a diagram showing the support member in a second state;

FIG. 60 is a diagram showing the support member in a third state;

FIG. 61 is a diagram showing the support member in a fourth state;

FIG. 62 is a flowchart of a support device control process according to the second embodiment;

FIG. 63 is a diagram showing the support member in the second state;

FIG. 64 is a diagram showing the support member in the third state;

FIG. 65 is a diagram showing the support member in the fourth state;

FIG. 66 is an explanatory diagram for explaining locations where the support device according to the present invention can be installed; and

FIG. 67 is an explanatory diagram for explaining locations where the support device according to the present invention can be installed.

### MODE(S) FOR CARRYING OUT THE INVENTION

In the following, a vehicle seat according to the present invention will be described with reference to the drawings. In the present embodiment, the vehicle seat is applied to the driver's seat of a vehicle. In the following description, the up-down, front-rear, and left-right directions are defined based on the travel direction of the vehicle, but the present invention is not limited to this.

### First Embodiment

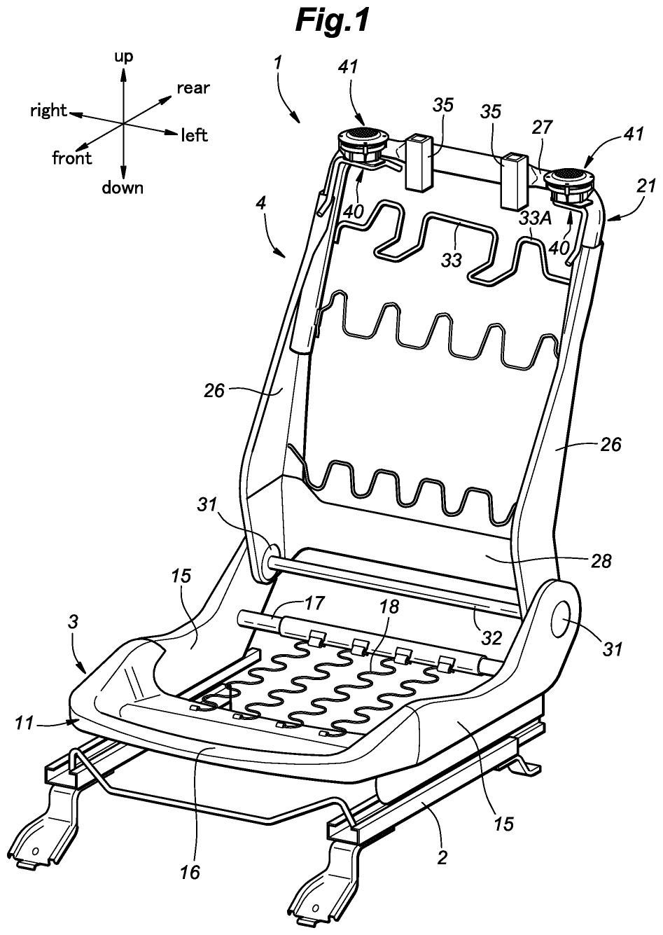

As shown in FIG. 1, the vehicle seat (hereinafter referred to as the seat 1) includes a seat cushion 3 provided on the floor of the vehicle cabin via slide rails 2, a seatback 4 joined to a rear portion of the seat cushion 3, and a headrest provided on an upper side of the seatback 4.

The seat cushion 3 includes a seat cushion frame 11 forming a skeleton. A pad is supported on the seat cushion frame 11, and the outer surface of the pad is covered with a skin material. The seat cushion frame 11 includes left and right side frames 15 extending in the front-rear direction, a front frame 16 extending laterally and joined to each of the front end portions of the left and right side frames 15, and a rear frame 17 extending laterally and joined to each of the rear end portions of the left and right side frames 15. The rear end portions of the left and right side frames 15 extend obliquely upward. Between the front frame 16 and the rear frame 17, S-shaped springs 18 are stretched to extend in the front-rear direction.

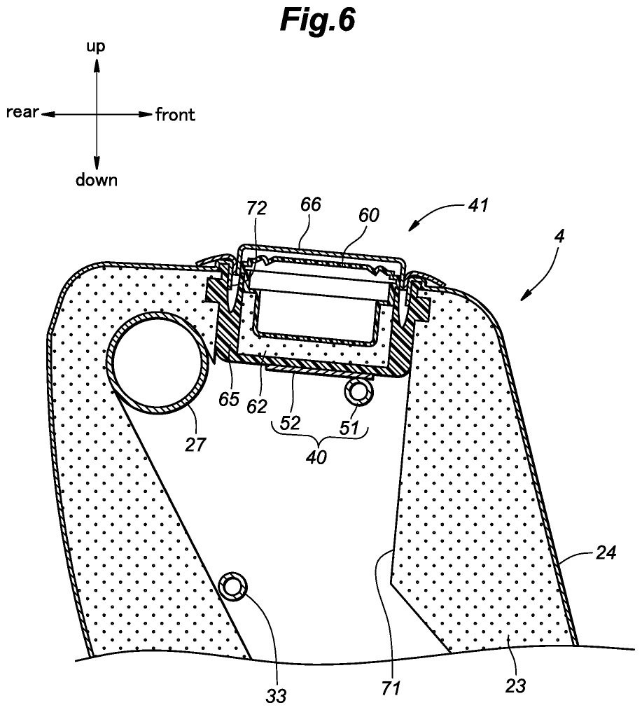

The seatback 4 includes a seatback frame 21 forming a skeleton, a pad 23 (see FIG. 6) supported by the seatback frame 21, and a skin material 24 (see FIG. 6) covering the outer surface of the pad 23. The seatback frame 21 includes left and right side frames 26 extending in the up-down direction, an upper frame 27 extending laterally and joined to each of the upper end portions of the left and right side frames 26, and a lower frame 28 extending laterally and joined to each of the lower end portions of the left and right side frames 26.

The upper frame 27 and the upper end portions of the left and right side frames 26 are formed by bending a pipe having a circular cross section. A central part of the pipe in the lengthwise direction extends laterally to form the upper frame 27 and left and right end portions of the pipe in the lengthwise direction are bent downward to form the upper end portions of the left and right side frames 26. The both end portions of the pipe are disposed along the inner surfaces of left and right sheet metal members forming the side frames 26 and are welded to the sheet metal members. The lower frame 28 is formed of a sheet metal member and is disposed such that the surfaces thereof face forward and rearward. The left and right end portions of the lower frame 28 are welded to the rear edges of the lower end portions of the laterally corresponding side frames 26.

The lower ends of the left and right side frames 26 are joined to the rear ends of the laterally corresponding side frames 15 via reclining mechanisms 31. Due to the reclining mechanism 31, the left and right side frames 26 are supported such that the angle thereof relative to the left and right side frames 15 is adjustable. The left and right reclining mechanisms 31 are connected to each other by a connecting shaft 32.

Further, the seatback frame 21 includes a cross member 33 extending laterally below the upper frame 27 and joined to each of the left and right side frames 15. The left and right end portions of the cross member 33 are joined to the left and right side frames 26. In the present embodiment, the cross member 33 is formed by bending a metal rod (metal wire) having a circular cross section. The cross member 33 has multiple bent parts 33A which are bent to protrude upward. An upper end portion of each bent part 33A extends laterally in a linear manner.

The upper frame 27 is provided with left and right support members 35 for supporting left and right pillars of the headrest. Each of the left and right support members 35 is formed in a tubular shape having open ends and is joined to the upper frame 27 such that the axis thereof extends vertically. The left and right support members 35 are disposed in bilaterally symmetric positions with respect to the widthwise center line of the seatback 4. A space is formed between the left and right support members 35.

Devices 41 are mounted to the upper frame 27 and the left and right side frames 26 via brackets 40. The brackets 40 and the devices 41 on the left and right sides are disposed in bilaterally symmetric positions with respect to the widthwise center line of the seatback 4. The brackets 40 and the devices 41 on the left and right sides have a bilaterally symmetric configuration, and therefore, in the following, description will be made of the bracket 40 and the device 41 on the right side.

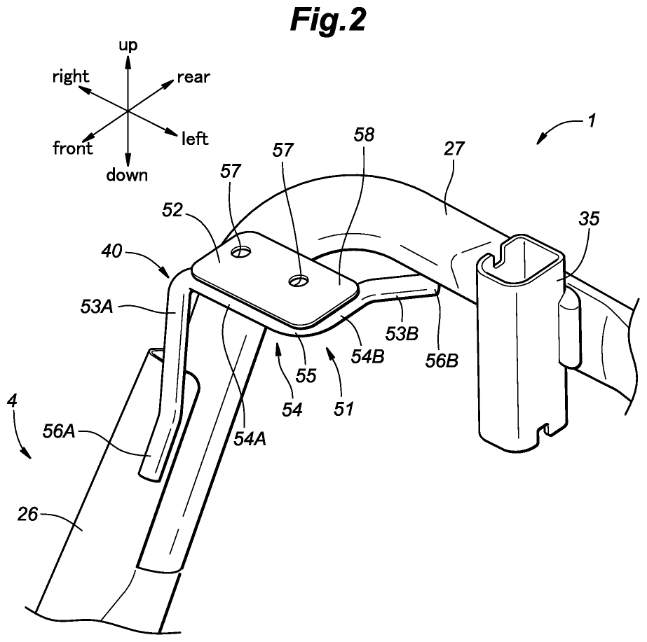

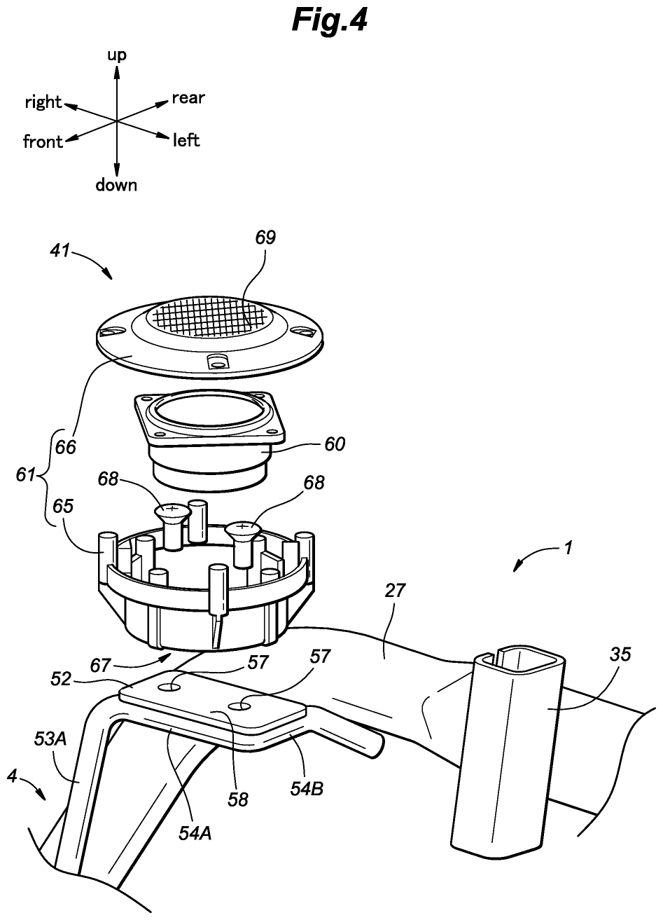

As shown in FIGS. 2-4, the bracket 40 includes a first member 51 (wire member) and a second member 52 (plate member) connected to the first member 51. In the present embodiment, the first member 51 and the second member 52 are formed as separate members.

The first member 51 is formed by bending a metal rod (metal wire) having a circular cross section. The first member 51 is attached to the side frame 26 at one end thereof and is attached to the upper frame 27 at the other end thereof. The first member 51 includes a side attachment part 56A and an upper attachment part 56B, a side connection part 53A and an upper connection part 53B, and a main body 54.

The side attachment part 56A is attached to the side frame 26. Preferably, the side attachment part 56A is attached to the front portion of the side frame 26. The upper attachment part 56B is attached to the upper frame 27. Preferably, the upper attachment part 56B is attached to the lower portion of the upper frame 27. The side attachment part 56A and the upper attachment part 56B are preferably welded to the side frame 26 and the upper frame 27, respectively.

The side connection part 53A is connected to the side attachment part 56A at the lower end thereof. The side connection part 53A is connected to the side attachment part 56A at a predetermined angle. The upper end of the side attachment part 56A is connected to the main body 54. The upper connection part 53B is connected to the upper attachment part 56B at the rear end thereof. The front end of the upper connection part 53B is connected to the main body 54. The upper connection part 53B is connected to the upper attachment part 56B at a predetermined angle.

The main body 54 includes a first part 54A and a second part 54B. The first part 54A is connected to the upper end of the side connection part 53A and extends leftward from the upper end of the side connection part 53A. The second part 54B is connected to the front end of the upper connection part 53B and extends forward from the front end of the upper connection part 53B. Preferably, the first part 54A and the second part 54B extend in mutually perpendicular directions. The left end of the first part 54A and the front end of the second part 54B are connected to each other to form a bent part 55.

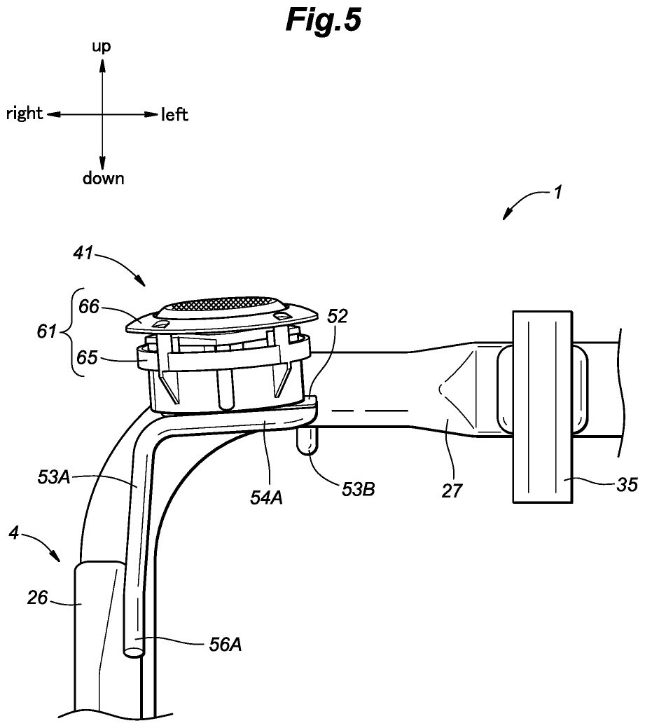

As shown in FIGS. 2 and 5, the main body 54 is disposed forward of the upper frame 27 and to the left of the side frame 26 in the left-right direction (namely, closer to the center of the seat 1). Preferably, the main body 54 is disposed closer to the side frame 26 (namely, more outward with respect to the seat 1) than the midpoint between the side frame 26 and the right support member 35 is in the left-right direction. The surface defined by the upper portion of the main body 54 is preferably inclined forward and rightward (namely, outward with respect to the seat 1 in the left-right direction) when the seatback 4 is in the use position in which the seatback 4 stands upright.

As shown in FIGS. 2-5, the second member 52 is formed of a flat metal plate. The second member 52 has main surfaces facing in the upward and downward directions. The second member 52 preferably has a rectangular shape in plan view. The second member 52 is fixed to the main body 54 at the lower surface thereof. Preferably, the second member 52 is welded to the main body 54. By being attached to the upper portion of the main body 54, the second member 52 is preferably disposed to be inclined forward and rightward (namely, outward with respect to the seat 1 in the left-right direction). The front end portion of the second member 52 is preferably disposed in a position coinciding with the front end portion of the first part 54A in the front-rear direction. The left end portion of the second member 52 is preferably disposed in a position coinciding with the left end portion of the second part 54B in the left-right direction.

The second member 52 is disposed forward of the upper frame 27 and leftward of the side frame 26 (namely, closer to the center of the seat 1) in the left-right direction. Preferably, the second member 52 is disposed closer to the side frame 26 (namely, more outward with respect to the seat 1) than the midpoint between the side frame 26 and the right support member 35 is in the left-right direction. The second member 52 is disposed to be spaced from the side frame 26 and the upper frame 27. Namely, the second member 52 is disposed to the left of the side frame 26 (namely, closer to the center of the seat 1 in the left-right direction) and forward of the upper frame 27.

The second member 52 is provided with mounting holes 57 penetrating therethrough in the up-down direction. The mounting holes 57 are holes for mounting the device 41. The device 41 is supported on the upper surface 58 (support surface) of the second member 52.

The device 41 includes a speaker 60, a case 61, and a sound absorbing member 62 (see FIG. 6). The speaker 60 outputs a sound wave in a predetermined direction based on a signal inputted from a control device not shown in the drawings. The speaker 60 may be a known directional speaker. The speaker 60 is accommodated in the case 61.

The case 61 includes a holder part 65 and a cover part 66. The case 61 is preferably made of resin. The holder part 65 holds the speaker 60. The holder part 65 has a mounting surface 67 formed to be substantially flat at the bottom portion thereof. The mounting surface 67 opposes the upper surface 58. The holder part 65 is joined to the second member 52 at the mounting surface 67. Preferably, the holder part 65 is fastened to the second member 52 by inserting screws 68 into the mounting holes 57, for example.

The cover part 66 is attached to the holder part 65. Thereby, the speaker 60 is accommodated inside the case 61. In the present embodiment, the cover part 66 functions as a grille. The grille is preferably provided with multiple through holes 69 penetrating therethrough in the up-down direction. The through holes 69 function as sound holes for passing the sound wave outputted from the speaker 60. An outer marginal portion of the cover part 66 is formed with multiple fastening holes.

As shown in FIG. 6, the sound absorbing member 62 absorbs the sound wave emitted from the speaker 60. The sound absorbing member 62 is disposed between the speaker 60 and the holder part 65. The sound absorbing member 62 is preferably a porous member having sound absorbing property. The sound absorbing member 62 is preferably a sponge having a thickness of about 1 mm, for example.

The pad 23 has a first hole 71. The first hole 71 is a hole opened in a circular shape in the upper surface of the pad 23. Preferably, the diameter of the first hole 71 substantially matches the diameter of the device 41. In a position of the skin material 24 corresponding to the first hole 71 in the front-rear and left-right directions, a second hole 72 is formed. The second hole 72 is a circular hole. Preferably, the diameter of the second hole 72 substantially matches the diameter of the first hole 71. The device 41 is inserted into the first hole 71 and the second hole 72. Around the second hole 72, the skin material 24 is pushed into the fastening holes of the cover part 66 and is fastened by screws not shown in the drawings. Thereby, the device 41 is provided inside the seatback 4.

Next, the effects of the vehicle seat according to the present embodiment will be described. The bracket 40 includes the first member 51 and the second member 52 attached to the first member 51. The first member 51 is attached to the side frame 26 and the upper frame 27. On the upper surface 58 of the second member 52, the device 41 is supported.

According to this configuration, the device 41 is mounted to the side frame 26 and the upper frame 27 via the second member 52 in the seat 1. Since the device 41 is supported by the upper surface 58, the device 41, which may be of various shapes, can be mounted without changing the shape and arrangement of the first member 51 and the second member 52. Also, the mounting of the device 41 can be facilitated. Further, since the bracket 40 is fixed to both the side frame 26 and the upper frame 27, the stiffness of the bracket 40 can be enhanced. Also, the bracket 40 can stand a load in the up-down direction and the left-right direction.

The second member 52 is disposed forward of the upper frame 27 and closer to the center of the seat 1 than the side frame 26 is in the left-right direction. This allows the bracket 40 and the device 41 to be compactly disposed in the seat 1.

The first member 51 is attached to the front portion of one of the side frames 26 and to the lower portion of the upper frame 27. This allows the bracket 40 and the device 41 to be disposed in the seat 1 even more compactly.

The second member 52 is disposed to be spaced from the side frame 26 and the upper frame 27. Therefore, even when the device 41 is larger than the second member 52 in the front-rear and left-right directions, it is possible to make the device 41 less likely to contact the side frame 26 and the upper frame 27. Thus, in the case where the device 41 includes the speaker 60, it is possible to make the vibration less likely to be transmitted to the side frame 26 and the upper frame 27.

The first member 51 and the second member 52 are formed integrally. Therefore, the number of steps for assembling the bracket 40 to the seat 1 can be reduced.

The first member 51 is welded to the side frame 26 and the upper frame 27. Therefore, the bracket 40 can be reliably fixed to the side frame 26 and the upper frame 27.

The main body 54 includes the first part 54A and the second part 54B. The first part 54A extends from the side frame 26 side toward the center of the seat 1 in the left-right direction. The second part 54B extends forward from the upper frame 27 side. The first part 54A and the second part 54B are connected to form the bent part 55. The second member 52 is attached to an upper portion of the bent part 55 at the lower surface thereof which is opposite from the upper surface 58. When the second member 52 is attached to the main body 54, the second member 52 can be supported at two points, namely, the first part 54A and the second part 54B. Therefore, the second member 52 can be easily attached to the first member 51.

The seat 1 includes the pad 23 and the skin material 24 covering the pad 23. The pad 23 has the first hole 71 opened at an upper portion thereof and formed to extend downward. The skin material 24 has the second hole 72 formed in the position corresponding to the first hole 71. At least a part of the device 41 is fitted into the first hole 71 and the second hole 72. Therefore, the device 41 can be mounted inside the seat 1.

Between the speaker 60 and the holder part 65, the sound absorbing member 62 is disposed. Thereby, the sound wave outputted from the speaker 60 is absorbed by the sound absorbing member 62. Thus, the vibration transmitted to the seat 1 via the bracket 40 can be reduced.

The device 41 is provided on each of the left and right sides of the seat 1. This makes it possible to dispose the speaker 60 on each of the left and right sides of the seat 1. Thus, it is possible to achieve 3D sound.

The second member 52 is disposed forward of the upper frame 27. This enables the speaker 60 to be disposed further forward in the seatback 4. Thus, the speaker 60 can be disposed near the ear of the seated person. Therefore, it is possible to provide a sound field at the position near the ear of the seated person.

Also, the main body 54 and the second member 52 are disposed closer to the side frame 26 (namely, more outward with respect to the seat 1) than the midpoint between the right side frame 26 and the right support member 35 is. Thereby, the device 41 can be disposed more outward with respect to the seat 1 in the left-right direction. Consequently, the distance between the left and right speakers 60 can be widened. Thus, it is possible to reduce the influence of crosstalk and to provide a more 3D sound field.

Also, the main body 54 and the second member 52 are disposed to be inclined forward and outward with respect to the seat 1. Consequently, the speaker 60 can be mounted to be inclined forward and outward with respect to the seat 1 in the left-right direction. Therefore, it is possible to provide the person seated on the seat 1 with a sense of left-right separation of the sound emitted from the left and right speakers 60. Also, since the sound emitted from the speakers 60 can be directed toward the position of the ears of the seated person, there is no need to increase the volume of the speakers 60 than necessary. Thus, the influence of crosstalk can be reduced further.

Next, another embodiment of the bracket 40 will be described. In the following, the structures same as those of the bracket 40 will be denoted by the same reference signs and the description will be omitted.

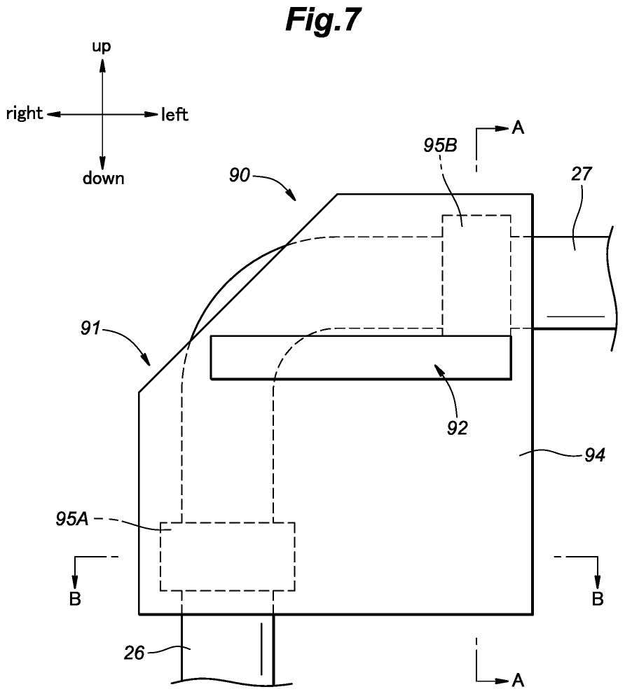

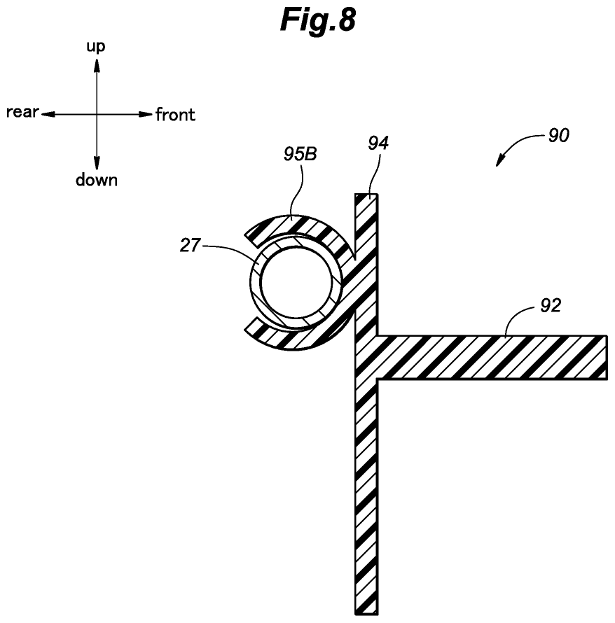

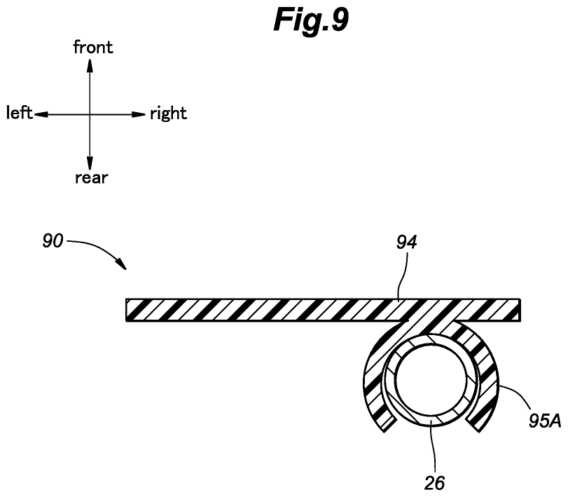

As shown in FIGS. 7-9, a bracket 90 includes a first member 91 and a second member 92 attached to the first member 91. The bracket 90 is made of resin. In the present embodiment, the first member 91 and the second member 92 are formed integrally.

The first member 91 includes a main body 94, a side attachment part 95A, and an upper attachment part 95B. The main body 94 is formed of a plate having main surfaces facing in the forward and rearward directions. The second member 92 is attached to the front surface of the main body 94. The side attachment part 95A and the upper attachment part 95B are provided on the rear surface of the main body 94.

The side attachment part 95A is attached to the side frame 26. The side attachment part 95A is attached to the side frame 26 by pinching the same from left and right. The upper attachment part 95B is attached to the upper frame 27. The upper attachment part 95B is attached to the upper frame 27 by pinching the same from above and below.

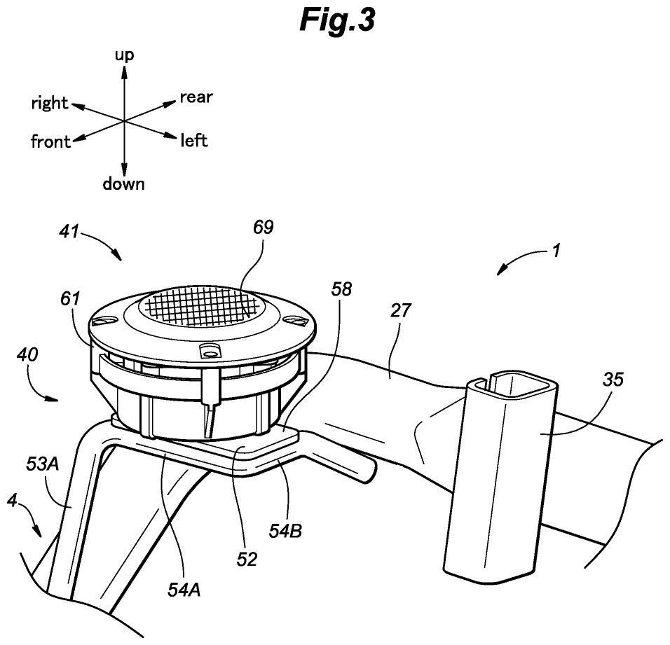

The second member 92 is formed of a plate having main surfaces facing in the upward and downward directions. The device 41 (see FIGS. 3-5) is mounted to the upper surface (support surface) of the second member 92.

Since the bracket 90 is made of resin, the bracket 90 can be attached to the side frame 26 and the upper frame 27 by pressing the first member 91 against the side frame 26 and the upper frame 27 from front. Thus, the bracket 90 can be easily attached to the side frame 26 and the upper frame 27. Also, since the bracket 90 is formed integrally, the assembly work is easy. Thus, the device 41 can be easily mounted to the seat 1.

The side attachment part 95A engages the side frame 26 from left and right. Also, the upper attachment part 95B engages the upper frame 27 from above and below. Therefore, displacement of the bracket 90 is restricted in the up-down direction and the left-right direction. Thus, the bracket 90 can be reliably fixed to the side frame 26 and the upper frame 27.

Concrete embodiments have been described in the foregoing, but the present invention can be modified in various ways without being limited to the above embodiments. The device 41 may include, instead of the speaker 60, a light, a sensor, a blower, etc. The main body 54 and the second member 52 may be disposed to be inclined rearward or may be disposed to be inclined toward the center of the seat 1 in the left-right direction. Thereby, the device 41 can be mounted to the seat 1 at an arbitrary angle.

The speakers 60 may be configured to function in cooperation with other speakers provided in the vehicle. For example, the speakers 60 may be configured to be used in combination with other speakers provided in a front part of the vehicle to achieve excellent sound image localization.

Incidentally, a vehicle in which the seat having the device mounted thereto is to be installed usually has an interior component mounted thereto.

In the following, description will be made of an embodiment in which an interior component according to the present invention is applied to a door trim to be installed in a vehicle (automobile).

In the following, for convenience of explanation, the front, rear, left, right, up, and down directions are defined with respect to the vehicle body of the vehicle provided with a door trim 101. Also, an inner side in the vehicle width direction (left-right direction) may be referred to as an inboard side, and an outer side in the vehicle width direction (left-right direction) may be referred to as an outboard side, as necessary.

### Second Embodiment

The door trim 101 (interior component) according to the second embodiment is mounted to the inboard side of a door panel P which is an exterior component. The door trim 101 cooperates with the door panel P to configure at least a part of a door D of the vehicle. Namely, the door D includes the door trim 101 and the door panel P. In the present embodiment, the door trim 101 is mounted to the door panel P of the door D on the right side of the front seat.

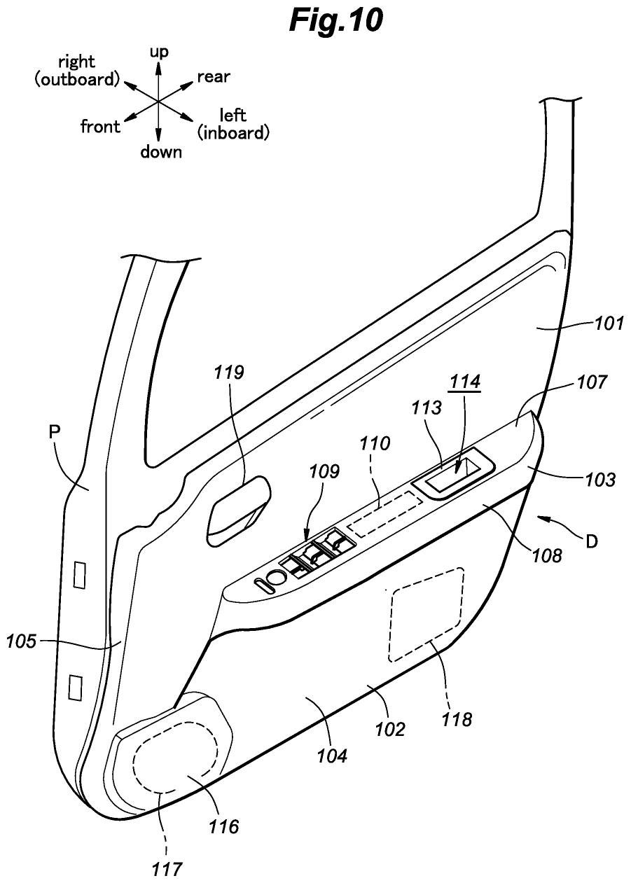

As shown in FIG. 10, the door trim 101 according to the second embodiment includes a trim main body 102 directly joined to the door panel P and an armrest 103 provided on the trim main body 102 (main body).

The trim main body 102 includes a main surface part 104 facing in the vehicle width direction and an edge part 105 corresponding to a periphery of the main surface part 104. A part of an outer surface of the trim main body 102 that constitutes an outboard surface of the main surface part 104 (hereinafter referred to as a back side 102A) opposes the door panel P via a predetermined gap. The edge part 105 extends from an end portion of the main surface part 104 in the outboard direction. An outboard end portion of the edge part 105 is in contact with the door panel P and is attached to the door panel P via fastening members, such as clips, for example.

The trim main body 102 is made of resin. For example, the trim main body 102 may be manufactured by so-called injection molding in which a cavity defined between two molds is injection-filled with molten resin, and thereafter, the molds are removed.

The armrest 103 includes an armrest upper wall 107 bulging from the trim main body 102 in the inboard direction and having surfaces facing in the upward and downward directions, and an armrest side wall 108 extending downward from the inboard end portion of the armrest upper wall 107. The armrest 103 bulges in the inboard direction from a central part of the main surface part 104 in the up-down direction. The armrest 103 functions as a support for the occupant's arm.

The armrest upper wall 107 extends from the main surface part 104 substantially horizontally in the inboard direction. The rear end portion of the armrest side wall 108 is inclined in the outboard direction toward the rear. The front portion of the armrest upper wall 107 is provided with a switch unit 109 for the occupant to perform operations such as for opening/closing the windows. A heater 110 composed of an electric heating wire or the like may be built in the armrest 103.

The door trim 101 is provided with a pull pocket member 113 on the armrest 103. The pull pocket member 113 has a box shape that is open upward and defines a pull pocket space 114 that is recessed downward from the armrest upper wall 10. The pull pocket member 113 functions as a grip to be grasped by the occupant when opening and closing the door D. The pull pocket member 113 is made of resin.

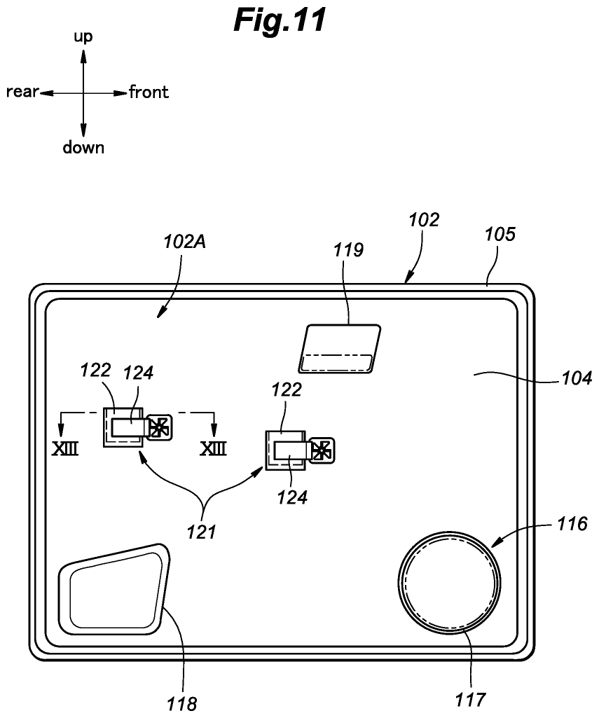

With reference to FIG. 11, a speaker grille 116 is provided on a front lower portion of the trim main body 102. The speaker grille 116 covers an inboard side of a speaker 117. A protector 118 is disposed on an outboard side of a rear lower portion of the trim main body 102. The protector 118 is made of synthetic resin material such as polypropylene, and absorbs shock applied to the door panel P when the vehicle has a side collision. On an upper portion of the trim main body 102, a door handle 119 for opening and closing the door D from the inboard side is installed.

### Abnormal Noise Suppression Structure

As shown in FIG. 11, abnormal noise suppression structures 121 are provided on an upper part of the back side 102A of the main surface part 104. The abnormal noise suppression structures 121 are provided to suppress generation of sound caused by the back side 102A of the main surface part 104 coming into contacting with the inboard surface of the door panel P due to vibration caused during travel of the vehicle or vibration caused when the door D is opened or closed, for example.

FIG. 11 shows an example in which the back side 102A of the main surface part 104 is provided with two abnormal noise suppression structures 121 spaced from each other in the front-rear direction. Note, however, that the present invention is not limited by the number of abnormal noise suppression structures 121. For example, only one abnormal noise suppression structure 121 may be provided on the trim main body 102, or three or more abnormal noise suppression structures 121 may be provided on the trim main body 102. In the following, description will be made of the abnormal noise suppression structures 121 based on the state in which the door trim 101 is assembled to the door panel P (see FIG. 10).

In the present embodiment, the abnormal noise suppression structures 121 are disposed to avoid the speaker grille 116, the protector 118, and the door handle 119. For example, as shown in FIG. 11, each of the abnormal noise suppression structures 121 is disposed higher than the speaker grille 116 and the protector 118 and lower than the door handle 119.

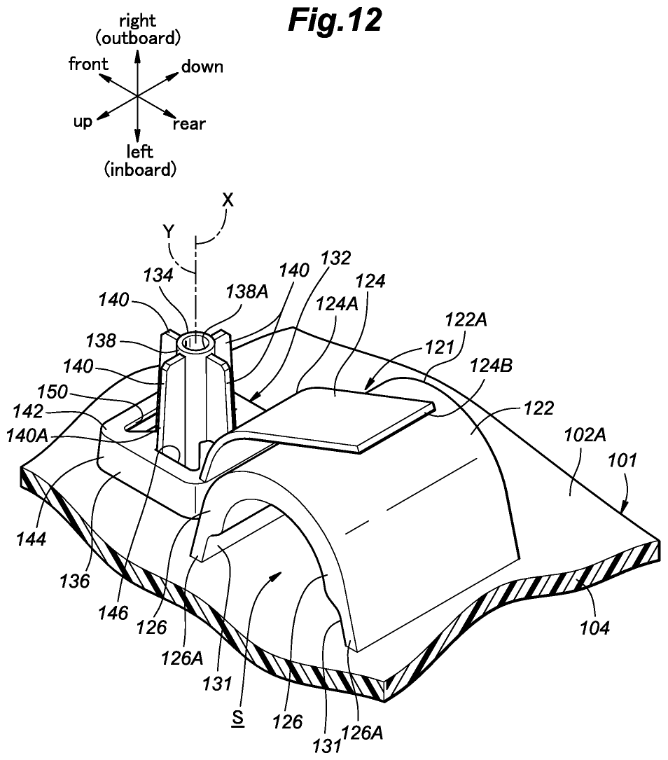

Next, with reference to FIGS. 12 to 14, details of the abnormal noise suppression structures 121 will be described. Each of the abnormal noise suppression structures 121 includes a protruding part 122 (also called a stopper) and an elastic piece 124 (also called an elastic protrusion) each provided on the back side 102A of the trim main body 102.

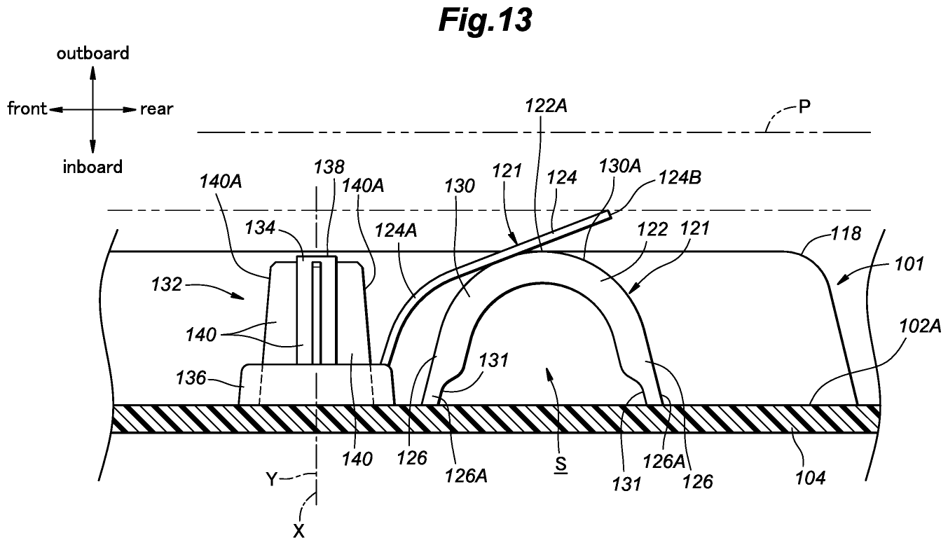

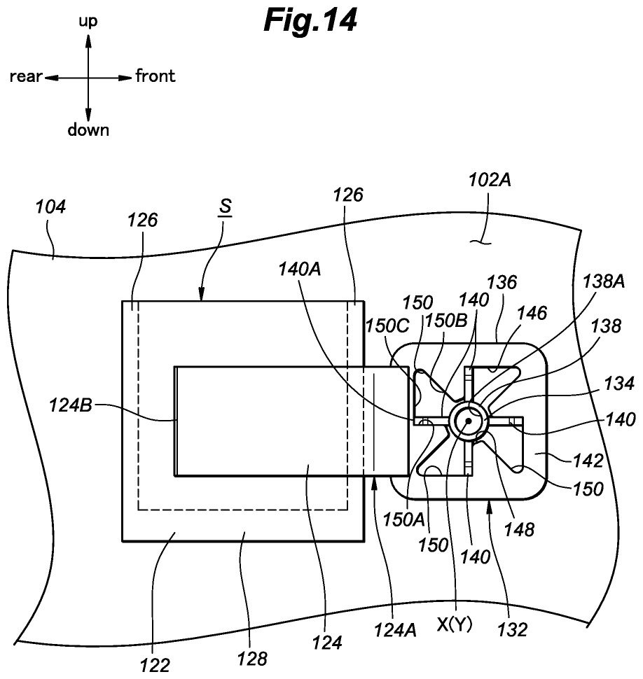

As shown in FIGS. 12 and 13, the protruding part 122 protrudes from the back side 102A of the main surface part 104 in the outboard direction, namely, toward the door panel P. As shown in FIGS. 12 and 14, the protruding part 122 is provided with a pair of main wall portions 126 protruding in the outboard direction and a sealing wall 128 (see FIG. 14) connecting the two main wall portions 126 to each other.

As shown in FIG. 13, each of the main wall portions 126 has a plate shape having surfaces facing substantially in the forward and rearward directions on the base end side. The main wall portions 126 extend vertically and are disposed to oppose each other in the front-rear direction. The mutually opposing surfaces of base end portions 126A of the main wall portions 126 are provided with recessed parts 131 that are recessed in directions away from each other. Thereby, the thickness of the base end portion of each main wall portion 126 is reduced compared to the other portion.

As shown in FIG. 12 and FIG. 13, the main wall portions 126 are curved in directions toward each other and are connected to each other at extension ends. Thereby, the protruding part 122 is configured to have a curved part 130 that is curved in an arc shape toward the door panel P (outboard side) and protrudes in the outboard direction. The curved part 130 has an arch shape protruding toward the door panel P as seen in the up-down direction. The surface of the curved part 130 facing the door panel P constitutes a contact surface 130A having an arc shape as seen in the up-down direction.

As shown in FIG. 14, the sealing wall 128 has a plate shape connecting the lower edges of the two main wall portions 126. The sealing wall 128 seals a lower end portion of a space S defined between the two main wall portions 126 (namely, an inner space of the protruding part 122).

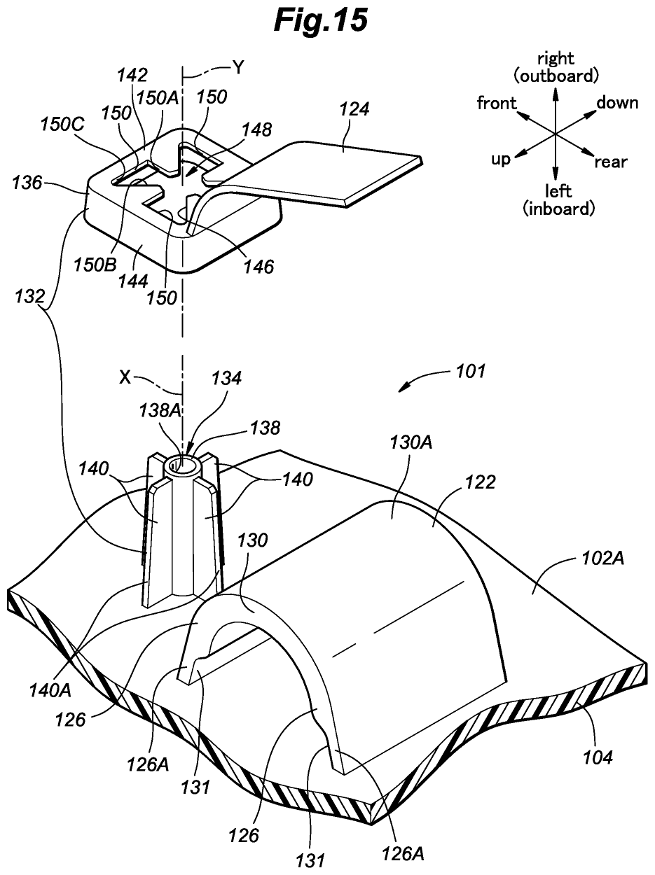

As shown in FIG. 15, in the present embodiment, the protruding part 122 is integrally molded with the trim main body 102.

As shown in FIG. 13, the elastic piece 124 is provided on the back side 102A of the main surface part 104. The elastic piece 124 has a rectangular thin plate shape protruding in the outboard direction from a part of the back side 102A of the main surface part 104 adjacent to the protruding part 122 (specifically, in the front vicinity of the protruding part 122). The elastic piece 124 extends substantially in the outboard direction from the part adjacent to the protruding part 122, and extends, via a bent part 124A, in a direction inclined in the outboard direction toward the protruding part 122 (namely, toward the rear). The elastic piece 124 extends rearward and outboard beyond the top 122A of the protruding part 122 (namely, the outboard end portion of the curved part 130). The tip 124B of the elastic piece 124 is positioned outboard of the top 122A of the protruding part 122.

As shown in FIG. 12, in the present embodiment, the elastic piece 124 is disposed to overlap the protruding part 122 from the front side. Note, however, that the present invention is not limited by the direction in which the elastic piece 124 extends. Specifically, the elastic piece 124 may be disposed to overlap the protruding part 122 from the rear side, upper side, or lower side. In other words, the protruding part 122 and the elastic piece 124 may be arranged in the front-rear direction or in the up-down direction.

When the door trim 101 is assembled with the door panel P, the tip 124B of the elastic piece 124 contacts the inboard surface of the door panel P and is pressed in the inboard direction. Due to the pressing force, the elastic piece 124 is brought into a slightly pressed and bent state, namely, an elastically deformed state. The elastic piece 124 deforms to follow the movement of the door panel P toward the door trim 101 or the movement of the door trim 101 toward the door panel P, so that the tip 124B thereof is maintained to be in contact with the door panel P.

In the present embodiment, when the door trim 101 is assembled with the door panel P, the elastic piece 124 is in contact with the protruding part 122 at a part between the base end and the tip 124B. Specifically, the elastic piece 124 is in contact a surface of the curved part 130 facing the door panel P, namely, the contact surface 130A. The contact position between the elastic piece 124 and the protruding part 122 is located inboard of the outboard end portion (the top 122A) of the curved part 130 and is shifted toward the base end of the elastic piece 124 (namely, forward) relative to the outboard end portion of the curved part 130.

The contact position between the elastic piece 124 and the protruding part 122 changes with the movement of the door panel P toward the main surface part 104 or the movement of the main surface part 104 toward the door panel P. For example, when the main surface part 104 moves in the direction toward the door panel P, the tip 124B of the elastic piece 124 is pressed toward the trim main body 102 and the elastic piece 124 is bent more strongly. At this time, the elastic piece 124 and the protruding part 122 are maintained in the contacting state, while the tip 124B of the elastic piece 124 is displaced toward the contact surface 130A. Therefore, as the main surface part 104 and the door panel P approach each other, the contact position between the elastic piece 124 and the protruding part 122 moves in a direction away from the base end of the elastic piece 124.

Also, when the main surface part 104 moves in the direction away from the door panel P, the elastic piece 124 extends, and the tip 124B of the elastic piece 124 moves toward the door panel P. At this time, the elastic piece 124 and the protruding part 122 are maintained in the contacting state, and the tip 124B of the elastic piece 124 is displaced away from the contact surface 130A. Therefore, as the main surface part 104 and the door panel P move away from each other, the contact position between the elastic piece 124 and the protruding part 122 moves toward the base end of the elastic piece 124. In this way, even when the main surface part 104 and the door panel P move toward/away from each other, the elastic piece 124 and the protruding part 122 are maintained in the contacting state.

In the present embodiment, as shown in FIG. 15, the elastic piece 124 is a separate member from the trim main body 102, and is joined to the trim main body 102 (specifically, the back side 102A of the main surface part 104) via a locking structure 132.

Next, the locking structure 132 will be described in detail. As shown in FIG. 12, the locking structure 132 is configured by a columnar body 134 provided on the trim main body 102 and a base portion 136 (also called a base) provided on the elastic piece 124.

The columnar body 134 protrudes from the back side 102A of the main surface part 104 toward the door panel P (in the outboard direction). The columnar body 134 has a non-circular cross section. In the present embodiment, the columnar body 134 is rotationally symmetric (specifically, four-fold symmetric) about an axis X perpendicular to the back side 102A of the main surface part 104. The columnar body 134 includes a main part 138 protruding from the back side 102A of the main surface part 104 and multiple ribs 140 provided on the main part 138.

The main part 138 has a cylindrical shape about the axis X and extends in the outboard direction (toward the door panel P). Namely, the axis X of the main part 138 coincides with the axis X of the columnar body 134. The main part 138 is connected to the back side 102A of the main surface part 104 at the base end thereof. Due to the columnar body 134 and the trim main body 102, a recessed part 138A recessed from the extension end of the main part 138 toward the trim main body 102 is formed on the door trim 101.

Each of the ribs 140 has a plate shape protruding from the outer circumferential surface of the main part 138. Each of the ribs 140 protrudes in a direction perpendicular to the outer circumferential surface of the main part 138. The ribs 140 extend from the base end side of the main part 138 along the protruding direction of the main part 138 in the direction away from the trim main body 102 (in the outboard direction). The ribs 140 are arranged on the outer circumferential surface of the main part 138 at equal intervals in the circumferential direction. In the present embodiment, the columnar body 134 is provided with four ribs 140. The ribs 140 are arranged to be rotationally symmetric about the axis X of the main part 138. As shown in FIG. 13, the protruding end surface 140A of each rib 140 is inclined in a direction away from the outer circumferential surface of the main part 138 as it extends toward the trim main body 102 (specifically, the back side 102A of the main surface part 104).

As shown in FIG. 15, the base portion 136 has a rectangular dish shape provided with a square plate-shaped upper wall 142 and a square tubular peripheral wall 144 extending from the edge part of the upper wall 142 in a direction substantially perpendicular (orthogonal) to the upper wall 142. The upper wall 142 is provided with a locking hole 146 which penetrates the upper wall 142 in the thickness direction and into which the columnar body 134 protrudes in a lockable manner.

As shown in FIGS. 14 and 15, the locking hole 146 has a non-circular cross section. In the present embodiment, the locking hole 146 is rotationally symmetric (specifically, four-fold symmetric) about an axis Y perpendicular to the upper wall 142. The locking hole 146 includes a central part 148 which can receive the main part 138 of the columnar body 134 and multiple wing parts 150 extending radially outward from the periphery of the central part 148 and each capable of receiving one of the ribs 140. The locking hole 146 is provided with the same number of wing parts 150 as the ribs 140 (in the present embodiment, four).

The central part 148 is a circular through hole penetrating the upper wall 142, with a center thereof being on the axis Y of the locking hole 146. Namely, the axis Y of the central part 148 coincides with the axis Y of the locking hole 146. The central part 148 is provided at approximately the center of the upper wall 142. The central part 148 has an inner diameter greater than the outer diameter of the columnar body 134. Thus, the central part 148 is configured such that the main part 138 can pass.

Each of the wing parts 150 extends outward from the periphery of the central part 148. Each of the wing parts 150 substantially has a shape of a right triangle in front view of the upper wall 142 and is connected to the central part 148 at one end. Each wing part 150 is defined by a first surface 150A extending from the axis Y of the central part 148 in a direction perpendicular to the edge part of the upper wall 142, a second surface 150B extending from the axis Y of the locking hole 146 toward a corner of the upper wall 142 to form an angle of about 45 degrees with respect to the first surface 150A, and a third surface 150C substantially parallel with the edge part of the upper wall 142. The wing parts 150 are arranged to be rotationally symmetric (specifically, four-fold symmetric) about the axis Y of the central part 148.

The width of the locking hole 146 in the direction from the axis Y toward a corner of the upper wall 142 is set to be equal to or slightly greater than the maximum value of the length from the axis X of the main part 138 to the protruding end surface 140A of each rib 140. The width of the locking hole 146 the axis Y in the direction perpendicular to the edge of the upper wall 142 is set to be equal to or slightly smaller than the length from the axis X of the main part 138 to the protruding end surface 140A of each rib 140 at a position spaced from the base end of the main part 138 by the extension length of the peripheral wall 144. Namely, the distance from the axis Y of the central part 148 to at least a part (specifically, a part adjacent to the second surface 150B) of the third surface 150C defining the wing part 150 is set to be smaller than the distance from the axis X of the corresponding main part 138 to the protruding end surface 140A of each rib 140.

As shown in FIG. 14, the ribs 140 are respectively received in the wing parts 150. Each rib 140 contacts, at the protruding end surface 140A thereof, a part of the third surface 150C adjacent to the first surface 150A. Since the distance from the axis Y of the central part 148 to the third surface 150C defining the wing part 150 is set, at the part adjacent to the second surface 150B, to be smaller than the distance from the axis X of the corresponding main part 138 to the protruding end surface 140A of each rib 140, each rib 140 is in pressure contact, at the protruding end surface 140A thereof, with a part of the third surface 150C adjacent to the first surface 150A. Thereby, the base portion 136 is frictionally locked to the columnar body 134, and the elastic piece 124 is fixed, at the base end side thereof, to the trim main body 102 via the locking structure 132.

The base end of the elastic piece 124 is joined to an edge part of the base portion 136 to be in parallel therewith. In the present embodiment, the width of the base end of the elastic piece 124 is substantially the same as that of the locking hole 146. The base end of the elastic piece 124 overlaps the entirety of the locking hole 146 as seen in the direction perpendicular to the edge part of the base portion 136 to which the base end of the elastic piece 124 is joined.

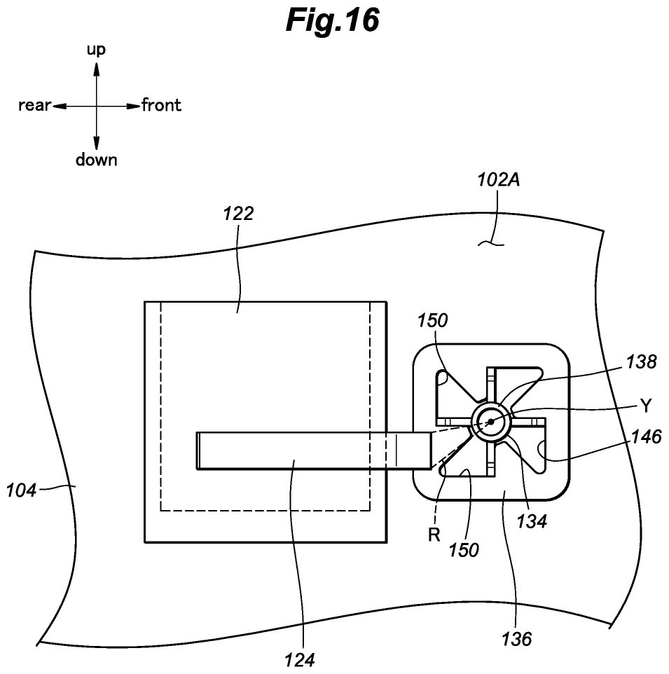

Note, however, that the width of the base end of the elastic piece 124 is not limited to this aspect. For example, the width of the base end of the elastic piece 124 may be slightly smaller than a half of the width of the locking hole 146. In this case, as shown in FIG. 16, the wing parts 150 are preferably provided in positions avoiding a region R connecting the axis Y of the locking hole 146 and the base end portion of the elastic piece 124. Thereby, the elastic piece 124 can be joined to a part of the upper wall 142 that is not thinned by the locking hole 146. Thus, compared to the case where the elastic piece 124 is joined to a part thinned by the locking hole 146, the elastic piece 124 and the base portion 136 are less easily separated, and the elastic piece 124 and the base portion 136 are joined firmly.

Next, an assembly method of the door trim 101 configured as above will be described.

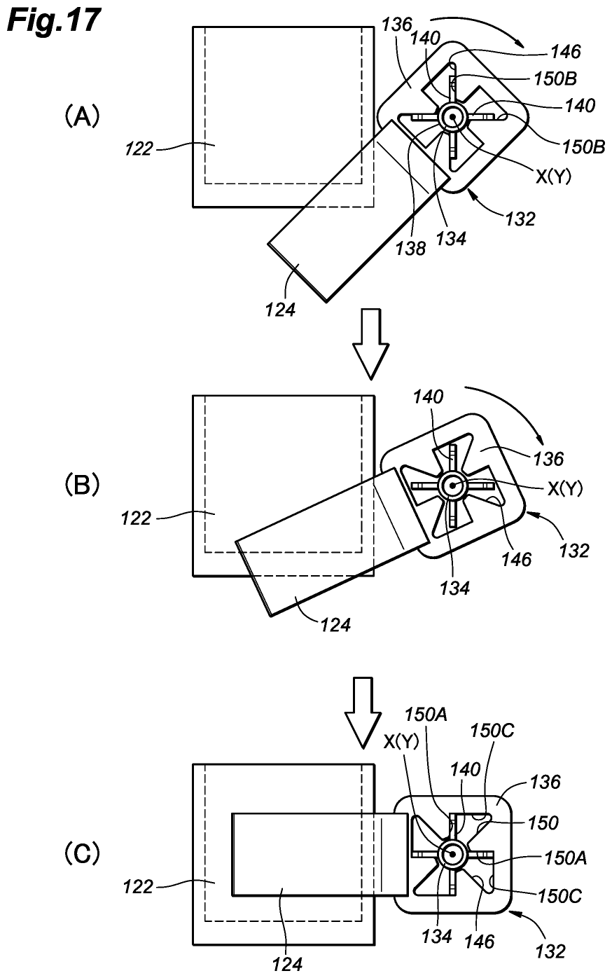

As shown in FIG. 17(A), a worker who assembles the door trim 101 inserts the columnar body 134 into the locking hole 146 such that each rib 140 is disposed along the second surface 150B. At this time, since the width of the locking hole 146 from the axis Y in the direction toward each corner of the upper wall 142 is set to be equal to or slightly greater than the maximum value of the length from the axis X of the columnar body 134 to the protruding end surface 140A of each rib 140, the columnar body 134 is loosely fitted in the locking hole 146. Therefore, the worker can move the base portion 136 toward the trim main body 102 until the peripheral wall 144 comes into contact with the back side 102A of the main surface part 104. As shown in FIG. 17(A), the position of the base portion 136 where each of the ribs 140 is disposed along the second surface 150B and the peripheral wall 144 contacts the back side 102A of the main surface part 104 is referred to as a loose fitting position. When the base portion 136 is in the loose fitting position, the columnar body 134 is loosely fitted in the locking hole 146, and the base portion 136 is movable in the protruding direction of the columnar body 134.

Thereafter, the worker rotates the base portion 136 about the central axis of the central part 148, as indicated by arrows in FIGS. 17(A) and 17(B). As a result, as shown in FIG. 17(C), each rib 140 comes into contact, at the protruding end surface 140A thereof, with a part of the third surface 150C adjacent to the first surface 150A, whereby the rib 140 is bought into pressure contact, at the protruding end surface 140A thereof, with the part of the third surface 150C adjacent to the first surface 150A. Thereby, the base portion 136 is locked to the columnar body 134, and the elastic piece 124 is fixed, at the base end side thereof, to the trim main body 102 via the locking structure 132. As shown in FIG. 17(C), the position of the base portion 136 where each rib 140 is in pressure contact with the third surface 150C defining the locking hole 146, the base portion 136 is frictionally engaged with the columnar body 134, and the base portion 136 is locked to the columnar body 134 is referred to as an engagement position.

When moving the base portion 136 from the loose fitting position to the engagement position, it is preferred that the worker rotates the base portion 136 about the central axis of the central part 148 while moving the base portion 136 toward the trim main body 102 or applying a load to the base portion 136 toward the trim main body 102. Thereby, it is possible to more reliably lock the base portion 136 to the base end side of the columnar body 134.

Next, the effects of the door trim 101 configured as above will be described. As shown in FIG. 13, when a load is applied to the trim main body 102 or the door panel P in a direction in which the trim main body 102 approaches the door panel P, the elastic piece 124 elastically deforms due to the load. This elastic deformation absorbs the load, and the generation of sound caused by contact between the door panel P and the trim main body 102 or a member provided on the trim main body 102 (for example, the protector 118) is suppressed.

Also, the elastic piece 124 is assembled beforehand to be in the state contacting the trim main body 102, and undergoes elastic deformation while maintaining the state contacting the trim main body 102. Therefore, the generation of sound which may be caused when the elastic piece 124 comes into contact with the door panel P can be suppressed.

The elastic piece 124 contacts the protruding part 122 at a part thereof between the base end and the tip 124B. Therefore, compared to the case where the protruding part 122 is not provided, the elastic piece 124 is less likely to contact the trim main body 102 at the tip thereof, and the generation of sound due to contact between the elastic piece 124 and the trim main body 102 can be suppressed. Further, since the elastic piece 124 is already in contact with the protruding part 122 when assembled and the contacting state is maintained, the generation of sound due to contact of the elastic piece 124 with the protruding part 122 can be also suppressed.

In the case where the trim main body 102 is manufactured by injection molding using molds or the like, for example, it is necessary to remove the molds after the molding. However, when trying to form the elastic piece 124 and the protruding part 122 simultaneously, removal of the molds may become difficult and manufacture of the trim main body 102 may become difficult.

In the present invention, the door trim 101 provided with the protruding part 122 and the elastic piece 124 can be configured by integrally molding the protruding part 122 with the trim main body 102 beforehand, and thereafter locking the base portion 136 of the elastic piece 124 to the columnar body 134 of the trim main body 102. Therefore, compared to the case where the elastic piece 124 and the protruding part 122 are integrally mold with the trim main body 102, the configuration of the trim main body 102 is simplified, and hence, manufacture of the door trim 101 is easy. Also, in the case where only the protruding part 122 can be integrally molded with the trim main body 102 but it is difficult to integrally mold the elastic piece 124 and the protruding part 122 with the trim main body 102 simultaneously, the present invention can allow the door trim 101 to be provided with the elastic piece 124 and the protruding part 122 because the elastic piece 124 can be prepared as a separate member.

Further, by providing the protruding part 122 and the columnar body 134 on the back side 102A of the trim main body 102 in a position where it is difficult to integrally mold the elastic piece 124 and the protruding part 122, it is possible to install the abnormal noise suppression structure 121 in the position where it is difficult to integrally mold the elastic piece 124 and the protruding part 122, whereby layout performance of the door trim 101 is improved.

When the worker inserts the columnar body 134 into the locking hole 146 to put the base portion 136 in the loose fitting position and thereafter rotates the base portion 136 (or the elastic piece 124) into the engagement position, the protruding end surface 140A of each rib 140 is brought into pressure contact with a part of the third surface 150C adjacent to the first surface 150A and the base portion 136 is frictionally engaged with the columnar body 134, whereby the elastic piece 124 is locked to the trim main body 102 at one end thereof. Thus, the process for locking the elastic piece 124 to the trim main body 102 is simple, and the assembly of the door trim 101 is easy.

The protruding end surface 140A of each rib 140 is inclined in a direction away from the outer circumferential surface of the columnar body 134 as it extends toward the trim main body 102. As a result, when the base portion 136 is moved toward the trim main body 102, the third surface 150C defining each wing part 150 and the protruding end surface 140A of one of the ribs 140 come into pressure contact with each other more firmly. Therefore, the base portion 136 can be frictionally engaged with the trim main body 102 more firmly. Also, compared to the case where the protruding end surface 140A of each rib 140 is parallel to the outer circumferential surface of the columnar body 134, it is easy to engage the base portion 136 with a part of the columnar body 134 positioned closer to the trim main body 102. Therefore, the elastic piece 124 can be supported firmly by the trim main body 102.

### Third Embodiment

The door trim 101 according to the third embodiment differs from the second embodiment in that the elastic piece 124 and the protruding part 122 are formed as an integral member, and the elastic piece 124 and the protruding part 122 are formed as a separate body from the trim main body 12. The other configurations are the same as those of the second embodiment, and thus, description of the other configurations will be omitted.

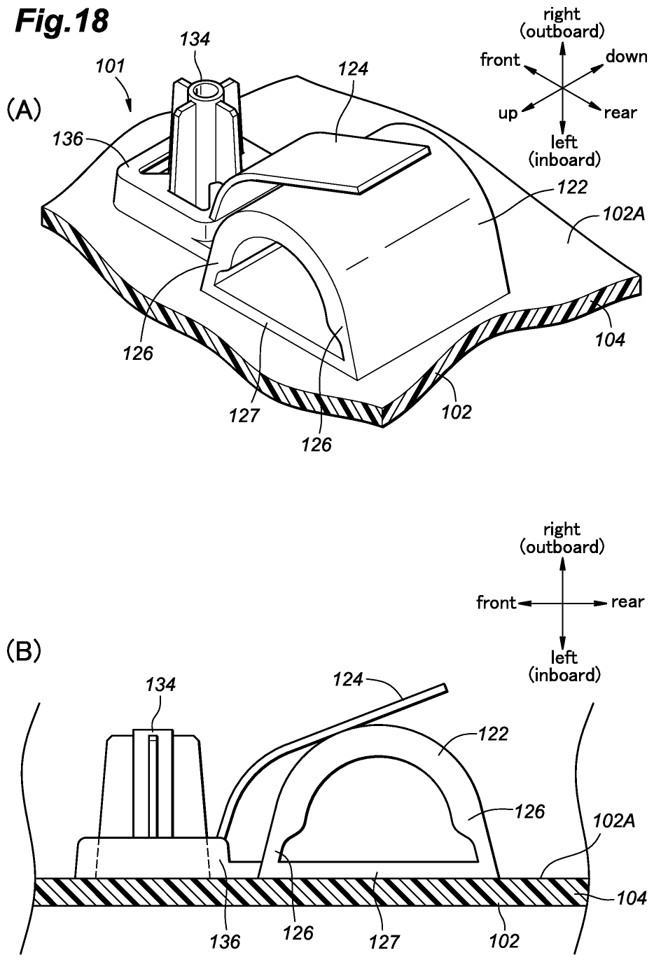

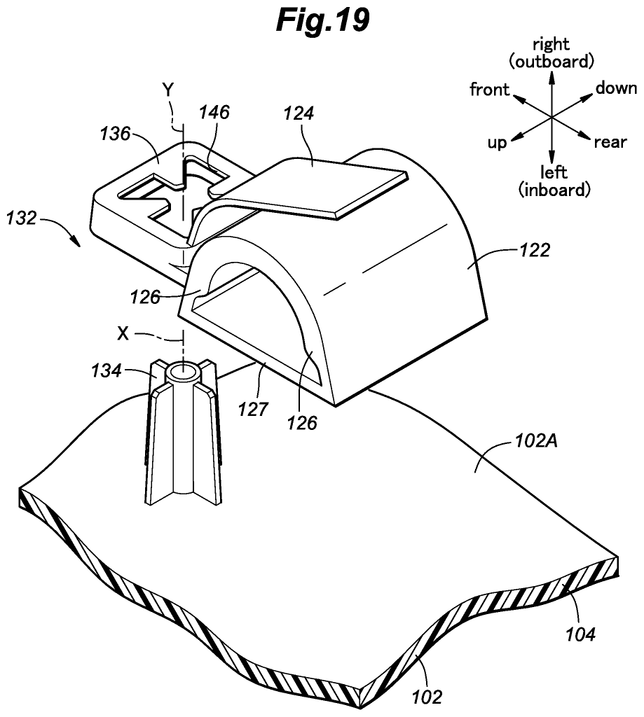

As shown in FIGS. 18(A) and 18(B), the elastic piece 124 and the protruding part 122 are each connected to the base portion 136 and, as shown in FIG. 19, the elastic piece 124, the protruding part 122, and the base portion 136 form an integral body. In the present embodiment, the base ends of the two main wall portions 126 are connected by a connection wall 127. Note, however, the present invention is not limited to this aspect, and the connection wall 127 may be not provided. However, with the base ends of the two main wall portions 126 being connected by the connection wall 127, the protruding part 122 becomes hard to be deformed by a load from the outboard side, and the elastic piece 124 can be supported more firmly from the inboard side.

Next, the effects of the door trim 101 according to the third embodiment will be described. By locking the base portion 136 to the columnar body 134, it is possible to provide the elastic piece 124 and the protruding part 122 on the back side 102A of the trim main body 102. Therefore, even in the case where it is difficult to integrally mold the elastic piece 124 and the protruding part 122 with the trim main body 102 or in the case where the elastic piece 124 and the protruding part 122 are to be locked onto a ready-made trim main body 102, it is possible to provide the elastic piece 124 and the protruding part 122 on the trim main body 102, whereby the abnormal noise suppression structure 121 can be easily configured on the door trim 101.

### Fourth Embodiment

The door trim 101 according to the fourth embodiment differs from the second embodiment in that the structure of a locking structure 162, particularly, the structure of a base portion 166, is different from that of the second embodiment, while the other configurations are the same as those of the second embodiment. Thus, description of the other configurations will be omitted, and the configuration of the base portion 166 will be described in the following.

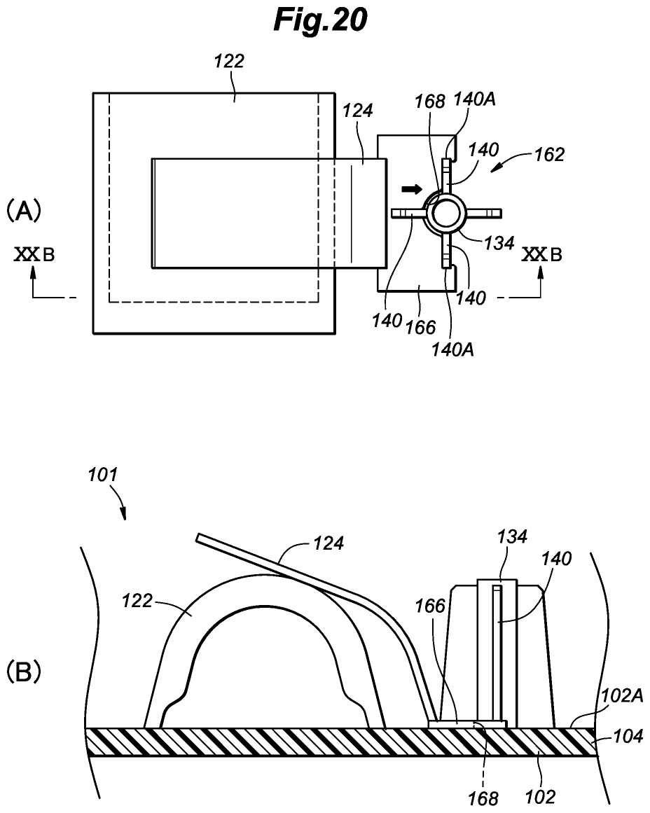

As shown in FIGS. 20(A) and 20(B), the base portion 166 according to the fourth embodiment has a flat plate shape connected to the elastic piece 124 at one end thereof. The base portion 166 is provided with a notch 168 that is recessed inward from an edge part thereof and is capable of receiving the columnar body 134. When the columnar body 134 is received in the notch 168, the multiple ribs 140 are each in pressure contact, at the protruding end surface 140A thereof, with the wall surface defining the notch 168. Thereby, the base portion 166 is frictionally engaged with the columnar body 134, and the elastic piece 124 is fixed to the trim main body 102. In the present embodiment, the base portion 166 is locked to the columnar body 134 with the protruding end surface 140A of each of the three ribs 140 provided on the columnar body 134 being in pressure contact with the wall surface defining the notch 168 of the base portion 166.

Next, assembly of the door trim 101 according to the fourth embodiment will be described. The worker sets the base portion 166 such that the main surface thereof is substantially parallel to the protruding direction of the columnar body 134, and pushes the columnar body 134 into the notch 168 (see the arrow in FIG. 20(A)). Thereby, the protruding end surface 140A of each rib 140 is brought into pressure contact with the wall surface defining the notch 168, and the base portion 166 is locked to the columnar body 134, whereby the elastic piece 124 is fixed to the trim main body 102. Namely, the base portion 166 and the columnar body 134 constitute the locking structure 162 for locking the elastic piece 124 to the trim main body 102.

Next, the effects of the door trim 101 configured as above will be described. The elastic piece 124 is formed as a separate member from the trim main body 102, and is joined to the trim main body 102 via the locking structure 162. Therefore, even in the case where it is difficult to integrally mold the elastic piece 124 with the trim main body 102, it is possible to provide the door trim 101 with the abnormal noise suppression structure 121. Since the elastic piece 124 can be locked to the trim main body 102 by pushing the columnar body 134 into the notch 168, it is possible to easily join the elastic piece 124 to the trim main body 102. Also, since the locking structure 162 is configured by providing the notch 168 in the base portion 166, the structure thereof is simple and manufacture of the door trim 101 is easy.

### Fifth Embodiment

The door trim 101 according to the fifth embodiment differs from the second embodiment in that the structure of a locking structure 172, particularly, the structure of a base portion 176, is different from that of the second embodiment, while the other configurations are the same as those of the second embodiment. Thus, description of the other configurations will be omitted, and the configuration of the base portion 176 will be described in the following.

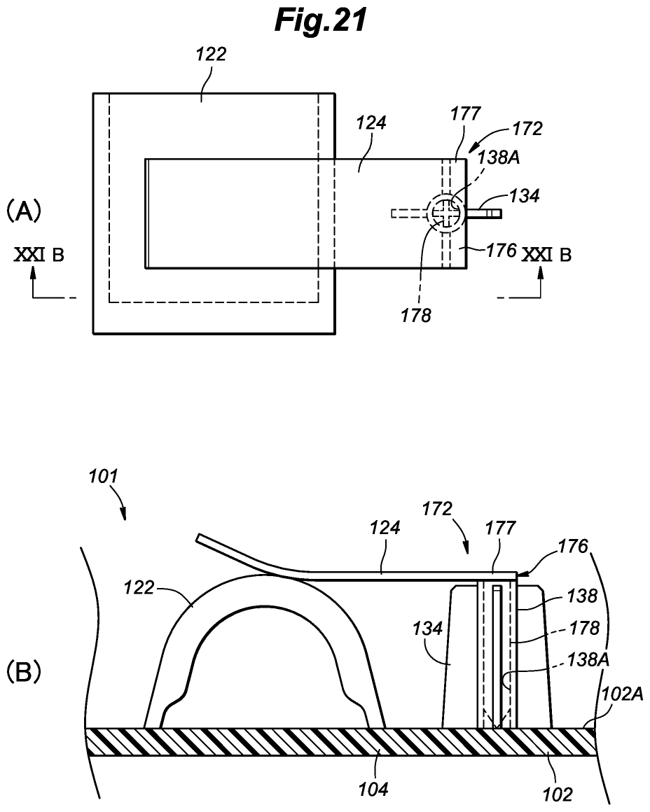

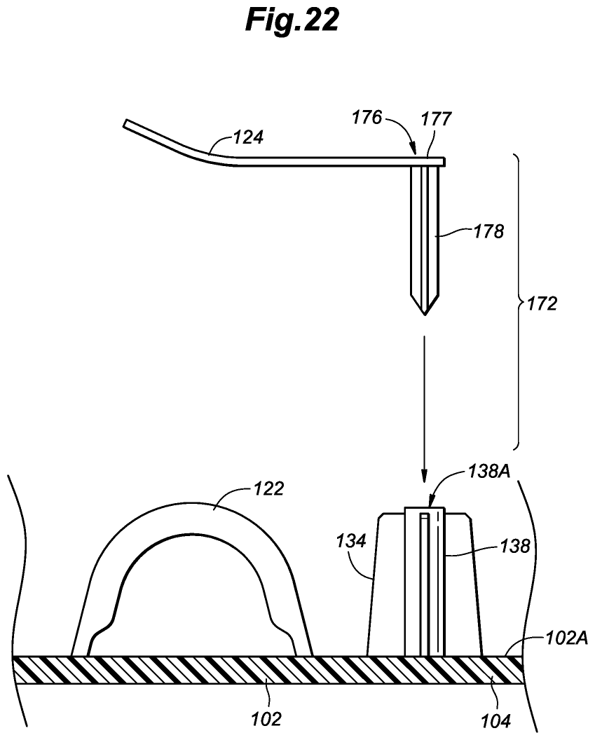

As shown in FIGS. 21(A) and 21(B), similarly to the second embodiment, the base portion 176 is connected to one end of the elastic piece 124. As shown in FIG. 22, the base portion 176 is provided with a flat plate part 177 having a flat plate shape and connected to the elastic piece 124 and an insertion part 178 protruding from the flat plate part 177. As shown in FIG. 21(A), the insertion part 178 has a cross-shaped cross section and has a substantially rod shape extending in a direction perpendicular to the flat plate part 177. As shown in FIG. 22, the tip of the insertion part 178 is preferably configured to be tapered. As shown in FIG. 21(B), the insertion part 178 is configured to be capable of being press-fitted into the recessed part 138A provided in the main part 138 of the columnar body 134. When the insertion part 178 is press-fitted into the recessed part 138A, the outer surface of the insertion part 178 comes into pressure contact with the wall surface defining the recessed part 138A and is frictionally engaged with the same, whereby the elastic piece 124 is fixed to the trim main body 102. Namely, the base portion 176 and the columnar body 134 constitute the locking structure 172 for locking the elastic piece 124 to the trim main body 102.

Next, the effects of the door trim 101 configured as above will be described. The tip of the columnar body 134 is provided with the recessed part 138A (engagement recess) that is recessed toward the trim main body 102, and the base end of the elastic piece 124 is provided with the insertion part 178 (engagement part) configured to protrude into the recessed part 138A. When the worker press-fits the insertion part 178 into the recessed part 138A, the insertion part 178 is frictionally engaged with the wall surface defining the recessed part 138A, and the elastic piece 124 is fixed to the trim main body 102. In this way, it is possible to assemble the elastic piece 124 with the trim main body 102 by press-fitting the elastic piece 124 into the recessed part 138A, and therefore, manufacture of the door trim 101 is easy. Also, since the insertion part 178 is configured to be locked to the recessed part 138A by being press-fitted into the same, the structure is simple.

### Sixth Embodiment

The door trim 101 according to the sixth embodiment differs from the fifth embodiment in that the configuration of a locking structure 179, particularly, the configuration of the insertion part 178 and the recessed part 138A, is different from that of the second embodiment, while the other configurations are the same as those of the second embodiment. Thus, description of the other configurations will be omitted, and the configuration of the base portion 136 will be described in the following.

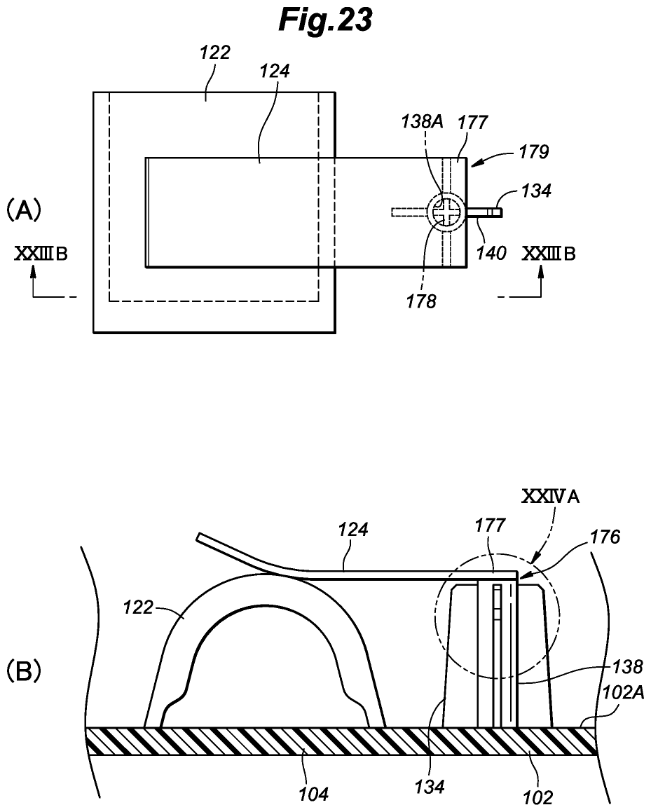

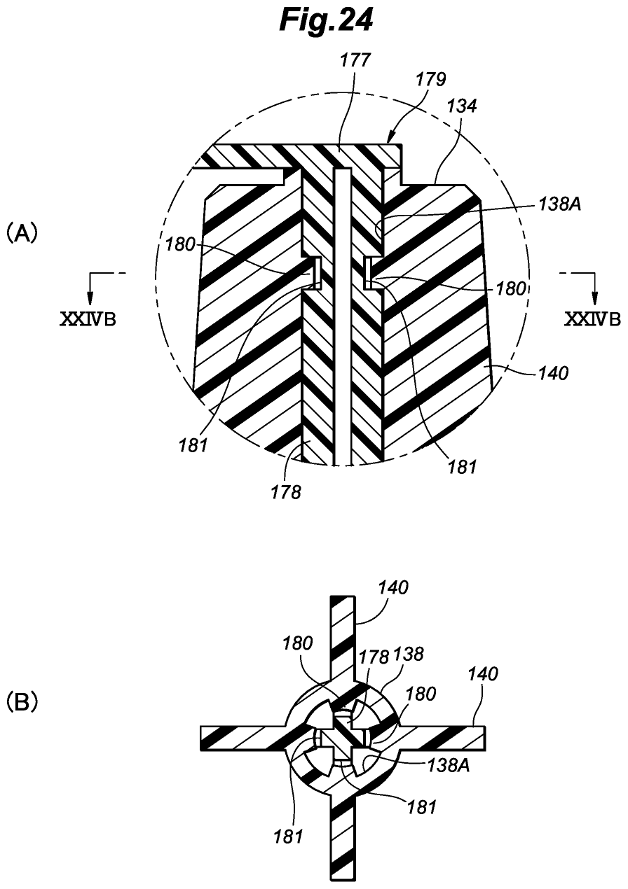

As shown in FIGS. 23(A) and 23(B), similarly to the fifth embodiment, the base portion 136 is provided with the flat plate part 177. As shown in FIGS. 24(A) and 24(B), Further, similarly to the fifth embodiment, the base portion 136 is provided with the insertion part 178. As shown in FIG. 23(A), the insertion part 178 is press-fitted into the recessed part 138A and the outer surface of the insertion part 178 is in pressure contact with the wall surface defining the recessed part 138A and is frictionally engaged with the same, whereby the elastic piece 124 is fixed to the trim main body 102.

As shown in FIGS. 24(A) and 24(B), the wall surface defining the recessed part 138A is provided with locking claws 180 that protrude inward. The outer surface of the insertion part 178 is provided, in positions aligned with the locking claws 180, with locking recesses 181 that are recessed toward the axis.

Next, the effects of the door trim 101 configured as above will be described. Similarly to the fifth embodiment, when the worker press-fits the insertion part 178 into the recessed part 138A, the insertion part 178 is frictionally engaged with the wall surface defining the recessed part 138A, whereby the elastic piece 124 is fixed to the trim main body 102. In this way, it is possible to assemble the elastic piece 124 with the trim main body 102 by press-fitting the elastic piece 124 into the recessed part 138A, and therefore, manufacture of the door trim 101 is easy.

Further, when the worker pushes the elastic piece 124 into the recessed part 138A, the locking claws 180 protrude into the locking recesses 181. Therefore, compared to the fifth embodiment, the elastic piece 124 and the columnar body 134 can be joined more firmly.

### Seventh Embodiment

The door trim 101 according to the seventh embodiment differs from the second embodiment with respect to a locking structure 182, while the other configurations are the same as those of the second embodiment. Thus, description of the other configurations will be omitted, and the configuration of the locking structure 182 will be described in the following.

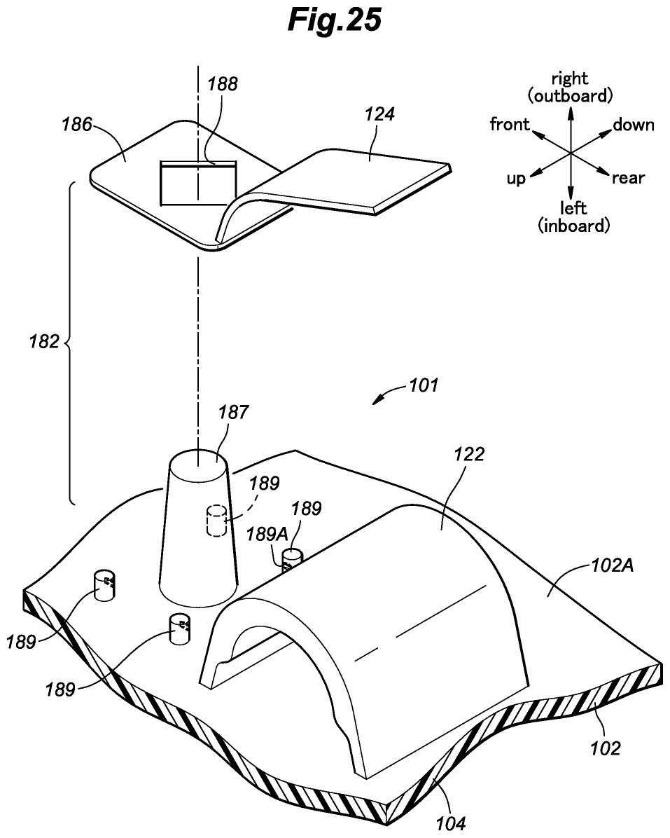

As shown in FIG. 25, similarly to the second embodiment, the locking structure 182 includes a base portion 186 joined to the elastic piece 124 and a columnar body 187 provided on the back side 102A of the main surface part 104. Unlike the second embodiment, the base portion 186 has a rectangular flat plate shape. One end of the elastic piece 124 is joined to a short-side edge part of the base portion 186.

The base portion 186 is provided with a locking hole 188. The locking hole 188 is a through hole penetrating the base portion 186 and, in the present embodiment, has a square shape. The columnar body 187 has a columnar shape protruding from the back side 102A of the main surface part 104. The columnar body 187 has a truncated cone shape having a diameter decreasing toward the tip. The tip of the columnar body 187 can pass through the locking hole 188, while the base end of the columnar body 187 is configured to be unable to pass through the locking hole 188.

Further, multiple locking parts 189 are provided on a part of the back side 102A of the main surface part 104 in the vicinity of the columnar body 187. The locking part 189 may have any shape so long as they cooperate to engage with the edge part of the base portion 186 and prevent removal of the base portion 186 from the trim main body 102 as well as rotation of the base portion 186. In the present embodiment, the trim main body 102 is provided with four locking parts 189 each being configured to engage with the edge part of the base portion 186. Each of the locking parts 189 forms a cylindrical column protruding from the back side 102A of the main surface part 104. Each of the locking parts 189 is provided, in the vicinity of the tip thereof, with a recessed part 189A for receiving an end portion of the base portion 186.

Next, assembly of the door trim 101 will be described. The worker grasps the base portion 186 joined to the elastic piece 124, and moves it such that the tip of the columnar body 187 is inserted into the locking hole 188. At this time, the base portion 186 is in a loose fitting position in which the columnar body 187 is loosely fitted in the locking hole 188.

Thereafter, when the worker moves the base portion 136 toward the trim main body 102 along the protruding direction of the columnar body 187, the base portion 136 is brought into an engagement position in which the columnar body 187 is frictionally engaged with the wall surface defining the locking hole 188. At this time, as shown in FIG. 25, the end portions of the base portion 136 are received in the recessed parts 189A respectively provided to the locking parts 189, and the base portion 136 is in a locking position in which the base portion 136 is locked to the trim main body 102.

Next, the effects of the door trim 101 configured as above will be described. By moving the base portion 136 toward the trim main body 102, the columnar body 187 is brought into frictional engagement with the wall surface defining the locking hole 188 and the elastic piece 124 is fixed to the trim main body 102. Thus, the locking structure 182 for joining the elastic piece 124 to the trim main body 102 can be configured as a simple configuration including the base portion 136 and the columnar body 187.

Concrete embodiments have been described in the foregoing, but the present invention can be modified in various ways without being limited to the above embodiments.

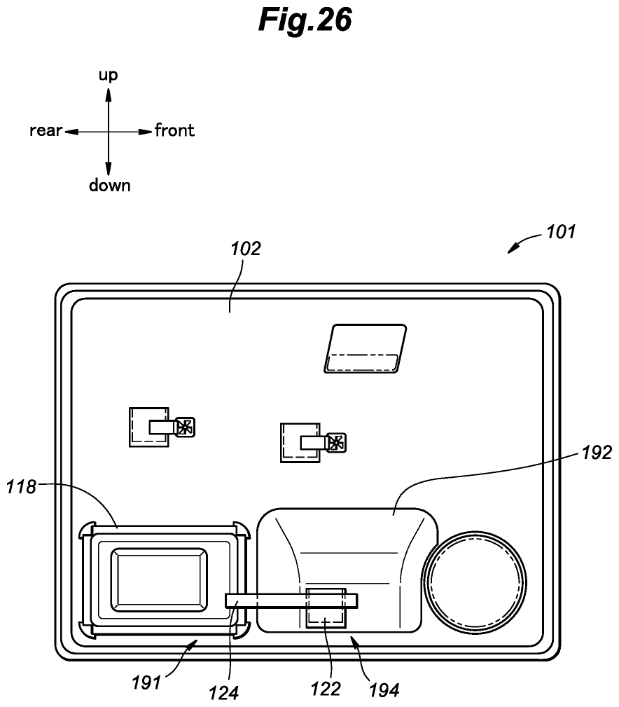

In the above embodiments, the locking structure 132, 162, 172, 179, 182 was composed of the base portion 136, 166, 176, 186 and the columnar body 134, 187 provided on the trim main body 102 (specifically, the back side 102A of the main surface part 104), but the present invention is not limited to this aspect. When the protector 118 is composed of a resin member separate from the trim main body 102 and is joined to the trim main body 102, the elastic piece 124 and/or the protruding part 122 may be formed integrally with the protector 118. FIG. 26 shows an example in which the elastic piece 124 is integrally formed on the protector 118. In this way, by integrally forming the elastic piece 124 and/or the protruding part 122 on the protector 118, the protector 118 functions as a locking structure 191 for locking the elastic piece 124 and/or the protruding part 122 to the trim main body 102. Thus, it is possible to provide the door trim 101 with the elastic piece 124 and the protruding part 122 without changing the number of components for configuring the trim main body 102.

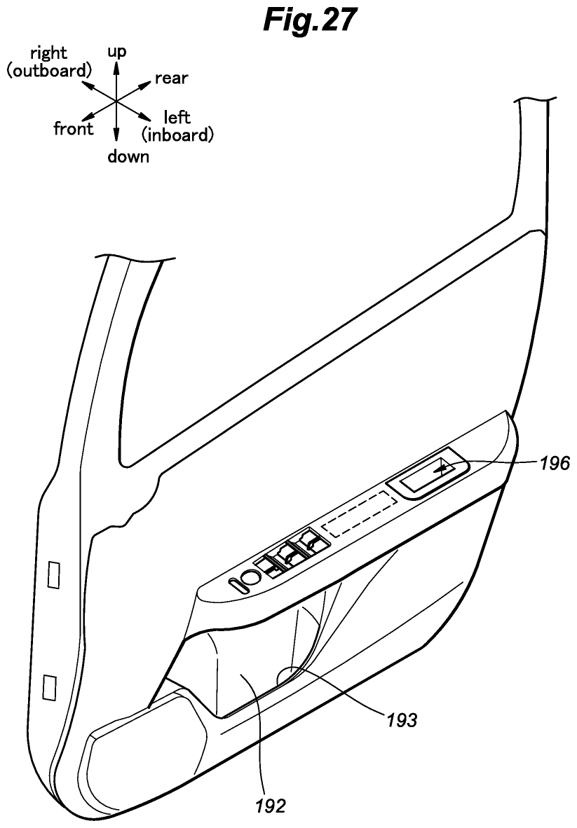

Also, there is a case where the trim main body 102 is provided with a through hole and a pocket forming member 192 is joined to the trim main body 102 to close the through hole from the back side so as to provide the door trim 101 with a door pocket 193, as shown in FIG. 27. In this case, the elastic piece 124 and/or the protruding part 122 may be integrally formed on the pocket forming member 192. FIG. 26 shows an example in which the protruding part 122 is integrally formed on the pocket forming member 192. In this way, by integrally forming the elastic piece 124 and/or the protruding part 122 on the pocket forming member 192, the pocket forming member 192 functions as a locking structure 194 for locking the elastic piece 124 and/or the protruding part 122 to the trim main body 102. Thus, it is possible to provide the door trim 101 with the elastic piece 124 and the protruding part 122 without changing the number of components for configuring the door trim 101.

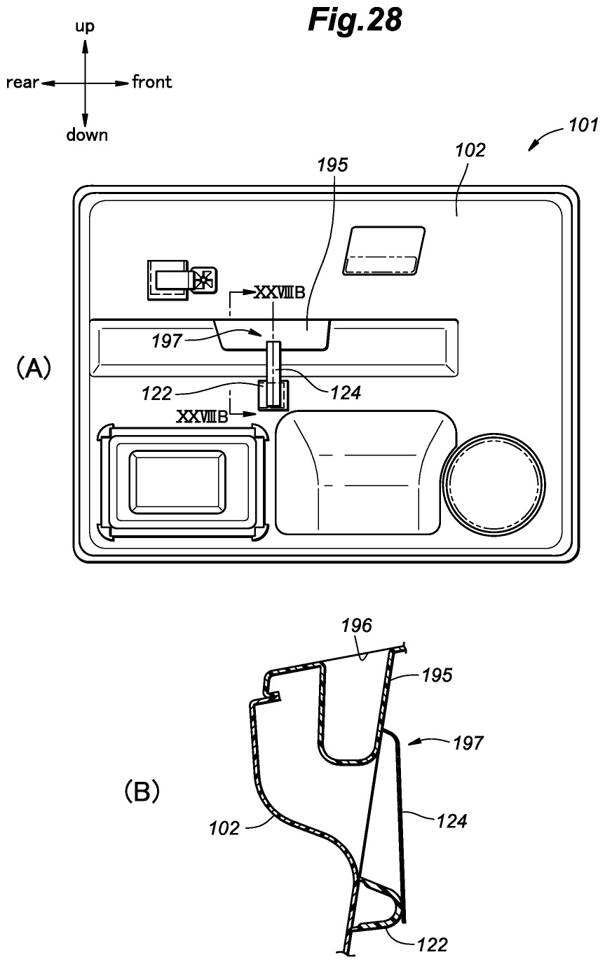

Besides, as shown in FIG. 28, there is a case where the trim main body 102 is provided with a through hole and a pull pocket forming member 195 made of resin is fitted into the through hole from the back side of the trim main body 102 so that a pull pocket 196 is formed in the door trim 101. In this case, the elastic piece 124 and/or the protruding part 122 may be integrally formed on the pull pocket forming member 195. Thereby, the pull pocket forming member 195 functions as a locking structure 197 for locking the elastic piece 124 and/or the protruding part 122 to the trim main body 102. Thus, it is possible to provide the door trim 101 with the elastic piece 124 and the protruding part 122 without changing the number of components for configuring the door trim 101.

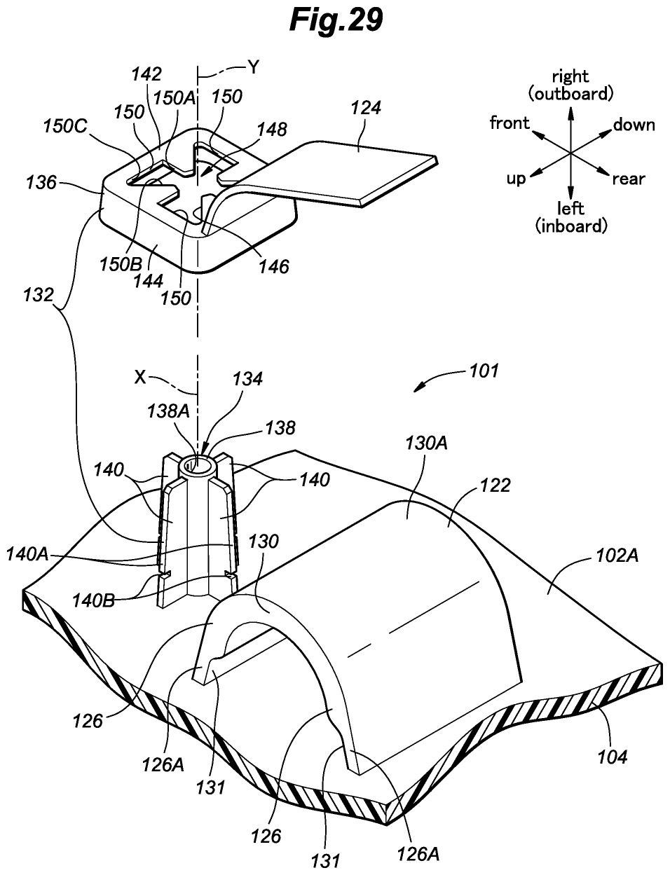

In the above embodiments, with the locking structure 132 according to the second embodiment, the base portion 136 is locked to the columnar body 134 due to contact of the protruding end surface 140A of each rib 140 with the wall surface defining the locking hole 146 but, as shown in FIG. 29, each of the ribs 140 may be provided with a cutout 140B that is recessed toward the axis X to be capable of receiving the upper wall 142. Thereby, it becomes difficult for the base portion 136 to be detached from the columnar body 134, and the base portion 136 can be locked to the columnar body 134 more reliably.

In the above embodiment, description was made of an example in which the door trim 101 is mounted to the door panel P of the door D on the right side of the front seat, but the door trim 101 may be mounted to the door panel P of the door D on the left side of the front seat or may be mounted to the door panel P of the door D on to the left or right side of the rear seat.

Also, in the above embodiments, description was made of an example in which the interior component according to the present invention constitutes the entirety of the door trim 101, but the present invention is not limited to this aspect. The interior component according to the present invention may constitute at least a part of the door trim 101. The door trim 101 is only an example of the interior component, and the interior component according to the present invention may constitute at least a part of a vehicle interior component other than the door trim 101 (for example, a dash panel, a console box, etc.).

Incidentally, in the vehicle to which the interior component as above is mounted, a fragrance device may be mounted to the seat for the purpose of improving the comfort of the occupant.

In the following, a fragrance device according to the present invention will be described with reference to the drawings. The fragrance device is a device for emitting fragrance, and is used in a state mounted to a predetermined target object. In the following, an example in which the target object is a seat installed in a vehicle is described, but the target object is not limited to the seat. In the following, for the sake of convenience, description will be made with the up-down, front-rear, and left-right directions being defined based on the front-rear direction of the seat.

### Eighth Embodiment

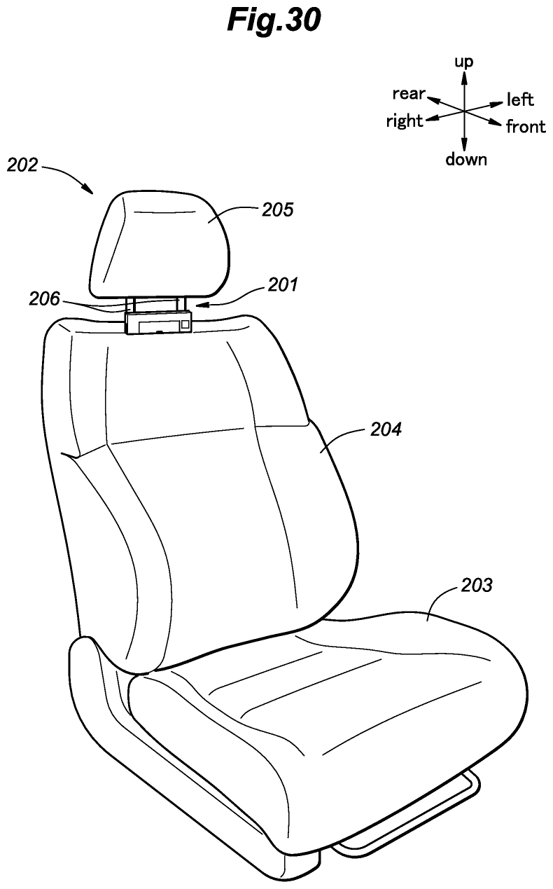

As shown in FIG. 30, a seat 202 to which a fragrance device 201 is mounted includes a seat cushion 203 provided on the floor, a seatback 204 joined to a rear portion of the seat cushion 203, and a headrest 205 provided on the upper side of the seatback 204. The headrest 205 is connected to the seatback 204 via a pair of headrest pillars 206 disposed to be laterally spaced from each other.

Each of the headrest pillars 206 is formed of a cylindrical metal pipe. Each of the headrest pillars 206 extends substantially upward from the upper end of the seatback 204 to reach the headrest 205. In the present embodiment, the fragrance device 201 is used in a state joined to the headrest pillar 206 from the front side in a position between the headrest 205 and the seatback 204.

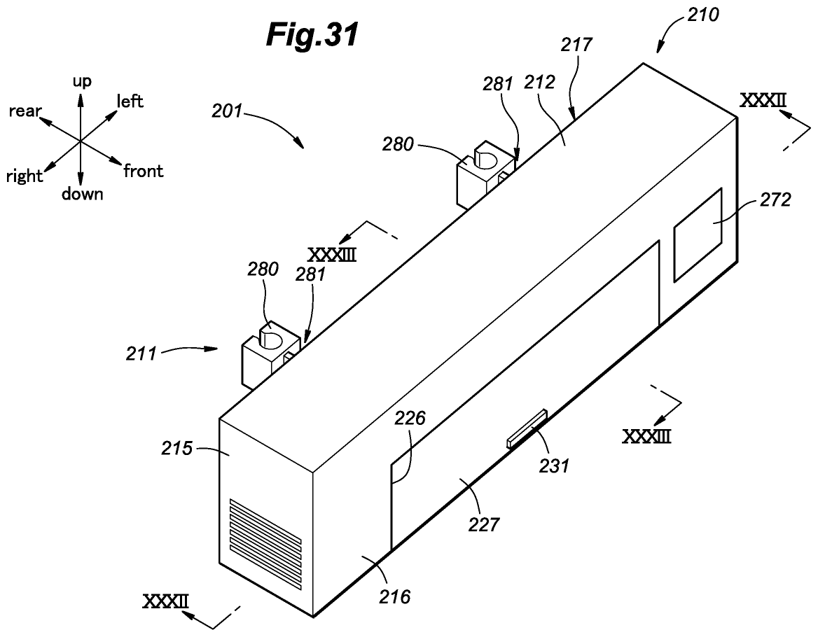

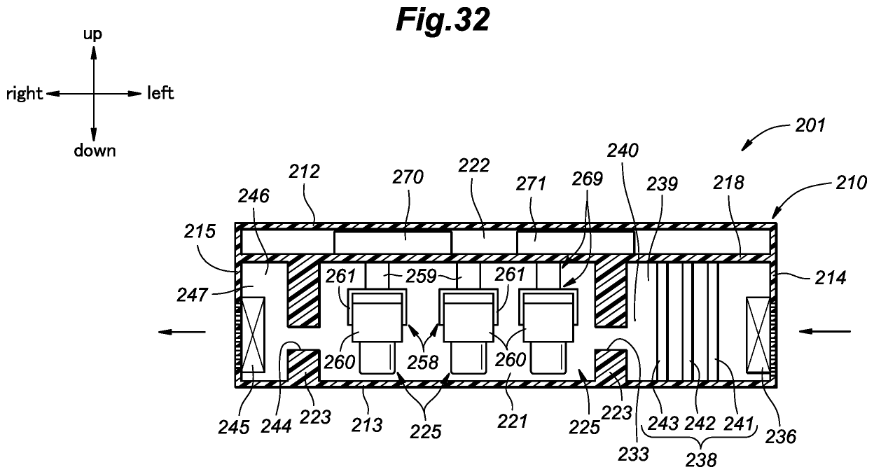

As shown in FIGS. 31 and 32, the fragrance device 201 includes a housing 210 and a mounting device 211 for mounting the housing 210 to the seat 202 (see FIG. 30). In the present embodiment, the mounting device 211 mounts the housing 210 to both the two headrest pillars 206 (see FIG. 30).

The housing 210 is provided with an upper wall 212 and a lower wall 213 that form a pair in the up-down direction, a left wall 214 and a right wall 215 that form a pair in the left-right direction, and a front wall 216 and a rear wall 217 that form a pair in the front-rear direction, and has a box-like shape extending laterally. The housing 210 is further provided with a partition wall 218 which extends in the left-right direction to connect the inner sides of the left wall 214 and the right wall 215 to each other. Thereby, in the housing 210, a first containment chamber 221 positioned in a lower portion of the housing 210 and a second containment chamber 222 provided above the first containment chamber 221 are defined.

The left wall 214 and the right wall 215 are provided, in lower portions thereof, with respective bulging parts 223 that bulge in directions facing each other. The bulging parts 223 contact the partition wall 218, the lower wall 213, and the rear wall 217 without a gap and are connected to each of them. As a result, the width of the first containment chamber 221 in the left-right direction is narrower than the width of the second containment chamber 222 in the left-right direction.

The first containment chamber 221 accommodates cartridges 225 containing aromatic substances emitting fragrance.

The front wall 216 of the housing 210 is formed with an opening 226. The opening 226 is a hole penetrating the front wall 216, and is provided to enable access to the inside of the first containment chamber 221 from the outside. This allows accommodation and removal of the cartridge 225 in and from the first containment chamber 221. The opening 226 is provided with an opening and closing lid 227 so as to be capable of opening and closing.

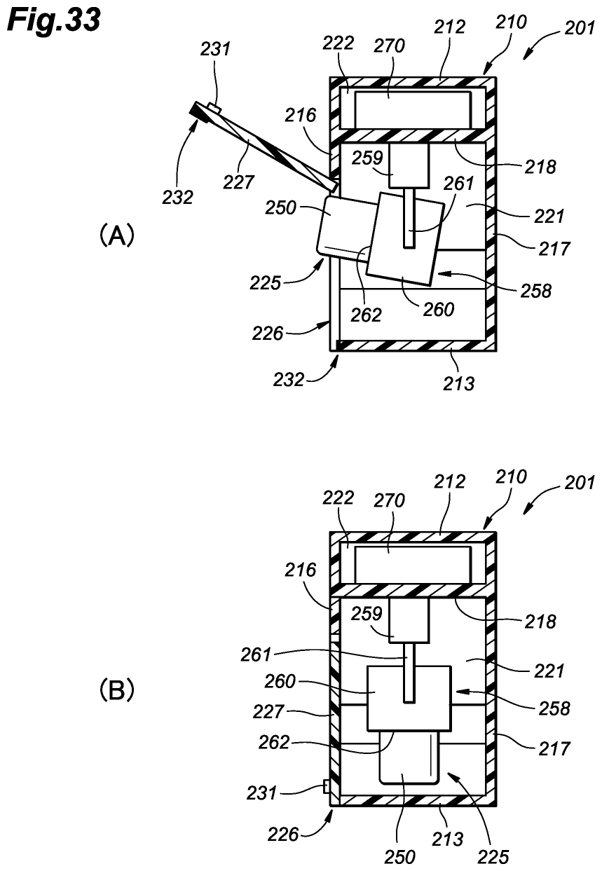

In FIG. 33, (A) shows a state in which the opening 226 is opened by the opening and closing lid 227, and (B) shows a state in which the opening 226 is sealed by the opening and closing lid 227. The opening and closing lid 227 is preferably provided on the front wall 216 of the housing 210 to be pivotable. The opening and closing lid 227 preferably opens and closes the opening 226 by pivoting about a pivot shaft extending laterally along the upper edge of the opening 226. The front surface (namely, the outer surface) of the opening and closing lid 227 is provided with an operation part 231.

The operation part 231 is operated by the user to open and close the opening 226. The operation part 231 is preferably provided on a lower central part of the opening and closing lid 227 in the left-right direction. The operation part 231 preferably includes a protrusion that protrudes forward, for example. The opening and closing lid 227 is locked in a state closing the opening 226 by a locking mechanism 232.

In the present embodiment, the locking mechanism 232 includes a pair of magnets provided on the housing 210 and the rear surface of the opening and closing lid 227. The magnets are disposed in positions corresponding to each other in the up-down and left-right directions. The magnets lock the opening and closing lid 227 in the state closing the opening 226 with magnetic force. In another embodiment, the locking mechanism 232 may include a spring and lock the opening and closing lid 227 in the state closing the opening 226 with an urging force.

As shown in FIG. 32, a lower portion of the left wall 214 is provided with a left through hole 233 extending in the left-right direction and penetrating the left wall 214 in the thickness direction. The left end of the left through hole 233 is opened on the outer side surface of the left wall 214 of the housing 210. The right end of the left through hole 233 is opened on the inner side surface of the left wall 214 of the housing 210 which is a side surface defining the first containment chamber 221. Thereby, the left through hole 233 forms a passage communicating the first containment chamber 221 with the outside of the housing 210.

The left through hole 233 is provided, in a central part in the left-right direction, with a first accommodation part 239 accommodating an introduction fan 236 and an air cleaning device 238.

The introduction fan 236 takes in air from the outside of the housing 210 to the inside of the left through hole 233 and discharges the air to the first containment chamber 221. Thereby, the introduction fan 236 functions to introduce air from the outside of the housing 210 to the first containment chamber 221. Thus, inside the left through hole 233, an introduction passage 240 is formed to connect the outside of the housing 210 to the inside of the first containment chamber 221.

The air cleaning device 238 is provided on the downstream side of the introduction fan 236. The air cleaning device 238 removes dust and odor-producing substances in the air discharged from the introduction fan 236. In the present embodiment, the air cleaning device 238 is composed of three layers of filters. The air cleaning device 238 includes a first filter 241, a second filter 242, and a third filter 243.

The first filter 241 functions as a pre-filter. The first filter 241 filters large dust particles or the like from the air introduced from the outside of the housing 210 by the introduction fan 236. The first filter 241 is disposed on the most upstream side of the three layers of filters.

The second filter 242 functions as a dust collection filter. The second filter 242 filters fine dust and pollen or the like from the air filtered by the first filter 241. The mesh size of the second filter 242 is smaller than the mesh size of the first filter 241.

The third filter 243 functions as a deodorizing filter. The third filter 243 adsorbs odor-producing substances from the air filtered by the second filter 242. Preferably, the third filter 243 is an activated carbon filter, for example. The third filter 243 is disposed on the most downstream of the three layers of filters.

The air cleaning device 238 does not need to have all of the three layers of filters, and one or more of them may be omitted. Also, the air cleaning device 238 may be disposed upstream of the introduction fan 236.

A lower portion of the right wall 215 is provided with a right through hole 244 extending in the left-right direction and penetrating the right wall 215 in the thickness direction. The right end of the right through hole 244 is opened on the outer side surface of the right wall 215 of the housing 210. The left end of the right through hole 244 is opened on the inner side surface of the right wall 215 of the housing 210 which is a side surface defining the first containment chamber 221. Thereby, the right through hole 244 forms a passage communicating the first containment chamber 221 with the outside of the housing 210.

The right through hole 244 is provided, in a central part in the left-right direction, with a second accommodation part 247 accommodating a discharge fan 245.

The discharge fan 245 takes in air from the first containment chamber 221 to the inside of the right through hole 244 and discharges the air to the outside of the housing 210. Thereby, the discharge fan 245 functions to discharge air from the first containment chamber 221 to the outside of the housing 210. Thus, inside the right through hole 244, a discharge passage 246 is formed to connect the inside of the first containment chamber 221 to the outside of the housing 210.

In this way, the fragrance device 201 is formed with a passage for the air that is introduced from the outside of the housing 210, passes the inside of the first containment chamber 221, and is discharged to the outside of the housing 210. When the cartridges 225 are accommodated in the first containment chamber 221 and aromatic substances are released from the cartridges 225, fragrance is emitted to the outside. Next, details of a cartridge 225 will be described.

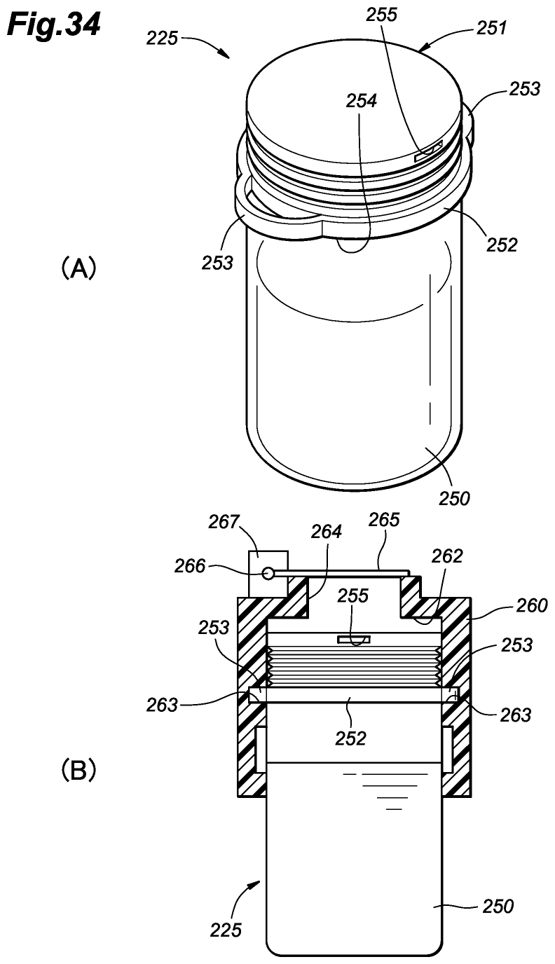

As shown in FIG. 34(A), the cartridge 225 includes a bottle 250 containing an aromatic substance and a cap 251 sealing the bottle 250. The aromatic substance contained in the bottle 250 may be in liquid form, such as an aromatic oil, or may be in gel form. The aromatic substances are selected for the respective cartridges 225 so as to emit different types of fragrance.

The bottle 250 has a bottomed cylindrical shape with an open top. The bottle 250 is preferably a light shielding bottle.

The cap 251 is made of a material having elasticity, such as silicon. The cap 251 includes a cap main body 252 and at least two convex parts 253 provided on the cap main body 252.

The cap main body 252 is provided with a recessed part 254 having a shape conforming to the opening of the bottle 250. In the present embodiment, the cap main body 252 has a bottomed cylindrical shape about a predetermined axis. The bottle 250 is sealed by being inserted into the recessed part 254 of the cap main body 252.

The convex parts 253 are formed on the outer circumferential surface of the cap main body 252. Each convex part 253 protrudes in from the outer circumferential surface of the cap main body 252 in a direction away from the axis. In the present embodiment, the cap main body 252 is provided with two convex parts 253 protruding in directions away from each other in the left-right direction. The convex parts 253 are preferably configured to have a predetermined width in the circumferential direction.

The cap main body 252 is provided with a fragrance hole 255 communicating the inside of the bottle 250 with the outside of the same and guiding the fragrance emitted from the aromatic substance to the outside. The fragrance hole 255 is opened on the front surface of the cap main body 252. The fragrance hole 255 is preferably formed in a position where the fragrance hole 255 is not sealed by the bottle 250 when the cap 251 is attached to the bottle 250.

As shown in FIG. 32, the first containment chamber 221 is provided with multiple holding parts 258 for detachably supporting the cartridges 225 containing aromatic substances.

Each of the multiple holding parts 258 is supported on the partition wall 218 via a load cell 259. The multiple holding parts 258 are disposed to be arranged in the left-right direction. The multiple holding parts 258 have the same structure, and thus, description will be made with reference to one of the multiple holding parts 258 in the following.

As shown in FIG. 32 and FIG. 34(B), the holding part 258 includes a holding part main body 260 detachably coupled to the cartridge 225, and legs 261 supporting the holding part main body 260. The holding part 258 is preferably made of resin.

The holding part main body 260 holds the cartridge 225. The holding part main body 260 is formed in a box shape. The holding part main body 260 has a receiving recess 262 for receiving an upper portion of the cartridge 225. The receiving recess 262 is formed with holding grooves 263 for holding the cartridge 225.

The holding grooves 263 are engaged with the convex parts 253. When the user inserts the cartridge 225 into the receiving recess 262, the convex parts 253 elastically deform to be engaged with the holding grooves 263, whereby the cartridge 225 is held. Configuration may be made such that when the cartridge 225 is fully inserted into the receiving recess 262, the fragrance hole 255 is sealed from the first containment chamber 221 by the holding part main body 260.

The holding part main body 260 is further provided with a communication hole 264. The communication hole 264 communicates the inside of the bottle 250 with the first containment chamber 221, and guides the fragrance emitted from the aromatic substance to the first containment chamber 221. The communication hole 264 is preferably opened on the upper surface of the holding part main body 260. The communication hole 264 is opened and closed by a shutter 265.

The shutter 265 opens and closes the communication hole 264 by pivoting about a pivot shaft 266 extending along an edge part of the communication hole 264. The shutter 265 is preferably driven by a motor 267.

The legs 261 are connected to left and right side portions of the holding part main body 260. The legs 261 pivotably hold the holding part main body 260. By pivoting the holding part main body 260, the user can displace the holding part main body 260 between a replacement position and a use position.

The replacement position indicates a position where the receiving recess 262 is viewable through the opening 226 and the cartridge 225 can be inserted/removed, as shown in FIG. 33(A). When taking out the cartridge 225, the user pivots the holding part main body 260 forward while supporting the lower portion of the cartridge 225 or the holding part main body 260. Thereby, it is possible to displace the holding part main body 260 to the replacement position.

The use position indicates a position where the opening 226 can be sealed by the opening and closing lid 227 while the cartridge 225 is accommodated in the receiving recess 262, as shown in FIG. 33(B). When using the fragrance device 201, the user inserts the cartridge 225 into the holding part main body 260 in the replacement position and pivots the holding part main body 260 rearward while supporting the lower portion of the cartridge 225 or the holding part main body 260. Thereby, it is possible to displace the holding part main body 260 to the use position.

Whether the holding part main body 260 is in the replacement position or the use position does not depend on whether the cartridge 225 is actually accommodated in the receiving recess 262 or not.

The holding part main body 260 may selectively take the replacement position or the use position. Also, the holding part main body 260 may be urged toward one of the replacement position or the use position. In the case where the holding part main body 260 is urged toward the replacement position, it is preferred if a lock mechanism for locking the holding part main body 260 in the use position when using the fragrance device 201 is provided. The legs 261 are supported by the partition wall 218 via the load cell 259.

As shown in FIG. 32, the load cell 259 has two load ends 269 and detects a tensile load applied between the load ends 269. The load cell 259 is preferably provided with a strain gauge. The load cell 259 is fixed to the partition wall 218 by one of the load ends 269. The load cell 259 is connected to the legs 261 at the other of the load ends 269. The load cell 259 transmits the detection result to an ECU 270 (control device) as a first signal.

The ECU 270 is composed of a computer provided with a processor, a memory, and a storage device such as a hard disk. The ECU 270 can execute various processes, with the processor reading necessary data and application software from the memory and/or the storage device and executing computational processing according to the software. The ECU 270 may be configured as a single piece of hardware or may be configured as a unit including multiple pieces of hardware.

The storage device pre-stores, as a reference value, a tensile load detected by the load cell 259 when the aromatic substance is not contained in the cartridge 225.

The ECU 270 is operated by electric power from a battery 271. In the present embodiment, the ECU 270 is accommodated in the second containment chamber 222 together with the battery 271.

The ECU 270 calculates the weight of the aromatic substance in the cartridge 225 based on the first signal received from the load cell 259 and the reference value stored in the storage device. Specifically, the ECU 270 acquires the weight of the aromatic substance by subtracting the reference value from the tensile load included in the first signal and multiplying the value obtained by the subtraction by a predetermined coefficient. For example, when the tensile load is detected in Newtons, it is preferred to divide the tensile load by the magnitude of the gravitational acceleration.

The ECU 270 preferably notifies the calculation result as a remaining amount of the aromatic substance. For example, the ECU 270 may display the calculation result on a display device 272 (see FIG. 31) mounted on the front wall 216 (see FIG. 31) of the housing 210. The ECU 270 may perform the notification by communicating with an external display. Also, the ECU 270 may notify the calculation result by sound by using a speaker not shown in the drawings. For example, it is preferred if the ECU 270 makes a notification sound when the weight of the aromatic substance in the cartridge 225 is less than or equal to a predetermined threshold value. The ECU 270 may make the notification by light by using a lamp not shown in the drawings. It is preferred if the ECU 270 turns on the lamp when the weight of the aromatic substance in the cartridge 225 is less than or equal to the predetermined threshold value.

Also, it is preferred that when the weight of the aromatic substance in the cartridge 225 is less than or equal to the predetermined threshold value, the ECU 270 prohibits an opening operation of the motor 267 (see FIG. 34) of the shutter 265 (see FIG. 34) corresponding to the cartridge 225, for example.

The battery 271 functions as a voltage source for supplying electric power to various devices installed in the fragrance device 201, including the introduction fan 236, the discharge fan 245, the motors 267 (see FIG. 34), the load cells 259, and the ECU 270.

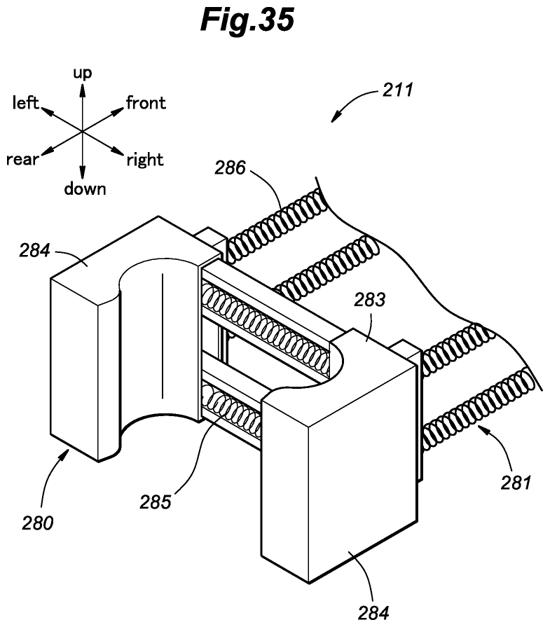

As shown in FIGS. 30, 31, and 35, the mounting device 211 includes two engagement parts 280 to be engaged with the two headrest pillars 206 and two connection parts 281 connecting the engagement parts 280 to the housing 210.

One of the engagement parts 280 is engaged with one of the two headrest pillars 206. The other of the engagement parts 280 is engaged with the other of the two headrest pillars 206. One of the engagement parts 280 pinches one of the headrest pillars 206 from left and right. The other of the engagement parts 280 pinches the other of the headrest pillars 206 from left and right.

Each engagement part 280 includes a bottom portion 283 configured to contact the front portion of the headrest pillar 206, and left and right locking parts 284 extending rearward the from both ends of the bottom portion 283. The engagement part 280 is preferably formed in a U shape in plan view. The left and right locking parts 284 are preferably urged by spring members 285 in directions toward each other.

One of the connection parts 281 connects one of the engagement parts 280 to the housing 210. The other of the connection parts 281 connects the other of the engagement parts 280 to the housing 210. Each connection part 281 preferably includes a first adjustment mechanism 286 for adjusting the distance between the housing 210 and the engagement part 280. The first adjustment mechanism 286 preferably includes springs, adjusters, or the like, for example.

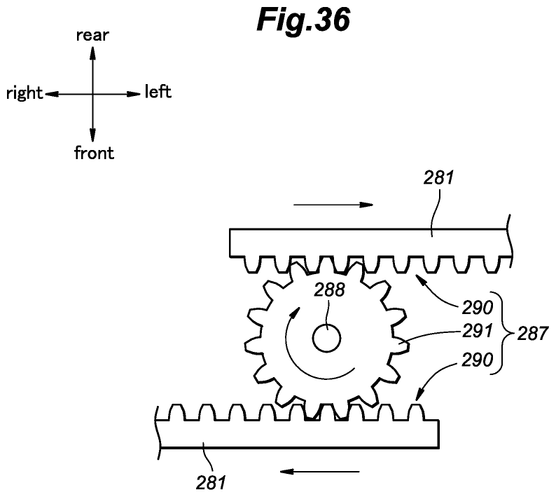

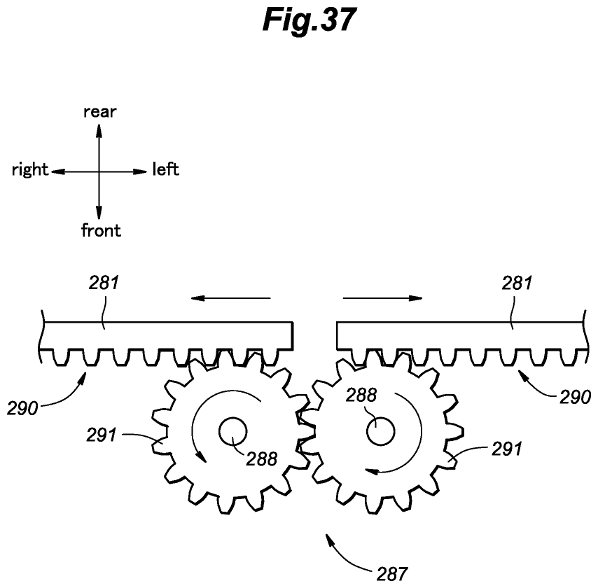

FIGS. 36 and 37 show connection parts 281 according to modifications. The connection parts 281 include a second adjustment mechanism 287 for adjusting the distance between one of the engagement parts 280 (see FIG. 31) connected to end portions thereof and the other of the engagement parts 280 (see FIG. 31).

The second adjustment mechanism 287 preferably includes a rotation shaft(s) 288 for receiving the user's input. When the user rotates the rotation shaft(s) 288, the second adjustment mechanism 287 converts the rotational motion to a motion for moving one of the engagement parts 280 (see FIG. 31) and the other of the engagement parts 280 (see FIG. 31) toward or away from each other, namely, a linear motion.

The mechanism for converting a rotational motion to a linear motion may be a known mechanism and a rack-and-pinion mechanism may be used, for example. FIGS. 36 and 37 show examples in which the second adjustment mechanism 287 is composed of a rack-and-pinion mechanism.

In FIG. 36, the second adjustment mechanism 287 is composed of racks 290 formed on two connection parts 281 extending in the left and right opposite directions, and a single pinion 291 disposed between the two connection parts 281. One of the connection parts 281 is disposed rearward of the pinion 291. The other of the connection parts 281 is disposed in front of the pinion 291. The pinion 291 is configured to mesh with both of the two racks 290.

When the user rotates the rotation shaft 288 of the pinion 291 clockwise, the one of the connection parts 281 is displaced leftward and the other of the connection parts 281 is displaced rightward. When the user rotate the rotation shaft 288 of the pinion 291 counterclockwise, the one of the connection parts 281 is displaced rightward and the other of the connection parts 281 is displaced leftward. In this way, by rotating the rotation shaft 288 of the pinion 291, the user can cause the one of the engagement parts 280 (see FIG. 31) and the other of the engagement parts 280 (see FIG. 31) to move toward or away from each other.

In FIG. 37, the second adjustment mechanism 287 is composed of racks 290 formed on two connection parts 281 extending in left and right opposite directions, and two pinions 291 respectively meshing with the two connection parts 281. The two connection parts 281 are disposed rearward of the pinions 291. The two pinions 291 are disposed adjacent to each other on the left and right and mesh with each other.

When the user rotates the rotation shaft 288 of one of the pinions 291 clockwise, one of the connection parts 281 is displaced leftward. At this time, the other of the pinions 291 rotates counterclockwise upon receipt of the rotation of the one of the pinions 291, whereby the other of the connection parts 281 is displaced rightward. Also, when the user rotates the rotation shaft 288 of the one of the pinions 291 counterclockwise, the one of the connection parts 281 is displaced rightward. At this time, the other of the pinions 291 rotates clockwise upon receipt of the rotation of the one of the pinions 291, whereby the other of the connection parts 281 is displaced leftward. In this way, by rotating the rotation shaft 288 of the pinion 291, the user can cause the one of the engagement parts 280 (see FIG. 31) and the other of the engagement parts 280 (see FIG. 31) to move toward or away from each other.

The second adjustment mechanism 287 may be multiple locking grooves provided in the rear wall 217 of the housing 210 shown in FIG. 31, for example, to be arranged in the left-right direction so as to be selectively engaged with the engagement parts 280. By selecting the locking grooves with which the two engagement parts 280 are engaged, the distance between one of the engagement parts 280 and the other of the engagement parts 280 may be adjusted.

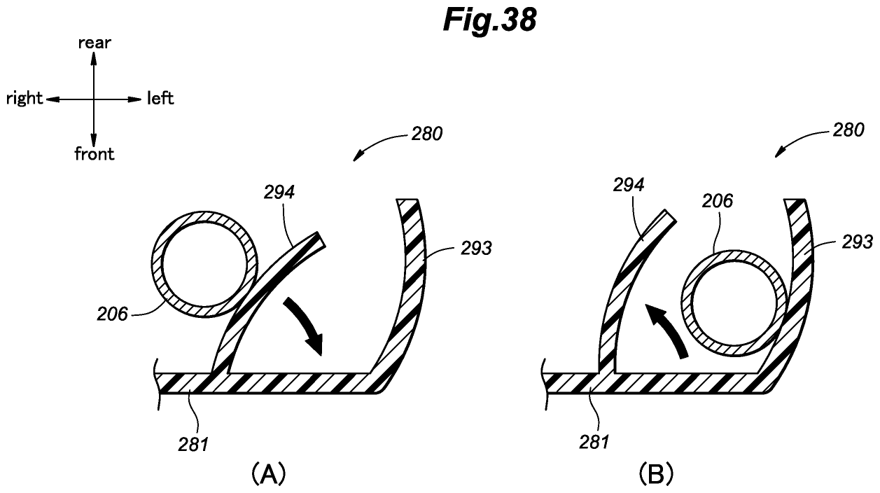

FIG. 38 shows one of the engagement parts 280 according to a modification. The engagement part 280 is preferably connected to an end portion of the connection part 281 shown in FIGS. 36 and 37, for example. The engagement part 280 includes a locking member 293 extending rearward from the free end of the connection part 281 which extends laterally and a support member 294 extending rearward from the connection part 281 at a position that is closer to the base end than the locking member 293 is.

The user causes one of the engagement parts 280 and the other of the engagement parts 280 to move toward each other from an initial position in which the one of the engagement parts 280 is position on the outer side of one of the headrest pillars 206 in the left-right direction and the other of the engagement parts 280 is positioned on the outer side of the other of the headrest pillars 206 in the left-right direction. The user causes the one of the engagement parts 280 and the other of the engagement parts 280 to further move toward each other from the state (A) in which the locking member 293 is in contact with the headrest pillar 206. Thereby, the headrest pillar 206 pushes the support member 294 toward the connection part 281 and gets over the support member 294, and thereafter is locked by the locking member 293(B).

Due to elastic deformation of the support member 294, the headrest pillar 206 is captured between the locking member 293 and the support member 294. In this way, the engagement part 280 is engaged with the headrest pillar 206.

Next, the effects of the fragrance device 201 according to the present embodiment will be described. The fragrance device 201 includes the housing 210 provided with the first containment chamber 221 for containing aromatic substances that emit fragrance, the introduction fan 236 and the discharge fan 245 for blowing air to guide the fragrance in a predetermined direction, and the mounting device 211 for mounting the housing 210 to the headrest pillars 206.

According to this configuration, the fragrance device 201 for emitting a fragrance can be mounted to the headrest pillars 206. Since the fragrance device 201 is detachable from the seat 202, when it becomes necessary to repair or replace the fragrance device 201, the work therefor is easy.

In the introduction passage 240, the introduction fan 236 for blowing air into the first containment chamber 221 from the outside is disposed. In the discharge passage 246, the discharge fan 245 for blowing air from the first containment chamber 221 to the outside is disposed. Thereby, a flow path for the air that is introduced from the outside of the housing 210, passes through the introduction passage 240, the first containment chamber 221, and the discharge passage 246, and is discharged to the outside is formed. Thus, the fragrance emitted from the aromatic substances accommodated in the first containment chamber 221 can be efficiently released.

Further, the air cleaning device 238 is disposed in the introduction passage 240. Thereby, it is possible to remove dust and odor-producing substances from the air introduced from the outside and to blow the air into the first containment chamber 221. Thus, it is possible to remove impurities or the like from the air released from the fragrance device 201.

In the first containment chamber 221, the holding parts 258 are supported via the load cells 259, and the cartridges 225 are detachably supported by the holding parts 258. Each load cell 259 transmits the first signal to the ECU 270, and the ECU 270 calculates the weight of the aromatic substance in each cartridge 225 based on the first signal and causes the calculation result to be displayed on the display device 272. Since the display device 272 is provided on the outer surface of the housing 210, the user can confirm the remaining amount of the aromatic substances without opening the opening and closing lid 227 and visually checking the cartridges 225.

The cap 251 of each cartridge 225 has the convex parts 253. The convex parts 253 are engaged with the holding grooves 263 formed in the receiving recess 262. Thereby, the cartridge 225 is reliably held by the holding part 258.

The holding part main body 260 is configured to be displaceable between a replacement position where the receiving recess 262 is viewable through the opening 226 and the cartridge 225 can be inserted/removed and a use position where the opening 226 can be sealed by the opening and closing lid 227, with the cartridge 225 being accommodated in the receiving recess 262. Thus, replacement of the cartridge 225 is easy.

Each holding part 258 has the communication hole 264 communicating the inside of the bottle 250 with the first containment chamber 221, and the shutter 265 for opening and closing the communication hole 264. The shutter 265 is driven by the motor 267. Therefore, the emission of the fragrance can be controlled by opening and closing the shutter 265. Thus, fragrance of a part of the multiple aromatic substances can be selectively emitted. Also, there is no need for the user to manually open and close the shutter 265.

The mounting device 211 includes the engagement part 280 to be engaged with the headrest pillar 206 and the first adjustment mechanism 286 for adjusting the distance between the engagement part 280 and the housing 210. Therefore, the fragrance device 201 can be mounted appropriately depending on the shape of the target object.

The mounting device 211 includes two engagement parts 280 to be engaged with the headrest pillars 206 and the second adjustment mechanism 287 for adjusting the distance between one of the engagement parts 280 and the other of the engagement parts 280. Therefore, the fragrance device 201 can be mounted appropriately depending on the shape of the target object.

The ECU 270 prohibits the opening operation of the shutter 265 by the motor 267 when the weight of the aromatic substance in the cartridge 225 is less than or equal to the predetermined threshold value. Therefore, when the aromatic substance is not contained in the cartridge 225, unnecessary opening operation of the shutter 265 can be prohibited.

The fragrance hole 255 is opened on the front surface of the cap main body 252. Therefore, even when the seatback 204 to which is the fragrance device 201 mounted is reclined rearward, it is possible to prevent the aromatic substance in liquid form from leaking from the bottle 250.

### Ninth Embodiment

Next, a fragrance device 301 according to the ninth embodiment will be described. The fragrance device 301 differs from the fragrance device 201 according to the eighth embodiment with respect to the configuration of a cartridge 325, a holding part main body 260, and a mounting device 311. In the following, the configurations same as those of the eighth embodiment will be denoted by the same reference signs and the description will be omitted.

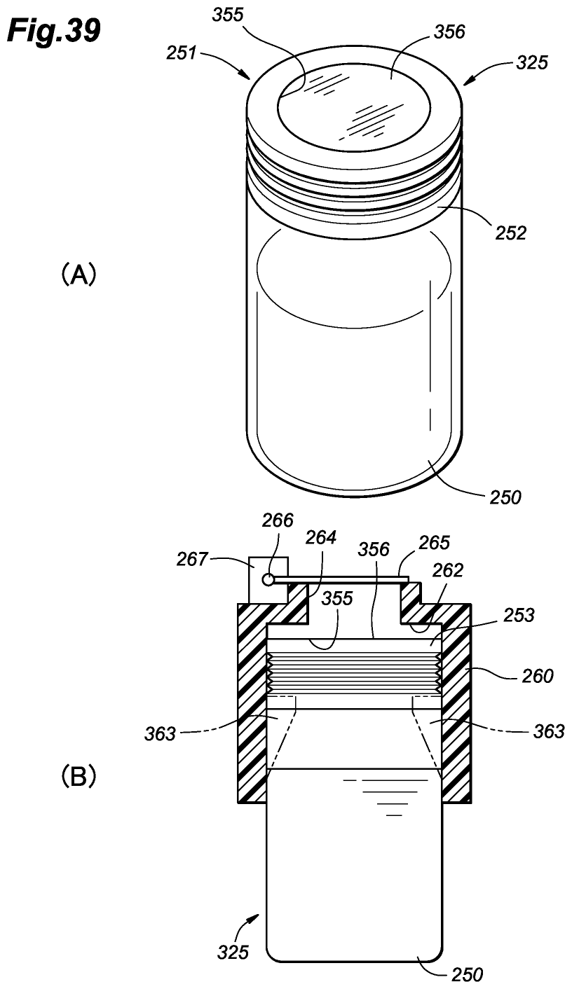

As shown in FIG. 39, the cartridge 325 includes a bottle 250 and a cap 251 for sealing the bottle 250. The cap 251 includes a cap main body 252 and a fragrance hole 355 provided in the cap main body 252.

The fragrance hole 355 communicates the inside of the bottle 250 with the outside of the same and guides the fragrance emitted from the aromatic substance to the outside. The fragrance hole 355 is opened on the upper surface of the cap main body 252. The fragrance hole 355 is covered by a filter 356.

The filter 356 prevents passage of liquid and allows passage of gas. The filter 356 prevents leakage of liquid from the bottle 250 to the outside through the fragrance hole 355 and allows emission of gas to the outside of the bottle 250 through the fragrance hole 355. Namely, the filter 356 retains the aromatic substance in liquid form inside the bottle 250 and allows the volatilized aromatic substance to be emitted to the outside of the bottle 250. The filter 356 may include a known waterproof breathable sheet, a known waterproof breathable valve, etc.

Thus, even though the cartridge 325 is tilted in any direction, it is possible to prevent the aromatic substance in liquid form from leaking from the bottle 250. Therefore, when inserting the cartridge 325 into the holding part main body 260, it is possible to prevent the aromatic substance in liquid form from leaking from the bottle 250. Also, when the seatback 204 (see FIG. 30) to which the fragrance device 301 is mounted is reclined rearward, it is possible to prevent the aromatic substance in liquid form from leaking from the bottle 250.

The holding part main body 260 holds the cartridge 325. The holding part main body 260 is formed in a box shape. The holding part main body 260 has a receiving recess 262 for receiving an upper portion of the cartridge 325. The side wall of the receiving recess 262 is provided with a pair of locking pieces 363.

The two locking pieces 363 cooperate with each other to lock the outer surface of the bottle 250. The two locking pieces 363 are provided at equal intervals in the circumferential direction of the receiving recess 262. Preferably, each of the locking pieces 363 has a triangular shape in front view. When the cartridge 325 is inserted into the receiving recess 262 from below, the pair of locking pieces 363 resiliently holds the bottle 250. Therefore, the bottle 250 can be resiliently held by the pair of the locking piece 363.

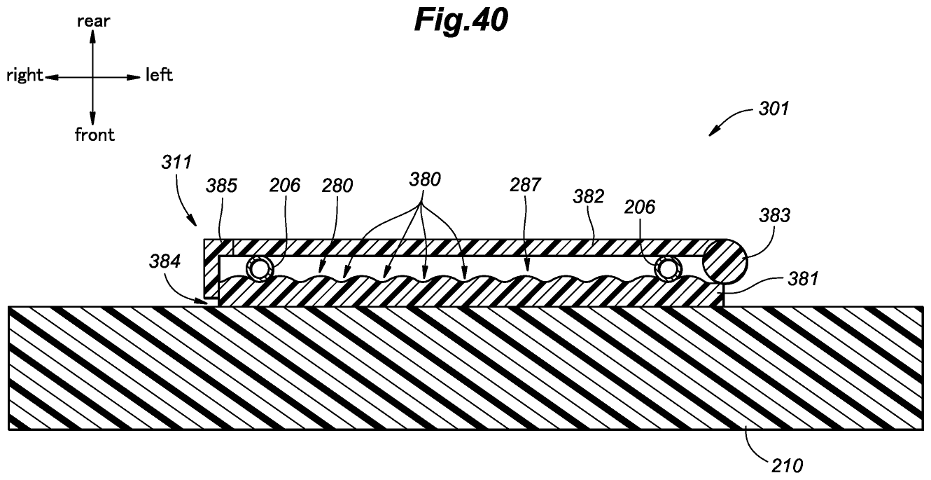

As shown in FIG. 40, the mounting device 311 includes a first member 381 connected to the housing 210 and a second member 382 pivotably connected to the first member 381.

The first member 381 is attached to the rear surface of the housing 210. The first member 381 is formed in a columnar shape extending laterally. The first member 381 is connected to the housing 210 at the front surface thereof. The rear surface of the first member 381 is formed with multiple engagement grooves 380. At one of the left and right end portions of the first member 381, a pivoting mechanism 383 is mounted. At the other of the left and right end portions of the first member 381, a first lock mechanism 384 is mounted.

The engagement grooves 380 are engaged with the headrest pillars 206. The engagement grooves 380 are provided along the lengthwise direction of the first member 381. The engagement grooves 380 are formed to be recessed toward front from the rear surface of the first member 381. The engagement grooves 380 function as the engagement parts 280 for selectively engaging with the headrest pillars 206 and also function as the second adjustment mechanism 287 for adjusting the distance between the two engagement parts.

The engagement groove 380 may have the mutually same width and depth or may have different widths and depths. Each engagement groove 380 may have a second engagement groove formed in a bottom portion thereof to be further recessed forward.

The pivoting mechanism 383 includes a pivot shaft extending in the up-down direction. The pivoting mechanism 383 connects the second member 382 to the first member 381 to be pivotable about the pivot shaft. The pivoting mechanism 383 may include a spring for urging the second member 382 in a direction away from the first member 381.

The second member 382 cooperates with the first member 381 to engage with the headrest pillars 206. The second member 382 is formed in a columnar shape extending laterally. Preferably, the second member 382 has substantially the same length as the first member 381. One of the left and right end portions of the second member 382 is connected to one of the left and right end portions of the first member 381 via the pivoting mechanism 383. At the other of the left and right end portions of the second member 382, a second lock mechanism 385 is mounted.

The first lock mechanism 384 and the second lock mechanism 385 cooperate with each other to lock the mounting device 311 to the headrest pillars 206. The first lock mechanism 384 and the second lock mechanism 385 are preferably a locking hole and a locking claw to be inserted in the locking hole, for example.

According to this configuration, the fragrance device 301 can be mount properly by selecting the engagement grooves 380 with which the two headrest pillars 206 are engaged according to the distance between the headrest pillars 206.

Concrete embodiments have been described in the foregoing, but the present invention can be modified in various ways without being limited to the above embodiments.

The mounting device 311 may be configured to be detachable from the housing 210. For example, the connection parts 281 of the mounting device 311 may have an engagement mechanism for engagement with the housing 210 and the housing 210 may have an engaged mechanism to be engaged with the engagement mechanism.

Specifically, the engagement mechanism may be a groove, and the engaged mechanism may be a rail to be slidably engaged with the groove.

The fragrance device 301 may be used in a state in which the mounting device 311 is detached from the housing 210. For example, the fragrance device 301 may be used while being accommodated in an accommodation part formed in the headrest 205.

Also, the fragrance device 301 may be used in a state in which the mounting device 311 is detached from the housing 210 and in which the fragrance device 301 is held by a known device such as a neck pillow, a neck strap, etc. For example, in the case where the device is a neck pillow formed of a flexible resin material, the housing 210 may be accommodated inside the neck pillow. The neck pillow may be provided with an air passage communicating with the openings formed in the right wall 215 and the left wall 214 of the housing 210 and an opening 226 that is connected to the air passage and is opened on the outer surface. Thereby, the fragrance can be efficiently released.

The ECU 270 may include a communication means for communicating with the outside. The ECU 270 may perform various controls based on the information acquired via the communication means. For example, the ECU 270 may connect to a server, select the shutter 265 to be opened/closed, and perform opening/closing control of the shutter 265. Thereby, the ECU 270 can select, from among multiple aromatic substances, the aromatic substance that should emit fragrance.

The ECU 270 may be connected to various sensors and select, from among multiple aromatic substances, the aromatic substance that should emit fragrance based on the information detected by the sensors.

For example, the ECU 270 may acquire seat information from a position sensor for detecting the front-rear position of the seat 202, the reclining state of the seat 202, etc. and select the aromatic substance that emits fragrance based on the seat information. For example, when the seat information indicates that the seat 202 is in the reclining state, the ECU 270 preferably selects an aromatic substance having fragrance with relaxing effect.

For example, the ECU 270 may acquire odor information from an odor sensor for detecting odor and select the aromatic substance that emits fragrance based on the odor information. For example, in the case where the odor sensor is provided on the seat 202 and the ECU 270 determines based on the odor information that the occupant is sweating, the ECU 270 preferably selects an aromatic substance having fragrance with deodorizing effect. For example, in the case where the odor sensor is configured to detect odor in the vehicle cabin and the ECU 270 determines based on the odor information that the vehicle cabin is filled with the smell of food, preferably the ECU 270 controls the shutters 265 to stop the emission of fragrance and drives the introduction fan 236 and the discharge fan 245 to only clean the air.

For example, the ECU 270 may acquire biological information from a biological sensor provided on the seat 202 and select the aromatic substance that emits fragrance based on the biological information. For example, the biological sensor preferably includes a heart rate sensor for detecting the heart rate of the seated person or a pulse sensor for detecting the pulse wave of the seated person. When it is determined based on the biological information that the occupant is feeling nauseous, preferably the ECU 270 controls the shutters 265 to stop the emission of fragrance and drives the introduction fan 236 and the discharge fan 245 to only clean the air. When it is determined based on the biological information that the occupant is in a state of fatigue, the ECU 270 preferably selects the aromatic substance having fragrance with relaxing effect. When it is determined based on the biological information that the occupant is feeling sleepy, the ECU 270 preferably selects an aromatic substance having fragrance with awakening effect.

For example, the ECU 270 may acquire luminance information from an luminance sensor provided in the vehicle cabin and select the aromatic substance that emits fragrance based on the luminance information. For example, when the luminance is greater than or equal to a predetermined threshold value, the ECU 270 preferably selects an aromatic substance having fragrance with awakening effect. When the luminance is less than the predetermined threshold value, the ECU 270 preferably selects an aromatic substance having fragrance with relaxing effect.

The ECU 270 may be connected to an electronic device provided in the vehicle, acquire launch information of an application installed in the electronic device, and select the aromatic substance that emits fragrance based on the launch information.

The ECU 270 may acquire music information related to the currently playing music from the audio device of the vehicle or the smartphone of the occupant and select the aromatic substance that emits fragrance based on the music information. For example, the ECU 270 acquires, based on the music information, a BPM value of the currently playing music. When the BPM value is greater than or equal to a predetermined threshold value, the ECU 270 preferably selects an aromatic substance having fragrance with awakening effect. When the BPM value is less than the predetermined threshold value, the ECU 270 preferably selects an aromatic substance having fragrance with relaxing effect.

Moreover, the ECU 270 may acquire artist information of the currently playing music based on the music information. The ECU 270 may recommend the aromatic substance that should emit fragrance to the user based on the artist information. The selection of aromatic substance may be performed by the ECU 270 or may be performed by the user.

The ECU 270 may acquire position information from the navigation device of the vehicle or the smartphone of the occupant and select the aromatic substance that emits fragrance based on the position information. For example, when the position information indicates that the position is near the sea, the ECU 270 preferably selects an aromatic substance having fragrance inspired by the sea or sea breeze.

The ECU 270 may acquire destination information from the navigation device of the vehicle or the smartphone of the occupant and select the aromatic substance that emits fragrance based on the destination information. For example, when the destination information indicates a gym, the ECU 270 predicts the behavior at the destination (for example, exercise) based on the biological information. The ECU 270 preferably selects the aromatic substance that emits fragrance for each of the way there and the way back based on the prediction result. For example, the ECU 270 preferably selects an aromatic substance having fragrance with relaxing effect on the way there. The ECU 270 preferably selects an aromatic substance having fragrance with deodorizing effect on the way back.

The ECU 270 may select the aromatic substance depending on the user type. For example, the ECU 270 preferably selects the aromatic substance based on the user information (for example, sex, age, residence, hobby, etc.) pre-stored in the memory. The correspondence between the user information and the aromatic substance may be decided based on a pre-stored table or may be decided by AI learning.

The fragrance device 201, 301 may include multiple heaters for individually heating the aromatic substances contained in the cartridges 225, 325. The heaters are preferably provided in the rear portion of the first containment chamber 221. By heating the aromatic substances by the heaters, the timing of volatilization of the aromatic substances may be adjusted.

The air cleaning device 238 may be a device adopting a known method such as an electric dust collection method and an ion generation method. In this case, preferably, the air cleaning device 238 cleans the air under the control of the ECU 270.

The ECU 270 may control the introduction fan 236, the discharge fan 245, the shutters 265, the heaters, etc. based on the fragrance emission pattern acquired from the outside. The ECU 270 may control the shutters 265 based on the input from the user via switches or the like. The ECU 270 may control the shutters 265 based on the input from the user so as to control the order of emittance of fragrance from the aromatic substances. The ECU 270 may control the introduction fan 236, the discharge fan 245, and/or the heaters based on the input from the user so as to control the strength of emitted fragrance. The ECU 270 may control various devices based on the information acquired from the outside and/or the input from the user so as to perform blending of the aromatic substances.

Incidentally, for the purpose of further improving the comfort of the occupant in the vehicle in which the seat having the fragrance device as above mounted thereto is installed, it may be conceived to install an in-vehicle device provided with a heat storage device.

In the following, with reference to the drawings, the in-vehicle device according to the present invention is installed in a vehicle such as an automobile. In the following, description will be made of exemplary cases where the in-vehicle device constitutes a part or the entirety of a seat of a vehicle such as an automobile or constitutes a door trim, etc.

### Tenth Embodiment

The in-vehicle device according to the tenth embodiment constitutes an armrest 403 of a vehicle seat (hereinafter referred to as a seat 401). In the following description, the up-down, front-rear, and left-right directions are defined based on the occupant seated on the seat 401, but the present invention is not limited by this description of directions.

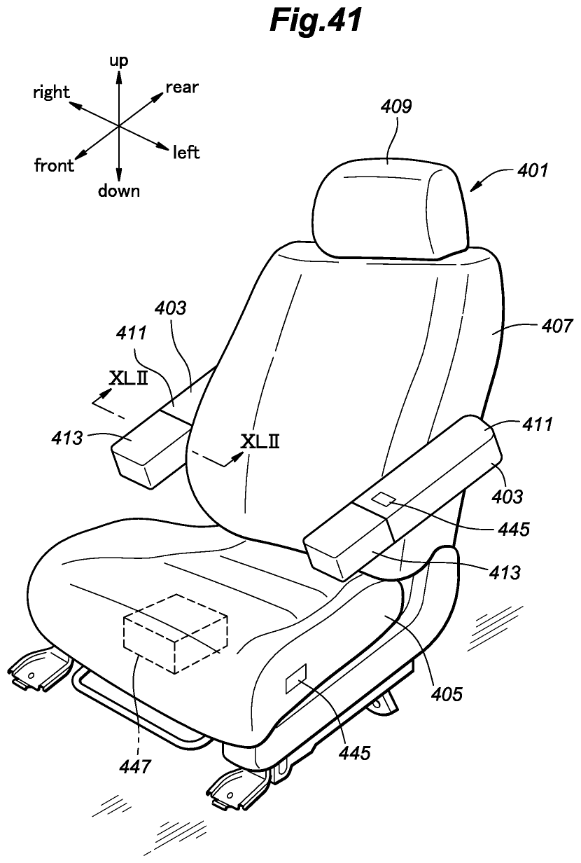

As shown in FIG. 41, the seat 401 is disposed in the vehicle cabin and constitutes a driver's seat or a front passenger seat, for example. The seat 401 includes a seat cushion 405 provided on the floor of the vehicle cabin, a seatback 407 joined to the rear portion of the seat cushion 405, and a headrest 409 provided on the upper side of the seatback 407. The seat cushion 405 supports the buttocks of the occupant seated on the seat 401. The seatback 407 is disposed behind the occupant seated on the seat 401 and functions as a backrest of the seat 401.

The seat 401 is further provided with a pair of armrests 403 pivotably joined to the left and right side surfaces of the seatback 407, respectively. The armrests 403 are disposed to the left and right of the occupant seated on the seat 401 and function as armrests of the seat 401.

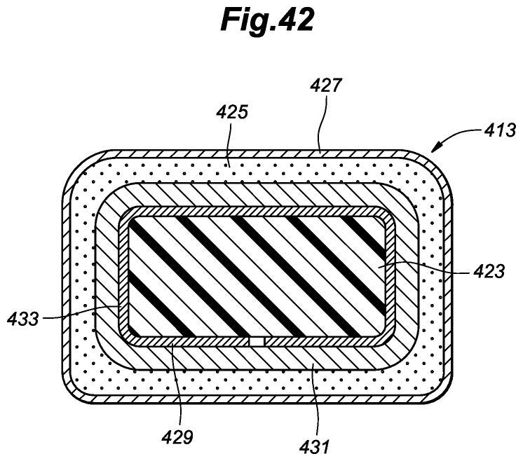

As shown in FIG. 42, each armrest 403 (one example of the in-vehicle device) includes an armrest main body 411 which is joined to the seatback 407 at the base end thereof and a heat storage device 413 detachably attached to the free end of the armrest main body 411.

The armrest main body 411 is pivotably connected to the seatback 407 at the base end thereof. A harness (not shown in the drawings) is introduced into the base end of the armrest 403 from the inside of the seatback 407. The harness is connected to a battery (not shown in the drawings) installed in the vehicle. The harness extends inside the armrest 403 from the base end side to the free end side. A power feed connector 415 joined to the harness is fixed to an end surface of the armrest main body 411 on the free end side.

The power feed connector 415 includes a housing 417 made of resin and fixed to the end surface of the armrest main body 411 on the free end side, power feed terminals 419 made of metal and fixed to the housing 417, and a magnet 421 fixed to the housing 417.

The power feed connector 415 is only required to be provided with at least one power feed terminal 419, but multiple power feed terminals 419 may be provided. Each power feed terminal 419 protrudes from the end surface of the armrest main body 411. In the present embodiment, the power feed connector 415 is provided with two power feed terminals 419, and the magnet 421 is provided between the two power feed terminals 419.

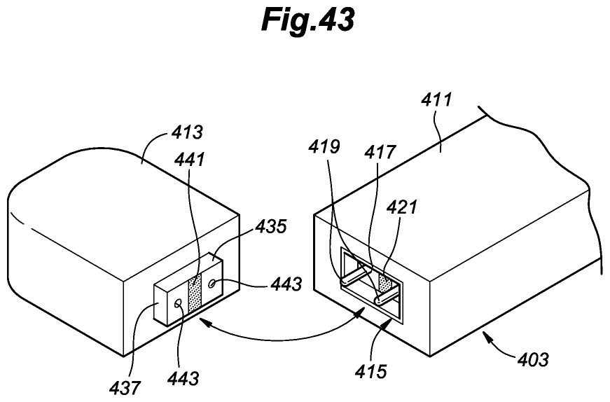

The heat storage device 413 is in a substantially rectangular parallelepiped shape having six side surfaces. As shown in FIG. 43, the heat storage device 413 includes a base material 423 forming a skeleton thereof, a pad member 425 provided on the base material 423, and a skin material 427 covering the outer surface of the pad member 425.

The base material 423 is a member having a substantially rectangular parallelepiped shape extending in a predetermined direction and is made of resin in the present embodiment.

The pad member 425 is provided to cover five side surfaces of the base material 423 excluding an end surface on one end side in the extension direction (hereinafter, the base end side). Preferably, the pad member 425 is made of a soft material having good breathability and being capable of conducting heat. In the present embodiment, the pad member 425 is made of a material having cushioning properties, such as urethane. The pad member 425 provided in the heat storage device 413 is preferably made of a material softer (having a smaller elastic modulus) than the pad member 425 provided in the armrest main body 411, the seatback 407, and the seat cushion 405.

The skin material 427 is composed of a member made of synthetic leather, leather, fabric, or the like. The skin material 427 covers the outer surface of the pad member 425 and constitutes five outer side surfaces of the heat storage device other than the side surface on the base end side.

In addition to the base material 423, the pad member 425, and the skin material 427, the heat storage device 413 is further provided with a heater 429 and a heat storage part 431.

The heater 429 includes a heater main body 433 having a cloth-like shape (sheet shape) and a power receiving connector 435. The heater main body 433 includes a sheet-shaped member with insulating properties, and an electric heating wire provided on the surface of the sheet-shaped member. The sheet-shaped member may be made of fabric or may be made of resin such as polyimide resin. The electric heating wire is made of metal having conductivity, such as copper, and is adhered to the sheet-shaped member. The power receiving connector 435 is provided on an end portion of the heater main body 433.

The power receiving connector 435 includes a housing 437 made of resin and fixed to the end surface of the base material 423 on the base end side, power receiving terminals (not shown in the drawings) made of metal and fixed to the housing 437, and a metal member 441 fixed to the housing 437.

In the present embodiment, the housing 437 of the power receiving connector 435 is provided with holes 443 for receiving the power feed terminals 419, and the power receiving terminals are provided in the holes 443. When the power receiving connector 435 is connected to the power feed connector 415, the power feed terminals 419 are inserted into the holes 443 and contact the power receiving terminals. Thereby, the power feed terminals 419 and the power receiving terminals are electrically connected. At this time, the heat storage device 413 is fixed to the armrest main body 411, and the heat storage device 413 cooperates with the armrest main body 411 to constitute the armrest 403 of the seat 401 provided in the vehicle cabin.

The seat 401 is provided with a switch 445 for turning on/off the voltage supplied from the battery to the harness in an appropriate position. When the switch 445 is turned on, electric power is supplied from the battery to the heater 429.

The metal member 441 is composed of a plate member made of metal (in the present embodiment, iron) which is attracted to the magnet 421 provided on the power feed connector 415. The metal member 441 is provided in a position to be near the magnet 421 when the power receiving connector 435 is connected to the power feed connector 415. Therefore, when the occupant connects the heat storage device 413 to the armrest main body 411, the metal member 441 is attracted by the magnetic force of the magnet 421, and the power receiving connector 435 is attached to the power feed connector 415. Thus, the power feed connector 415 and the power receiving connector 435 can be connected easily, and mounting of the heat storage device 413 to the armrest main body 411 is easy.

In the present embodiment, the power receiving connector 435 is provided with the metal member 441, but the present invention is not limited to this aspect. Instead of the metal member 441, the power receiving connector 435 may be provided with a magnet 421 that can be attracted to the magnet 421 provided on the power feed connector 415. Also, the power feed connector 415 may be provided with the metal member 441, while the power receiving connector 435 may be provided with the magnet 421. Besides, instead of the metal member 441, any member that can be attracted to the magnet 421 may be used.

The heat storage part 431 includes a heat storage material and can store heat of the heater 429 and the like. In the present embodiment, the heat storage part 431 includes a material that can store thermal energy as latent heat which is absorbed/released when the material undergoes a state change from solid to liquid or from liquid to solid or when the material undergoes solid-solid phase change (phase transition), that is, a latent heat storage material. Preferably, the phase change temperature (phase change point) of the latent heat storage material is set to 15 to 25° C. at which humans feel comfortable.

The heat storage part 431 may include a latent heat storage material in the form of liquid, gel, or the like. In such a case, the latent heat storage material is preferably sealed in a bag. The heat storage part 431 may be composed of a blend of latent heat storage capsules containing therein a latent heat storage material and granular latent heat storage material. Besides, the heat storage part 431 may be composed of resin or fibers in which the latent heat storage capsules and/or granular latent heat storage material is kneaded.

The latent heat storage material is preferably composed of a material that can store heat by phase change between two solid phases. Thereby, unlike the case where the latent heat storage material is composed of a material that can store heat by phase change between solid and liquid, it is not necessary to seal the latent heat storage material. Accordingly, the configuration of the heat storage device 413 is simplified.

As such a latent heat storage material that is not liquefied, materials that can store heat by using phase change between two solid phases having different crystal structures (for example, transition between monoclinic crystal and tetragonal crystal), such as vanadium dioxide, may be used, for example. In the case where vanadium dioxide ceramic is used as the latent heat storage material, the thermal conductivity of the heat storage part 431 improves, and the heat storage part 431 can promptly store heat. In addition, in the case where vanadium dioxide ceramic is used as the latent heat storage material, there is an advantage that the durability and machinability improve.

Also, the latent heat storage material may be a material that can store heat by other transition between crystal and non-crystal or transition between crystals.

In the present embodiment, the heat storage part 431 includes a latent heat storage material that stores heat related to phase change between two solid phases as latent heat, and is made of resin (urethane or the like) in which the latent heat storage material is kneaded.

As shown in FIG. 42, the heat storage part 431 is disposed between the heater 429 and the pad member 425 to extend along the outer surface of the heater 429. The heat storage part 431 is disposed, together with the heater 429, to cover the surface of the base material 423 other than the side surface on the base end side and the side surface on the free end side.

Next, a manufacturing method of the heat storage device 413 will be described. The worker who manufactures the heat storage device 413 prepares the base material 423, and thereafter fixes the heater 429 on the outer surface thereof. Thereafter, the worker disposes the heat storage part 431 which includes the latent heat storage material along the outer surface of the heater 429. Further, the worker covers the outer surface of the heat storage part 431 with the pad member 425, and thereafter covers the outer surface of the pad member 425 with the skin material 427, whereby the heat storage device 413 is completed.

Next, the effects of the in-vehicle device (armrest 403) configured as above will be described.

When the occupant is seated and turns on the switch 445, electric power is supplied to the heater 429. Thereby, the heater 429 generates heat, and the armrest 403 is warmed.

The heat storage device 413 is configured to be detachably attached to the armrest main body 411. Therefore, after turning off the switch 445, the occupant can detach the heat storage device 413 from the armrest main body 411, and carry the heat storage device 413 to a location where the thermal energy is needed. Thus, for example, the occupant may use the heat storage device 413 instead of a pocket heater to warm the occupant's fingertips or the like. In this way, by configuring the heat storage device 413 to be detachable, it is possible to use the thermal energy stored in the heat storage device 413 effectively at various locations. Since the armrest 403 provided on the seat 401 is configured to be capable of storing heat, it can be called a heat storing armrest (thermal armrest).

The heat storage device 413 is provided at the front end of the armrest 403. Therefore, the occupant seated on the seat 401 can easily attach and detach the heat storage device 413. Also, the heat storage device 413 can be mounted to the armrest main body 411 with the metal member 441 (or the magnet 421) attracted to the magnet 421. Thus, attachment and detachment of the heat storage device 413 is easy, and the heat storage device 413 can be configured to be detachably attached to the armrest main body 411 with a simple configuration.

The heat storage device 413 includes a latent heat storage material. Thus, compared to a conventional heat storage material that does not use phase change, the heat storage device 413 can be given a higher heat storage capacity.

As shown in FIG. 42, the heat storage part 431 is provided to be in contact with the heater 429. Therefore, the heat storage part 431 can efficiently store the heat of the heater 429. Further, in the present embodiment, since the heat storage device 413 is provided in the front portion of the armrest 403, the occupant seated on the seat 401 can easily attach and detach the heat storage device 413.

In the above embodiment, configuration was made such the heater 429 generates heat upon turning on of the switch 445 by the occupant seated on the seat 401, but the present invention is not limited to this aspect. The heat generation of the heater 429 may be controlled by a control device 447. The control device 447 is composed of a computer provided with a processor, a memory, and a storage device. The control device 447 may be provided on the lower side of the seat 401 (see FIG. 41), or may be provided in any position of the vehicle body. The control device 447 performs various controls including heat generation control of the heater 429, with the processor executing programs stored in the memory and/or the storage device. Preferably, the control device 447 performs heat generation control of the heater 429 by controlling the electric power supply from the battery or the like.

In the case where the vehicle is an electric vehicle that travels with the electric power from the battery, configuration may be made such that part of the electric power supplied to the battery when charging is supplied to the heater 429 so that the heater 429 generates heat. Thereby, thermal energy can be stored in the heat storage device 413 by using part of the electric power supplied to the battery when charging.

Besides, the control device 447 may be configured to energize the heater 429 depending on driving of the vehicle. For example, when the vehicle can be started by a terminal such as a smart key, the control device 447 may cause the heater 429 to generate heat when generation the vehicle is started by the terminal. Thereby, it is possible to store thermal energy in the heat storage device 413 when the vehicle is started.

### Eleventh Embodiment

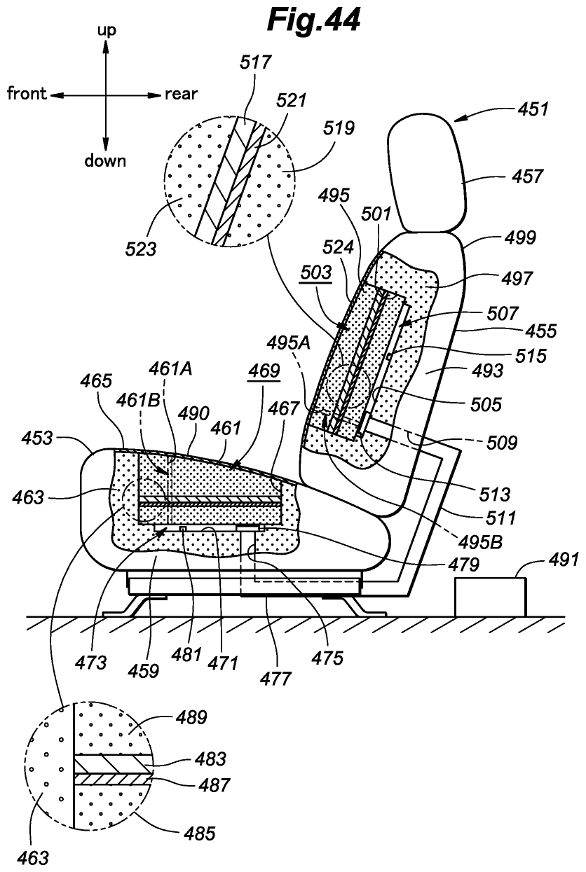

The in-vehicle device according to the eleventh embodiment constitutes a seat 451. As shown in FIG. 44, similarly to the tenth embodiment, the seat 451 is provided with a seat cushion 453, a seatback 455, and a headrest 457.

The seat cushion 453 includes a cushion main body 459 and a cushion-side heat storage device 461 detachably supported by the cushion main body 459.

The cushion main body 459 includes a cushion frame (not shown in the drawings) forming a skeleton, a pad member 463 (cushion pad member) supported by the cushion frame, and a skin material 465 covering the upper surface of the pad member 463.

The cushion frame has a rectangular frame shape in top view. The cushion frame includes a pair of left and right side frames extending in the front-rear direction, a front frame extending laterally and connecting the front portions of the left and right side frames, and a rear frame extending laterally and connecting the rear portions of the left and right side frames. Between the front frame and the rear frame, a plate-shaped pan frame extends in the front-rear direction. Note, however, that the present invention is not limited to this aspect, and instead of the pan frame, multiple spring members for supporting the pad member 463 may be stretched between the front frame and the rear frame.

The pad member 463 is placed on the upper surface of the cushion frame. The pad member 463 has a rectangular parallelepiped shape forming a rectangle in top view. The upper surface of the pad member 463 is provided with a receiving recess 467 that is recessed downward to receive the cushion-side heat storage device 461. The receiving recess 467 defines a receiving space 469 in which the cushion-side heat storage device 461 is received.

In the present embodiment, the cushion-side heat storage device 461 has a substantially rectangular parallelepiped shape. The receiving recess 467 also has a shape matching the cushion-side heat storage device 461 and defines the receiving space 469 having a substantially rectangular parallelepiped shape. The cushion-side heat storage device 461 is fitted in the receiving recess 467 and is accommodated in the receiving recess 467.

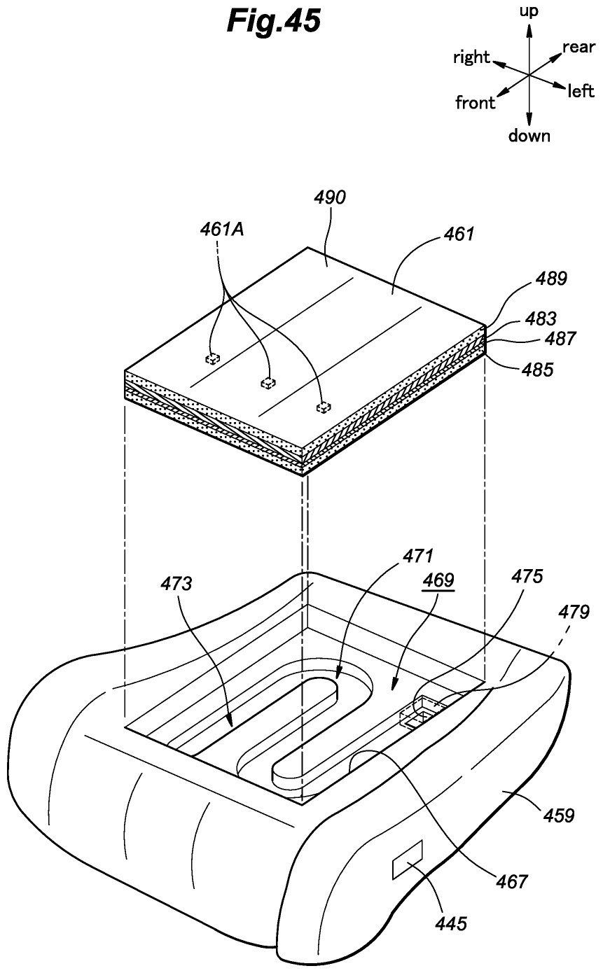

The lower surface (bottom surface) of the receiving recess 467 is provided with a stripe-shaped groove part 471 that is recessed downward. In the present embodiment, as shown in FIG. 45, the groove part 471 has a meandering shape in top view. The wall surface defining the groove part 471 and the lower surface of the cushion-side heat storage device 461 define a passage 473 in the seat cushion 453.

The pad member 463 is provided with a vent hole 475 extending downward from the bottom surface of the groove part 471 to the lower surface of the pad member 463. The vent hole 475 is a through hole penetrating the pad member 463 in the thickness direction and penetrates the pad member 463 in the up-down direction. A tubular cushion-side duct 477 is provided on the lower surface of the pad member 463 in a position aligned with the vent hole 475.

Inside the groove part 471, a cushion-side exhaust device 479 is provided. The cushion-side exhaust device 479 can discharge the air inside the passage 473 to the vent hole 475 (namely, exhaust the air from the passage 473). In the present embodiment, the cushion-side exhaust device 479 can supply the air inside the vent hole 475 to the inside of the passage 473 (namely, supply the air to the passage 473). The cushion-side exhaust device 479 may be provided in the vent hole 475 or in the cushion-side duct 477, or may be provided in the groove part 471. In the present embodiment, the cushion-side exhaust device 479 is disposed in the groove part 471 in a position aligned with an upper opening of the vent hole 475.

Inside the groove part 471, a cushion-side temperature sensor 481 for detecting the temperature of the air in the passage 473 is further provided. The cushion-side temperature sensor 481 is preferably composed of a known RTD (resistance temperature detector) temperature sensor whose electrical resistance value changes with a temperature change.

The cushion-side heat storage device 461 is provided with a cushion-side heat storage part 483 that can store heat, as in the tenth embodiment. The cushion-side heat storage part 483 also includes a latent heat storage material similar to that of the tenth embodiment.

In the present embodiment, in addition to the cushion-side heat storage part 483, the cushion-side heat storage device 461 includes a reverse-side pad member 485 constituting a lower portion thereof, a heater 487 provided on the obverse side (upper side) of the reverse-side pad member 485, and an obverse-side pad member 489 provided on the obverse side (upper side) of the heater 487. The cushion-side heat storage part 483 is disposed between the upper surface of the heater 487 and the lower surface of the obverse-side pad member 489. Each of the obverse-side pad member 489 and the reverse-side pad member 485 is preferably made of a material having cushioning properties, such as urethane, for example. Preferably, a skin material 490 is provided on the upper surface of the obverse-side pad member 489. Besides, the cushion-side heat storage device 461 is preferably provided with a through hole 461A penetrating the reverse-side pad member 485, the heater 487, the cushion-side heat storage part 483, and the obverse-side pad member 489 and connected to the groove part 471. The through hole 461A, the groove part 471, and the vent hole 475 form an air passage 461B extending from the upper surface to the lower surface of the seat cushion 453.

The heater 487 is connected to a harness (not shown in the drawings) provided inside the pad member 463 of the seat cushion 453. The heater 487 is supplied with electric power via the harness. When electric power is supplied to the heater 487, the heater 487 generates heat and the heat is stored in the cushion-side heat storage part 483 provided on the upper side of the heater 487. In the present embodiment, the electric power supplied to the heater 487 is controlled by a control device 491 composed of a computer similar to that of the tenth embodiment.

The control device 491 is connected to the cushion-side temperature sensor 481 in addition to the heater 487 and is configured to be capable of acquiring the temperature in the passage 473 detected by the cushion-side temperature sensor 481. Further, the control device 491 is connected to the cushion-side exhaust device 479 and is configured to be capable of controlling the cushion-side exhaust device 479. The control device 491 can drive the cushion-side exhaust device 479 to exhaust air from between the occupant seated on the seat 451 and the seat cushion 453 via the air passage 461B, or to blow air toward the occupant.

The seatback 455 includes a back main body 493 and a back-side heat storage device 495 detachably supported by the back main body 493.

The back main body 493 includes a back frame (not shown in the drawings) forming a skeleton, a pad member 497 (back pad member) supported by the back frame, and a skin material 499 covering the front surface of the pad member 497.

The back frame has a rectangular frame shape in front view. The back frame includes a pair of left and right side frames extending in the up-down direction, an upper frame extending laterally and connecting the upper portions of the left and right side frames, and a lower frame extending laterally and connecting the lower portions of the left and right side frames. Between the left and right side frames, a pressure receiving member (lumber support) elastically supported by the back frame to receive the load from the occupant may be provided.

The pad member 497 is placed on the front surface of the back frame. The pad member 497 has a rectangular parallelepiped shape forming a rectangle in front view. The front surface of the pad member 497 is provided with a receiving recess 501 that is recessed rearward to receive the back-side heat storage device 495. The receiving recess 501 defines a receiving space 503 in which the back-side heat storage device 495 is received.

In the present embodiment, the back-side heat storage device 495 also has a substantially rectangular parallelepiped shape. The receiving recess 501 also has a shape matching the back-side heat storage device 495 and defines the receiving space 503 having a substantially rectangular parallelepiped shape. The back-side heat storage device 495 is fitted in the receiving recess 501 and is accommodated in the receiving recess 501.

The front surface (bottom surface) of the receiving recess 501 is provided with a groove part 505 that is recessed rearward. The groove part 505 has a meandering shape in front view, for example. The wall surface defining the groove part 505 and the rear surface of the back-side heat storage device 495 define a passage 507 in the seatback 455.

The pad member 497 is provided with a vent hole 509 extending rearward from the bottom surface of the groove part 505 to the rear surface of the pad member 497. The vent hole 509 is a through hole penetrating the pad member 497 in the thickness direction and penetrates the pad member 497 in the front-rear direction. A tubular back-side duct 511 is provided on the rear surface of the pad member 497 in a position aligned with the vent hole 509.

The cushion-side duct 477 is joined to the cushion main body 459 at one end and is connected to the receiving recess 501 provided in the cushion main body 459 via a through hole. The back-side duct 511 is connected to the back main body 493 at one end and is connected to the receiving recess 501 provided in the back main body 493 via the vent hole 509. The cushion-side duct 477 and the back-side duct 511 are connected to each other at the other ends.

Inside the groove part 505, a back-side exhaust device 513 is provided. The back-side exhaust device 513 can discharge the air inside the passage 507 to the vent hole 509 (namely, exhaust the air from the passage 507). In the present embodiment, the back-side exhaust device 513 can also supply the air inside the vent hole 509 to the inside of the passage 507 (namely, supply the air to the passage 507). The back-side exhaust device 513 also may be provided in the vent hole 509 or in the back-side duct 511, or may be provided in the groove part 505. In the present embodiment, the back-side exhaust device 513 is disposed in the groove part 505 in a position aligned with a front opening of the vent hole 509.

Inside the groove part 505, a back-side temperature sensor 515 for detecting the temperature of the air in the passage 507 is further provided. The back-side temperature sensor 515 is preferably composed of a known RTD (resistance temperature detector) temperature sensor provided with a resistance temperature detector element whose electrical resistance value changes with a temperature change (for example, a resistance temperature detector element composed of nickel, copper, platinum, etc.).

The back-side heat storage device 495 is provided with a back-side heat storage part 517 that can store heat, as in the tenth embodiment. The back-side heat storage part 517 also includes a latent heat storage material similar to that of the tenth embodiment.

In the present embodiment, in addition to the back-side heat storage part 517, the back-side heat storage device 495 includes a reverse-side pad member 519 constituting a rear portion thereof, a heater 521 provided on the obverse side (front side) of the reverse-side pad member 519, and an obverse-side pad member 523 provided on the obverse side (front side) of the heater 521. The back-side heat storage part 517 is disposed between the front surface of the heater 521 and the rear surface of the obverse-side pad member 523. Each of the obverse-side pad member 523 and the reverse-side pad member 519 is preferably made of a material having cushioning properties, such as urethane, for example. Preferably, a skin material 524 is provided on the front surface of the obverse-side pad member 523. Besides, the back-side heat storage device 495 is preferably provided with a through hole 495A penetrating the reverse-side pad member 519, the heater 521, the back-side heat storage part 517, and the obverse-side pad member 523 and connected to the groove part 505. The through hole 495A, the groove part 505, and the vent hole 509 form an air passage 495B extending from the front surface to the rear surface of the seatback 455.

The heater 521 is connected to a harness (not shown in the drawings) provided inside the pad member 497 of the seatback 455. The heater 521 is supplied with electric power via the harness. When electric power is supplied to the heater 521, the heater 521 generates heat and the heat is stored in the back-side heat storage part 517 provided on the obverse side of the heater 521. In the present embodiment, the electric power supplied to the heater 521 of the back-side heat storage device 495 is also controlled by the control device 491 similarly to the heater 521 of the cushion-side heat storage device 461.

The control device 491 is connected to the back-side temperature sensor 515 and is configured to be capable of acquiring the temperature in the passage 507 detected by the back-side temperature sensor 515. Further, the control device 491 is connected to the back-side exhaust device 513 and is configured to be capable of controlling the back-side exhaust device 513. For example, the control device 491 can drive the back-side exhaust device 513 to exhaust air from between the occupant seated on the seat 451 and the seatback 455 via the air passage 495B, or to blow air to the occupant.

Similarly to the tenth embodiment, when there is an input to the switch 445, the control device 491 supplies electric power to the heater 487 of the cushion-side heat storage device 461 and the heater 521 of the back-side heat storage device 495 to cause each of the heaters 487, 521 to generate heat.

When at least one of the temperature acquired by the cushion-side temperature sensor 481 and the temperature acquired by the back-side temperature sensor 515 exceeds a predetermined threshold value, the control device 491 stops the supply of electric power to both of the heaters 487, 521. Thereby, heat generation of each of the heater 487 of the cushion-side heat storage device 461 and the heater 521 of the back-side heat storage device 495 is stopped.

Thereafter, when the temperature acquired by the cushion-side temperature sensor 481 is higher than the temperature acquired by the back-side temperature sensor 515, the control device 491 drives the cushion-side exhaust device 479. Thereby, the air in the passage 473 inside the seat cushion 453 is discharged and is sent into the passage 507 inside the seatback 455 via the cushion-side duct 477 and the back-side duct 511.

When the temperature acquired by the back-side temperature sensor 515 is higher than the temperature acquired by the cushion-side temperature sensor 481, the control device 491 drives the back-side exhaust device 513. Thereby, the air in the passage 507 inside the seatback 455 is discharged and is sent into the passage 473 inside the seat cushion 453 via the back-side duct 511 and the cushion-side duct 477.

Next, the effects of the seat 451 configured as above will be described.

Due to heat generation by the heater 487 of the cushion-side heat storage device 461, thermal energy is stored in the cushion-side heat storage device 461. Due to heat generation by the heater 521 of the back-side heat storage device 495, thermal energy is stored in the back-side heat storage device 495.

The heat storage devices 461, 495 are configured to be capable of being attached to and detached from the receiving recesses 467, 501, respectively. Therefore, the occupant can detach the heat storage devices 461, 495 and effectively use the thermal energy stored therein. For example, the occupant can warm the body with the heat from the heat storage devices 461, 495 outside the vehicle.

Further, in the present embodiment, when at least one of the temperature in the passage 473 of the seat cushion 453 and the temperature in the passage 507 of the seatback 455 exceeds a threshold value, the heat generation of the two heaters 487, 521 is stopped. After the heat generation of each of the heater 487, 521 is stopped, the heat released from the heat storage devices 461, 495 is supplied to the seat cushion 453 and the seatback 455. With the supplied heat, the seat cushion 453 and the seatback 455 are warmed, and lowering of the temperature of each of the seat cushion 453 and the seatback 455 can be suppressed.

However, due to the difference in the amount of heat released from the heat storage devices 461, 495 and/or the difference in the heat capacity between the cushion main body 459 and the back main body 493, a temperature difference may occur between the upper surface (seating surface) of the seat cushion 453 and the front surface (backrest surface) of the seatback 455.

In the present embodiment, the cushion-side duct 477 and the back-side duct 511 are connected to each other, and the passage 507 inside the seatback 455 and the passage 473 inside the seat cushion 453 are connected to each other via these ducts 477, 511. Thereby, the thermal energy stored in the back-side heat storage device 495 and the cushion-side heat storage device 461 can be circulated between the seat cushion 453 and the seatback 455. Therefore, a temperature difference is difficult to occur between the upper surface (seating surface) of the seat cushion 453 and the front surface (backrest surface) of the seatback 455, and the comfort of the seat 451 is enhanced.

In the present invention, when there is a temperature difference between the temperature acquired by the cushion-side temperature sensor 481 and the temperature acquired by the back-side temperature sensor 515, the control device 491 drives an exhaust device (the cushion-side exhaust device 479, the back-side exhaust device 513). Thereby, the air inside the groove on the higher temperature side (one of the groove parts 471, 505) is exhausted by the exhaust device and is sent into the groove on the lower temperature side (the other of the groove parts 471, 505). Thus, the thermal energy can be circulated efficiently between the seat cushion 453 and the seatback 455. Also, equalization of temperature is achieved between the inside of the groove part 505 provided in the seatback 455 and the inside of the groove part 471 provided in the seat cushion 453, whereby the temperature difference between the seating surface and the backrest surface can be suppressed.

### Twelfth Embodiment

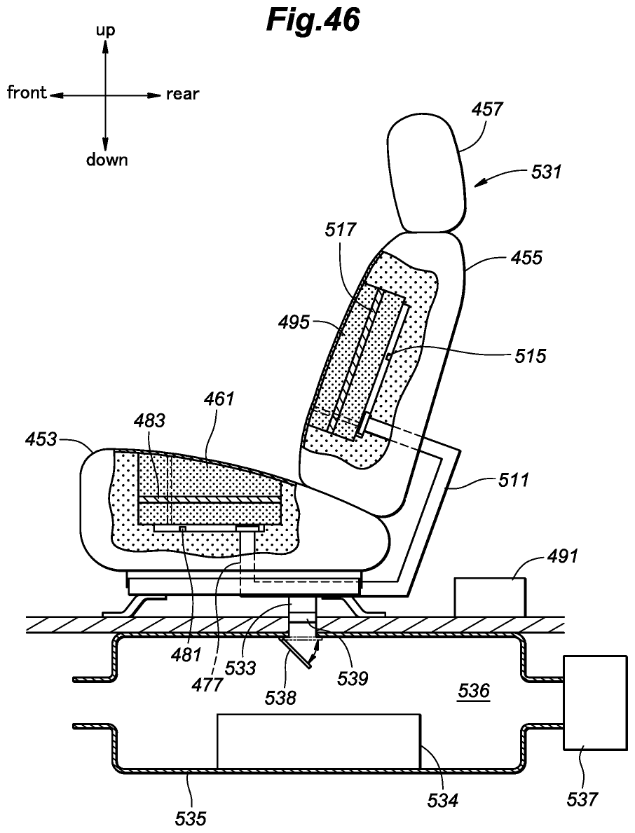

The in-vehicle device according to the twelfth embodiment also constitutes a seat 531 as in the eleventh embodiment. Note however, that, as shown in FIG. 46, the twelfth embodiment differs from the eleventh embodiment in that each of the cushion-side heat storage device 461 and the back-side heat storage device 495 is not provided with the heater 487, and each of the cushion-side duct 477 and the back-side duct 511 is connected to a single duct provided in the floor (hereinafter, the floor duct 533). The other configurations are the same as those of the eleventh embodiment, and thus, the description will be omitted.

The floor duct 533 connects the upper side and the lower side of the floor. On the lower side of the floor, a battery 534 for making the vehicle travel is provided. The battery 534 is placed on a support plate 535 connected to the floor. Between the floor and the support plate 535, an accommodation space 536 for accommodating the battery 534 is formed. On the lower side of the floor, a blower fan 537 for blowing air toward the battery 534 is provided.

The air sent out by the blower fan 537 passes around the battery 534 and flows into the inside of the floor duct 533. When the battery 534 is charged, the battery 534 generates heat, which warms the surroundings of the battery 534. Thus, the temperature of the air flowing into the inside of the floor duct 533 is increased by the heat of the battery 534.

The air that has flown into the inside of the floor duct 533 flows into the cushion-side duct 477 and the back-side duct 511.

The air that has flown into the cushion-side duct 477 passes through the passage 473 inside the seat cushion 405 and reaches the cushion-side heat storage device 461. Thereby, the cushion-side heat storage device 461 is heated, and thermal energy is stored in the cushion-side heat storage part 483 of the cushion-side heat storage device 461.

The air that has flown into the back-side duct 511 passes through the passage 507 inside the seatback 407 and reaches the back-side heat storage device 495. Thereby, the back-side heat storage device 495 is heated, and thermal energy is stored in the back-side heat storage part 517 of the back-side heat storage device 495.

The floor duct 533 may be provided with a shutter 538 for blocking the air flowing from the lower side to the upper side of the floor and an actuator (not shown in the drawings) for opening and closing the shutter 538. In this case, the control device 491 is preferably capable of controlling the actuator for opening and closing the shutter 538. Thereby, when the temperature of the air flowing into the floor duct 533 is lower than the temperature inside the vehicle cabin and thus thermal energy cannot be stored in the cushion-side heat storage device 461 or the back-side heat storage device 495, the control device 491 can close the shutter 538.

The floor duct 533 may be provided with a fan 539 for sending air into the inside of the floor duct 533 from the lower side of the floor. Thereby, the flow rate of the air flowing into the cushion-side duct 477 and the back-side duct 511 from the lower side of the floor is increased, and the cushion-side heat storage device 461 and the back-side heat storage device 495 can promptly store thermal energy.

Next, the effects of the seat 401 configured as above will be described. In the present embodiment, due to the air warmed by the heat of the battery 534, thermal energy is stored in the cushion-side heat storage device 461 and the back-side heat storage device 495. Thus, since the thermal energy generated when the battery 534 is charged or the like can be stored in the cushion-side heat storage device 461 and the back-side heat storage device 495, the thermal energy that would have been wasted can be effectively used.

Further, the thermal energy stored in the cushion-side heat storage device 461 and the back-side heat storage device 495 is released as heat when the temperature of the surroundings is lowered, and thus, electric power consumption can be reduced compared to the case where a heat generating device such as a heater is used.

In the present embodiment, configuration was made such that thermal energy is stored in the cushion-side heat storage device 461 and the back-side heat storage device 495 by the heat of the battery 534, but besides that, configuration may be made such that thermal energy is stored in each of the cushion-side heat storage device 461 and the back-side heat storage device 495 due to the body temperature of the seated person. In that case, preferably, configuration is made such that the seating surface and the backrest surface of the seat 401 have a temperature similar to the person's body temperature due to the heat from the cushion-side heat storage device 461 and the back-side heat storage device 495.

### Thirteenth Embodiment

The in-vehicle device according to the thirteenth embodiment constitutes a door trim 541 provided on a door panel 540 of a vehicle.

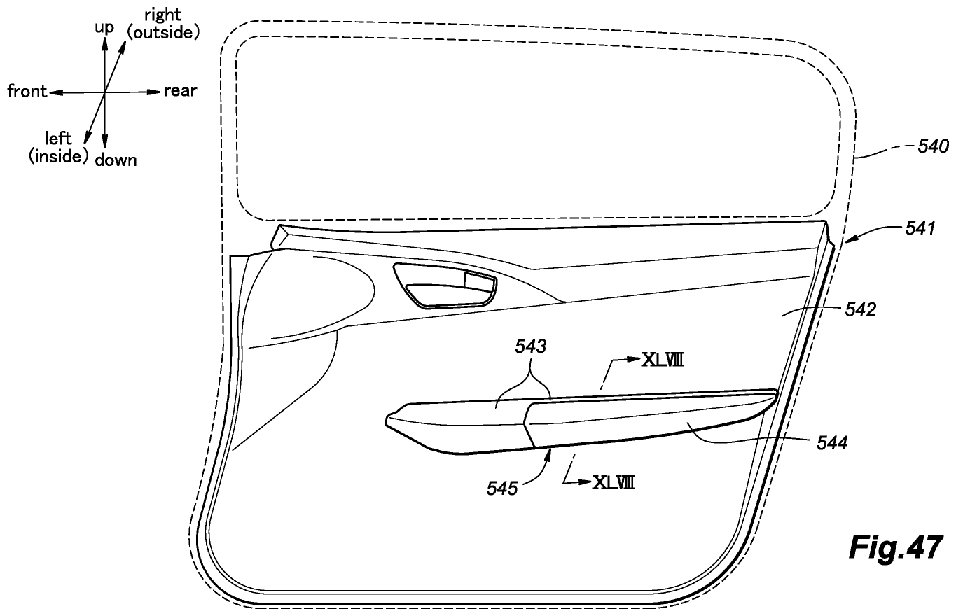

As shown in FIG. 47, the door trim 541 includes a trim main body 542 made of resin and mounted to an inboard side surface of the door panel 540.

The trim main body 542 is formed with a bulging part 543 bulging in the inboard direction from the inboard side surface thereof. The bulging part 543 is provided at a substantially central part of the trim main body 542 in the up-down direction and extends in the front-rear direction.

A heat storage device 544 is provided in a rear portion of the bulging part 543. The heat storage device 544 is configured to be continuous with a front portion of the bulging part 543 and cooperates with bulging part 543 to constitute an armrest 545 that protrudes in the inboard direction.

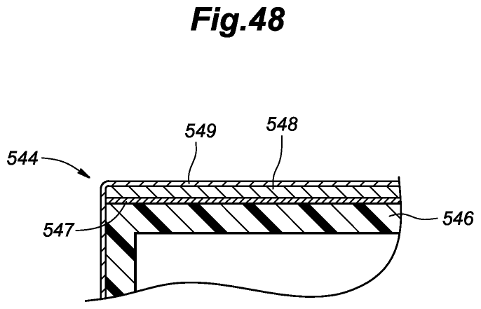

As shown in FIG. 48, the heat storage device 544 includes a base body 546, a heater 547 having a cloth-like shape (sheet shape), a heat storage part 548 disposed to contact the heater 547, and a skin material 549.

The base body 546 is configured to be detachably attached to the rear portion of the bulging part 543. In the present embodiment, the base body 546 is a resin member having a substantially U-shaped cross section, and is provided, at the inboard end portion, with a locking claw (not shown in the drawings) that can be engaged with the rear portion of the bulging part 543.

The heater 547 is fixed to the upper surface of the base body 546. The heat storage part 548 is fixed to the upper surface of the heater 547. The heat storage part 548 includes a latent heat storage material similar to that of the tenth embodiment and can store thermal energy. The skin material 549 is joined to the inboard side surface of the base body 546 and the upper surface of the heat storage part 548 and constitutes the upper surface and the inboard side surface of the heat storage device 544.

Similarly to the tenth embodiment described above, when the vehicle is an electric vehicle that travels with electric power from the battery 534, the heater 547 may be configured such that part of the electric power supplied to the battery 534 when charging is supplied to the heater 547 so that the heater 547 generates heat.

Next, the effects of the door trim 541 configured as above will be described. The heat storage device 544 is configured to be capable of being attached to and detached from the trim main body 542. Therefore, similarly to the tenth embodiment, the occupant can detach the heat storage device 544 after thermal energy is stored therein and use if to warm the body of the occupant, for example. Thus, the thermal energy stored in the heat storage device 544 can be used effectively at various locations.

In the present embodiment, the heat storage device 544 is provided on the inboard side surface of the door trim 541. Therefore, the heat storage device 544 can store thermal energy from the warmed air inside the vehicle cabin. Also, when the temperature inside the vehicle cabin is lowered, the heat storage device 544 releases heat to the inside of the vehicle cabin, and thus, the heat storage device 544 can keep the inside of the vehicle cabin warm.

### Fourteenth Embodiment

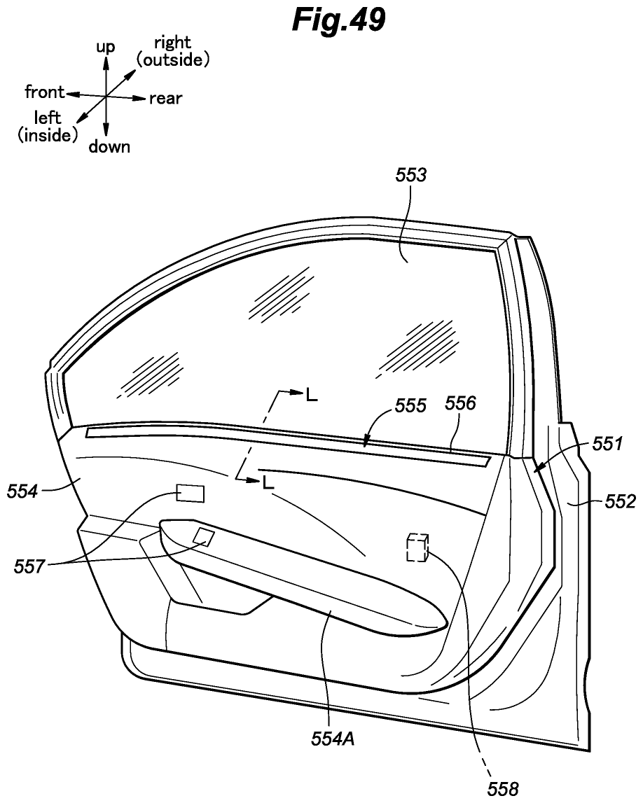

Similarly to the thirteenth embodiment, the in-vehicle device according to the fourteenth embodiment constitutes a door trim 551. As shown in FIG. 49, the door trim 551 is disposed on a lower side of a window 553 provided in a door panel 552.

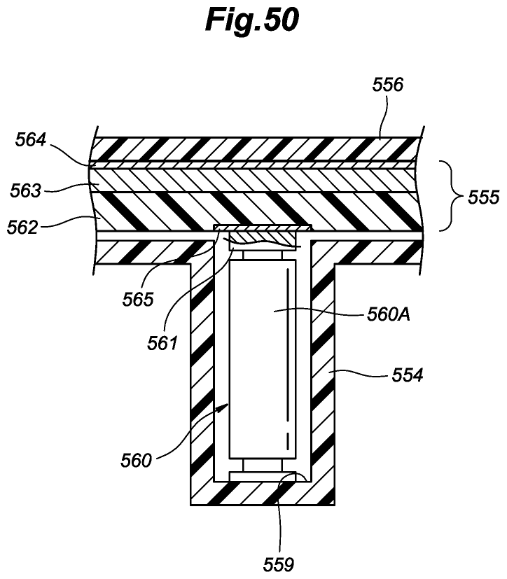

As shown in FIG. 49, the door trim 551 includes a trim main body 554, a heat storage device 555, a cover member 556 (also see FIG. 50), switches 557, and a control device 558. The heat storage device 555 is configured to be capable of being attached to and detached from the vicinity of the upper edge of the trim main body 554. When attached to the trim main body 554, the heat storage device 555 is disposed in a position along the lower edge of the window 553 of the door panel 552.

The trim main body 554 has a substantially plate shape having surfaces facing in the vehicle width direction. The trim main body 554 is fixed, at an edge part thereof, to the inboard side surface of the door panel 552. At a substantially central part of the trim main body 554 in the up-down direction, an armrest 554A that bulges in the inboard side and functions as an armrest is provided.

As shown in FIG. 50, the upper edge of the trim main body 554 is provided with an accommodation recess 559 that is recessed downward. A pressing device 560 is provided in a lower portion of the accommodation recess 559.

The pressing device 560 includes an actuator 560A configured to expand in a predetermined direction. The actuator 560A may be a known linear actuator that uses an air pressure, a ball screw, or the like. The actuator 560A is disposed in the accommodation recess 559 to expand in the up-down direction and is fixed to the bottom surface of the accommodation recess 559 at the lower end (one end in the expansion direction). A magnet 561 is provided on the upper end (the other end in the expansion direction) of the actuator 560A. Due to the expansion of the actuator 560A, the magnet 561 is pushed out upward.

The heat storage device 555 is provided above the pressing device 560. The heat storage device 555 includes a base material 562 made of resin and having a flat plate shape, a heat storage part 563 fixed to the obverse surface of base material 562 at the reverse side thereof, and a skin material 564 covering the obverse side of the heat storage part 563. On the reverse surface of the base material 562, a metal member 565, which is a plate member made of iron and is attracted to the magnet 561, is provided.

The heat storage part 563 includes a latent heat storage material whose phase change is induced upon application of a pressure (pressure-induced phase change). The latent heat storage material is preferably consists of a material that undergoes a phase transition to a phase having a different crystal structure when applied a pressure, such as block-type lambda trititanium pentoxide, for example.

The heat storage device 555 is disposed and mounted to the trim main body 554 such that the obverse surface of the base material 562 is the upper side and the heat storage device 555 extends in the front-rear direction. When the heat storage device 555 is mounted to the trim main body 554, the heat storage device 555 covers the pressing device 560 from above. At this time, the metal member 565 provided on the reverse side of the heat storage device 555 is attracted to the magnet 561 by the magnetic force.

The cover member 556 is made of transparent resin having a flat plate shape. The cover member 556 is provided on the upper side of the heat storage device 555 and constitutes an upper edge of the door trim 551. The cover member 556 is disposed to extend in the front-rear direction and is locked to the trim main body 554 at an edge part thereof.

As shown in FIG. 49, the switches 557 are provided to receive operational inputs from the occupant. In the present embodiment, the switches 557 are provided on the inboard side surface of the trim main body 554 and at a front end of the armrest 554A. The switches 557 may be composed of membrane switches. Also, when a touch panel is provided on the inboard side surface of the trim main body 554, the switches 557 may be composed of buttons displayed on the touch panel. In the present embodiment, each switch 557 is composed of a proximity sensor and/or a touch sensor.

When the switch 557 detects proximity (or touch), the control device 558 causes the actuator 560A to expand to press the heat storage device 555. Thereby, a pressure is applied to the latent heat storage material, and thermal energy is released.

The trim main body 554 may be provided with a heat dissipation fan (not shown in the drawings) for making an adjustment such that the door trim 551 is brought to an appropriate temperature after heat is released from the latent heat storage material.

The control device 558 may be configured to control the driving of the actuator 560A to release heat from the heat storage device 555 according to the signal from a terminal, such as a smartphone, held by the occupant. Thereby, the occupant can make the heat storage device 555 release heat by operating the terminal before getting in the vehicle. The control device 558 may be configured to predict the time when the occupant will get in the vehicle based on a trained model that has learned the getting-in time and to drive the actuator 560A a little before the getting-in time to make the heat storage device 555 release heat.

Next, the effects of the door trim 551 configured as above will be described. The heat storage device 555 is provided on the upper edge of the door trim 551 near the window 553. Therefore, the sunlight entering from the window 553 passes through the cover member 556 to reach the heat storage device 555, warming the heat storage device 555. Thus, the thermal energy from the sunlight is stored in the heat storage device 555.

Thereafter, when the occupant pushes the switch 557, the actuator 560A is driven, and the latent heat storage material is pressurized. Thereby, it is possible to cause the heat storage device 555 to release heat and to take out the thermal energy stored in the heat storage device 555. Therefore, in the case where the temperature inside the vehicle cabin is low when starting the vehicle, for example, the occupant can raise the temperature inside the vehicle cabin without using the electric power from the battery installed in the vehicle.

By applying a force resisting the attraction force between the magnet 561 and the metal member 565 after detaching the cover member 556, the occupant can detach the heat storage device 555 from the trim main body 554. Therefore, as in the tenth embodiment, the occupant can detach the heat storage device 555 after thermal energy is stored therein and take out the thermal energy by pressurizing it as necessary. Concrete embodiments have been described in the foregoing, but the present invention can be modified in various ways without being limited to the above embodiments.

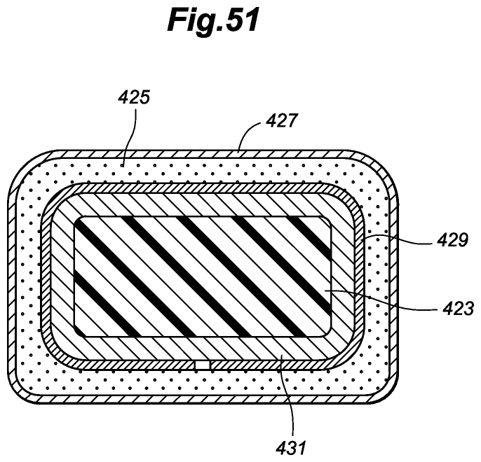

In the tenth embodiment described above, description was made of an example in which the heater 429 was provided on the outer surface of the base material 423 and the heat storage part 431 was provided on the outer surface of the heater 429, but any configuration may be adopted so long as the heat storage part 431 contacts the heater 429. As shown in FIG. 51, configuration in which the heat storage part 431 is provided on the outer surface of the base material 423 and the heater 429 is provided on the outer surface of the heat storage part 431 may be adopted. In this way, since the configuration is made such that the heat storage part 431 and the heater 429 contact each other, the thermal energy generated by the heater 429 can be efficiently stored in the heat storage part 431.

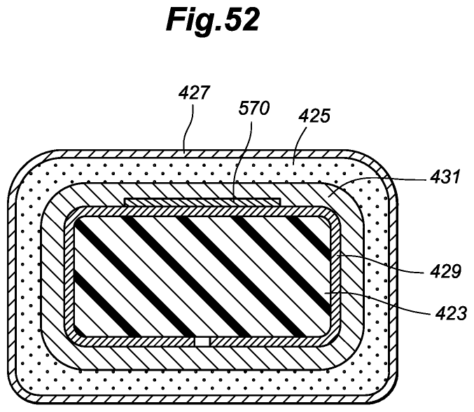

Besides, as shown in FIG. 52, between the base material 423 (main body) and the heat storage part 431, a Peltier element 570 that generates electricity from the temperature difference between the heat storage part 431 and the base material 423 may be provided. The Peltier element 570 may be provided in any position so long as it is between the base material 423 and the heat storage part 431, and the Peltier element 570 may be provided to contact the outer surface of the heater 429 as shown in FIG. 51 or the Peltier element 570 may be joined to the outer surface of the base material 423 on the reverse side of the heater 429. By providing the Peltier element 570, it is possible to convert the thermal energy stored in the heat storage part 431 to electrical energy and to take it out as electric power. The electric power taken out can be used to drive various devices provided on the seat 401, for example. In this way, by converting the heat in the heat storage part 431 to electric power, it is possible to use the thermal energy stored in the heat storage device 555 effectively at various locations.

In the tenth embodiment described above, an example in which the heat storage part 431 was composed of a latent heat storage material that can store heat by phase change between two solid phases having different crystal structures was described, but the latent heat storage material is not limited to this. The latent heat storage material may be composed of a material that can store heat by using insulator-metal phase change, such as vanadium oxide, for example.

The heat storage part 431 may include a latent heat storage material that undergoes phase change upon application of a voltage (voltage-induced phase change). Thereby, it is possible to induce phase change by applying a voltage to the heat storage part 431 and to release the stored thermal energy as heat. Also, the heat storage part 431 may include a material that undergoes phase change upon irradiation of light (light-induced phase change). Thereby, it is possible to induce phase change by irradiating light onto the heat storage part 431 and to release the stored thermal energy as heat.

In the twelfth embodiment described above, each of the cushion-side heat storage device 461 and the back-side heat storage device 495 was configured to store the thermal energy released from the battery, but the present invention is not limited to this aspect. The heat storage devices 461, 495 may be configured to store the heat from electronic equipment, such as the control device 558, for example, as thermal energy.

In the above embodiment, description was made of examples in which the heat storage device 413, 461, 495, 544, 555 was provided on the seat 401, 451, 531 or the door trim 541, 551 installed in the vehicle, but the present invention is not limited to this aspect. It is possible to install heat storage devices 571 each including a latent heat storage material at various locations.

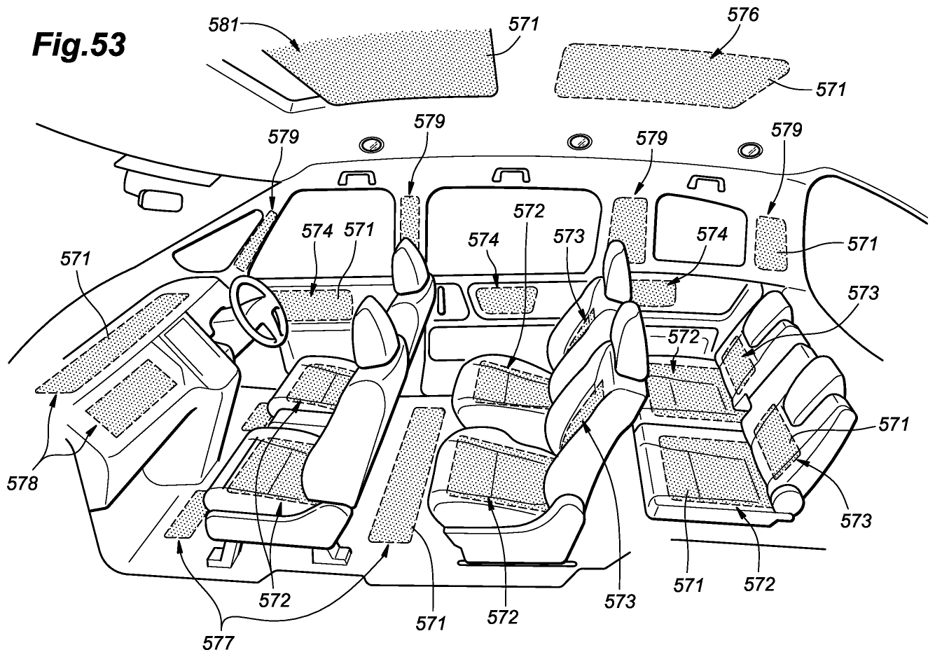

FIG. 53 shows the locations suitable for installation of the heat storage devices 571 by shading. As shown in FIG. 53, the heat storage devices 571 may be detachably provided on inner walls of the vehicle cabin, such as a ceiling 576 of the vehicle cabin, a floor 577, an instrument panel 578, an inboard side surface of each pillar 579, etc., in addition to seat cushions 572, seatbacks 573, and door trims 574. In this way, by providing the heat storage device 571 on the inner walls of the vehicle cabin or the like, it is possible to keep the inside of the vehicle cabin warm. Besides, when the vehicle is provided with a sunroof 581, the heat storage device 413 may be detachably provided on the sunroof 581. Thereby, the heat of the sunlight can be effectively used to store heat in the heat storage device 571. Also, the locations at which the heat storage devices 571 are installed are not limited to inside the vehicle cabin, but they may be installed at any location.

Incidentally, for the purpose of further improving the comfort of the occupant in the vehicle in which the heat storage device as above is installed, it may be conceived to provide a support member for supporting the body of the occupant seated on the seat.

### Fifteenth Embodiment

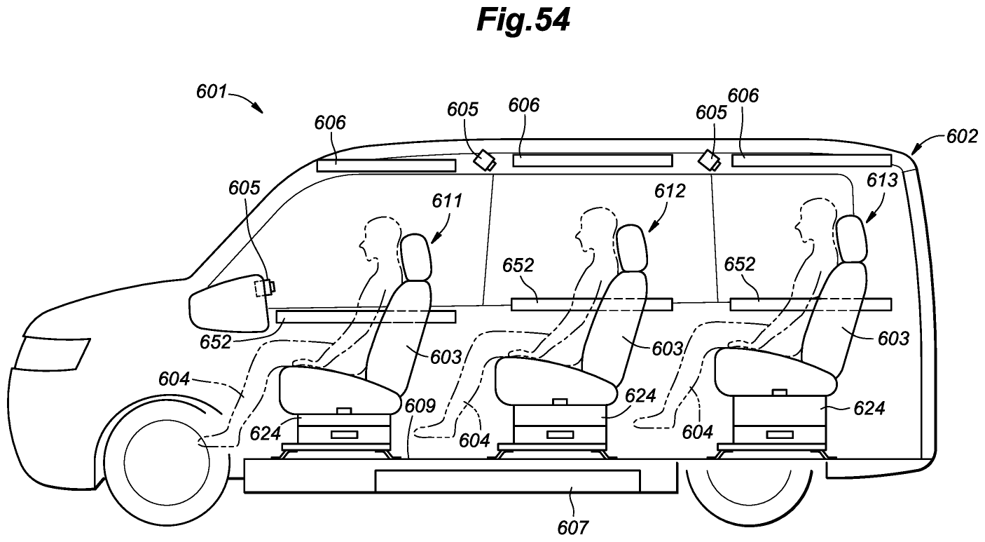

As shown in FIG. 54, a seat system 601 according to the present invention includes seats 603 provided in an automobile (vehicle 602), occupant detection means 605 for detecting occupants 604, support devices 606 for supporting the occupants 604 seated on the seats 603, and a control device 607 for controlling the support devices 606.

The seats 603 are provided on the floor 609 of the cabin of the vehicle 602. The seats 603 may include a driver's seat, a front passenger seat, and rear seats. The seats 603 preferably constitute front seats 611 in the first row, middle seats 612 in the second row, and rear seats 613 in the third row. Preferably, two seats 603 are provided for each row.

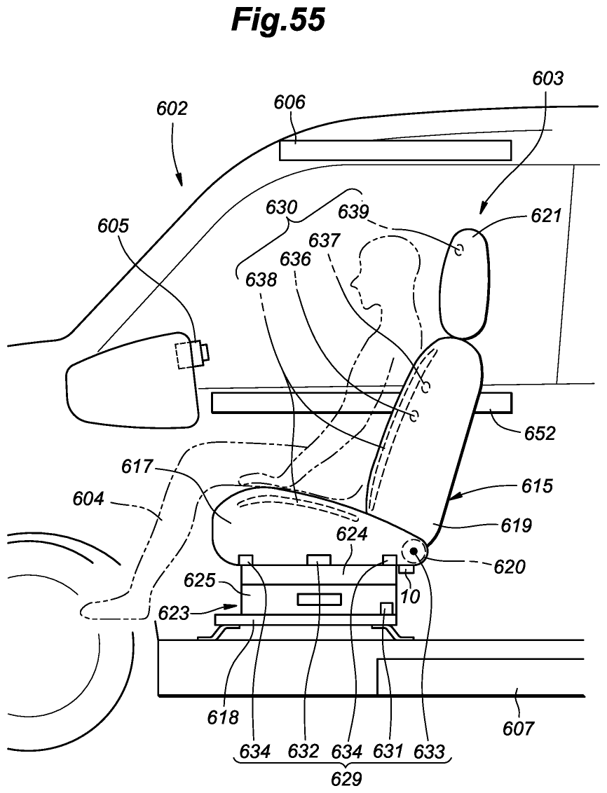

As shown in FIG. 55, each seat 603 includes a seat body 615 displaceable relative to the vehicle body, and a reclining mechanism 620, a slide mechanism 623, a height adjustment mechanism 624, and a rotation mechanism 625 for displacing the seat body 615 relative to the vehicle body.

The seat body 615 includes a seat cushion 617 and a seatback 619 provided above the rear portion of the seat cushion 617. The seat cushion 617 is joined to the vehicle body via a pair of left and right slide rails 618 extending in the front-rear direction. The seatback 619 is connected to the seat cushion 617 via the reclining mechanism 620 so as to be angle-adjustable. A headrest 621 is connected to an upper portion of the seatback 619.

The reclining mechanism 620 tilts the seatback 619 backward relative to the seat cushion 617. The reclining mechanism 620 displaces the seatback 619 between a first reclining position, a second reclining position, and a third reclining position. In the first reclining position, the seatback 619 stands upright relative to the seat cushion 617. In the second reclining position, the seatback 619 is tilted more backward relative to the seat cushion 617 than in the first reclining position. In the third reclining position, the seatback 619 is tilted more backward relative to the seat cushion 617 than in the second reclining position.

The first reclining position, the second reclining position, and the third reclining position may be set to have predetermined angle ranges. For example, the first reclining position may indicate a range from a state in which the seatback 619 stands upright relative to the seat cushion 617 to a state in which the seatback 619 is tilted backward by 30 degrees. The third reclining position may indicate a range from a state in which the seatback 619 is tilted backward by 60 degrees to a state in which the seatback 619 is substantially horizontal relative to the seat cushion 617. The second reclining position may indicate a range between the first reclining position and the third reclining position.

The slide mechanism 623 causes the seat body 615 to slide in the front-rear direction relative to the vehicle body. The slide mechanism 623 displaces the seat body 615 between a first front-rear position, a second front-rear position, and a third front-rear position. In the first front-rear position, the seat body 615 is positioned in the rearmost position on the slide rails 618. In the second front-rear position, the seat body 615 is positioned forward of the first front-rear position on the slide rails 618. In the third front-rear position, the seat body 615 is positioned forward of the second front-rear position on the slide rails 618.

The first front-rear position, the second front-rear position, and the third front-rear position may be set to have predetermined distance ranges. For example, the first front-rear position may indicate a range on the slide rails 618 from the rearmost position in the front-rear direction to the center position in the front-rear direction. The third front-rear position may indicate a range on the slide rails 618 from the frontmost position in the front-rear direction to the position spaced rearward from the frontmost position by one fourth of the length of the slide rails 618. The second front-rear position may indicate a range between the first front-rear position and the third front-rear position.

The height adjustment mechanism 624 displaces the seat body 615 in a substantially vertical direction relative to the vehicle body. The height adjustment mechanism 624 displaces the seat body 615 between a first raised position, a second raised position, and a third raised position. In the first raised position, the seat body 615 is the closest to the floor 609. In the second raised position, the seat body 615 is positioned higher than the first raised position. In the third raised position, the seat body 615 is positioned higher than the second raised position.

The first raised position, the second raised position, and the third raised position may be set to have predetermined distance ranges. For example, the first raised position may indicate an initial position in which the seat body 615 is not raised. The third raised position may indicate a position in which the seat body 615 is fully raised. The second raised position may indicate a range between the first raised position and the third raised position.

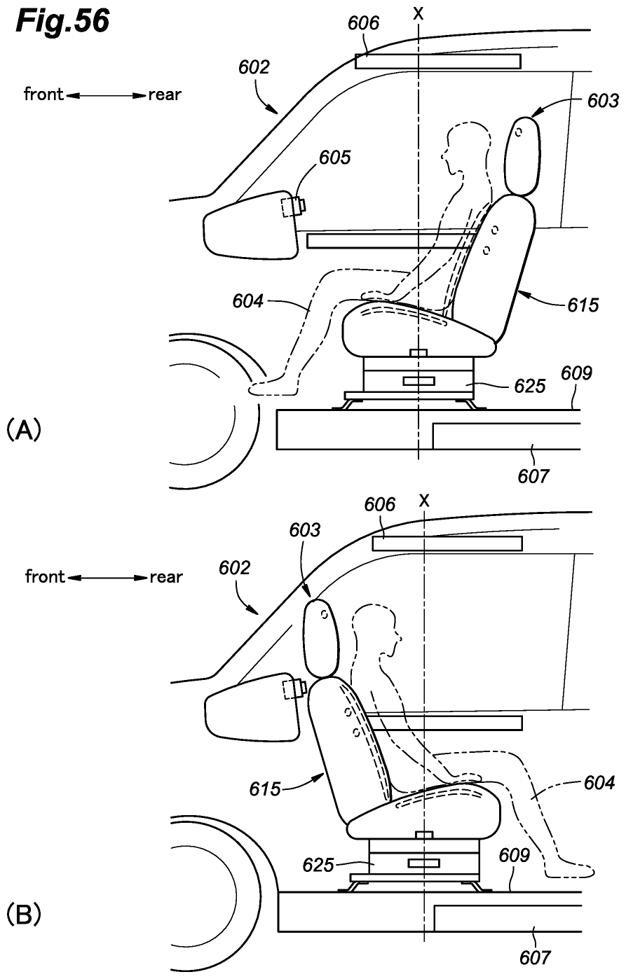

As shown in FIG. 56, the seat body 615 is joined to the vehicle body to be rotatable about an axis X extending in a substantially vertical direction. The seat body 615 is displaceable between a forward facing position (A) in which the seated occupant 604 faces forward and a rearward facing position (B) in which the seated occupant 604 faces rearward. Though not shown in the drawings, the seat body 615 may be configured to be displaceable to a laterally facing position in which the seated occupant 604 faces the center of the vehicle 602 in the left-right direction.

The rotation mechanism 625 rotates the seat body 615 relative to the vehicle body about the axis X and displaces the seat body 615 between the forward facing position, the rearward facing position, and the laterally facing.

As shown in FIG. 55, the seat 603 is provided with a seat sensor 629 for detecting the position of the seat body 615 and an alertness level sensor 630 provided on the seat body 615 to detect the alertness level of the seated occupant 604.

The seat sensor 629 includes a first sensor 631, a second sensor 632, a third sensor 633, and a fourth sensor 634.

The first sensor 631 detects the front-rear position of the seat body 615. The front-rear position indicates the distance (amount of change) by which the seat body 615 is moved forward from the initial position of the seat body 615. In the initial position, the seat body 615 is positioned at the rear end of the slide rails 618. For example, the first sensor 631 preferably consists of multiple proximity sensors disposed below the seat cushion 617. Each of the proximity sensors preferably outputs a detection signal when the seat cushion 617 is at a predetermined distance.

The second sensor 632 detects the height position of the seat body 615 relative to the floor 609. For example, the second sensor 632 consists of multiple proximity sensors provided in a lower portion of the seat cushion 617. Each of the proximity sensors preferably outputs a detection signal when the seat cushion 617 is at a predetermined height relative to the floor 609.

The third sensor 633 detects the reclining position of the seatback 619. The reclining position indicates an angle (amount of change) by which the seatback 619 is tilted backward from the initial position of the seatback 619 relative to the seat cushion 617. In the initial position, the seatback 619 stands upright relative to the seat cushion 617. For example, the third sensor 633 preferably consists of an angle sensor provided on the rotation axis of the seatback 619 relative to the seat cushion 617. The angle sensor is preferably a potentiometer whose electrical resistance changes depending on the angle of the seatback 619 relative to the seat cushion 617.

The fourth sensor 634 detects the tilt position of the seat cushion 617. The tilt position indicates an angle (amount of change) by which the seat cushion 617 is tilted from the initial position of the seat cushion 617 relative to the floor 609. In the initial position, the seat cushion 617 extends horizontally relative to the floor 609. For example, the fourth sensor 634 preferably consists of multiple proximity sensors provided at the front end and the rear end of the lower portion of the seat cushion 617. Each of the proximity sensors preferably outputs a detection signal when the seat cushion 617 is at a predetermined height relative to the floor 609.

The alertness level sensor 630 includes one of a heart rate sensor 636, a respiration sensor 637, a pressure sensor 638, and a brain wave sensor 639.

The heart rate sensor 636 is provided on the front surface of the seatback 619, and is preferably disposed in a position corresponding to the heart of the occupant 604. The heart rate sensor 636 is a sensor that counts the number of times the heart of the occupant 604 beats in a constant time (heart rate), and may be any of a touch type, an optical type, or an electrocardiogram type. The heart rate sensor 636 outputs the detection result as a signal.

The respiration sensor 637 is a sensor for detecting the respiratory rate and the respiratory depth of the occupant 604. For example, it may be conceived to configure the respiration sensor 637 as a type that detects the pressure applied from the occupant 604 in a position of the front surface of the seatback 619 corresponding to the lungs of the occupant 604 and reads the pressure change caused by respiratory motion of the occupant 604 or a type including two sheet-shaped electrodes disposed along the front surface of the seatback 619 to detect a fluctuation of the electrostatic capacitance between the two electrodes due to the motion of the chest, but the respiration sensor 637 may be of any type. The respiration sensor 637 outputs the detection result as a signal.

The pressure sensor 638 is a sensor used to detect the posture of the occupant 604 based on the pressure applied to the seat body 615. The pressure sensor 638 has a planar shape, is provided on the surfaces of the seat cushion 617 and the seatback 619 opposing the occupant 604, and measures the in-plane distribution of the pressure (pressure distribution) applied from the occupant 604 to them, thereby to detect the posture of the occupant 604. The pressure sensor 638 outputs the detection result as a signal.

The brain wave sensor 639 includes a magnetic sensor provided in a position of the headrest 621 opposing the head of the occupant 604, detects the magnetic signal associated with brain cell activity of the occupant 604, and calculates brain waves of the occupant 604. By using the alertness level sensor 630 including any of these sensors, it is possible to properly detect the alertness level of the occupant 604. The brain wave sensor 639 outputs the detection result as a signal.

As shown in FIG. 54, the occupant detection means 605 includes at least one of a vehicle-mounted camera for capturing an image inside the vehicle cabin, an infrared sensor, and a door opening/closing sensor. The occupant detection means 605 is connected to the control device 607 and outputs a signal to the control device 607. FIG. 54 shows, as one example, an example in which the occupant detection means 605 is a vehicle-mounted camera.

The vehicle-mounted camera captures an image of the seat 603 to be a target and outputs the image information to the control device 607. The control device 607 analyzes the image information from the vehicle-mounted camera with a predetermined program and detects whether the occupant 604 is seated on the seat 603. The vehicle-mounted camera is preferably provided on the roof or the windshield forming an upper portion of the vehicle cabin.

The infrared sensor includes an irradiation unit that irradiates infrared light toward the seat 603 and a detection unit that detects the infrared light reflected from the seat 603. When the occupant 604 is seated on the seat 603, the infrared reflected light detected by the detection unit changes. The detection unit of the infrared sensor outputs a signal corresponding to the strength of the detected infrared light to the control device 607. The control device 607 detects whether the occupant 604 is seated on the seat 603 based on the signal from the infrared sensor.

The occupant detection means 605 may be a sensor provided on the seat 603. For example, the occupant detection means 605 may be a seatbelt sensor. The seatbelt sensor includes a circuit that is opened and closed according to connection and separation of the tongue and buckle of the seatbelt, and outputs a signal corresponding to connection of the tongue and buckle of the seatbelt to the control device 607. The control device 607 detects whether the occupant 604 is seated on the seat 603 based on the signal from the seatbelt sensor. Also, the pressure sensor 638 may function as the occupant detection means 605.

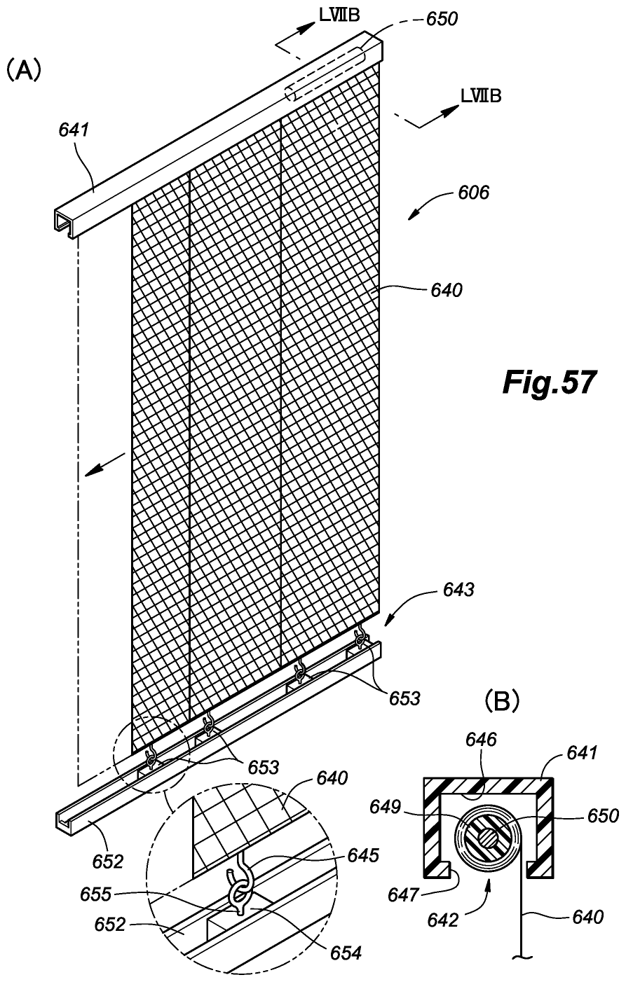

As shown in FIGS. 57 and 69-61, each support device 606 includes a housing 641 mounted to the vehicle body, a support member 640 to be accommodated in the housing 641, and a first deployment mechanism 642 and a second deployment mechanism 643 for deploying the support member 640.

The housing 641 is formed in a columnar shape extending in the front-rear direction and defines a containment chamber 646 therein. In the containment chamber 646, a tube 649 is supported. A lower portion of the housing 641 is formed with an opening 647 that is opened downward. Preferably, the housing 641 is mounted to an upper portion of the vehicle body. For example, the housing 641 is preferably mounted to the roof, the door, the seat 603, or the like.

The tube 649 is a cylindrical member holding the support member 640 and is rotatably supported by the housing 641. The support member 640 is connected to the tube 649. The support member 640 may be connected at one end thereof to be slidingly movable in the front-rear direction relative to the tube 649. Also, the one end of the support member 640 may be fixed to the tube 649, and the tube 649 may be provided to be displaceable in the front-rear direction relative to the housing 641.

The support member 640 is a sheet-shaped member and, as shown in FIG. 57(B), is contained in the housing 641 by being wound around an outer circumferential surface of the tube 649. In the following, a state in which the support member 640 is stowed in the housing 641 (stowed state) will be referred to as a first state. The support member 640 is fed out from the opening 647 of the housing 641 when the tube 649 is rotated.

The first deployment mechanism 642 downwardly feeds out the support member 640 stowed in the housing 641. The first deployment mechanism 642 includes the tube 649 and a motor 650 for rotating the tube 649.

The motor 650 rotates the tube 649. Thereby, the feeding length of the support member 640 from the housing 641 is adjusted. For example, the motor 650 preferably feeds out the support member 640 from the housing 641 by forward rotating the tube 649 and takes up the support member 640 to be stowed in the housing 641 by reverse rotating the tube 649. The motor 650 is preferably provided in the cylinder of the tube 649.

As shown in FIG. 57(A), multiple attachment parts 645 (for example, hooks) are attached to the other end of the support member 640. The multiple attachment parts 645 hold the support member 640 in the deployed state by being locked to the vehicle body. In the following, the state in which the support member 640 is fed out and extends vertically will be referred to as a second state.

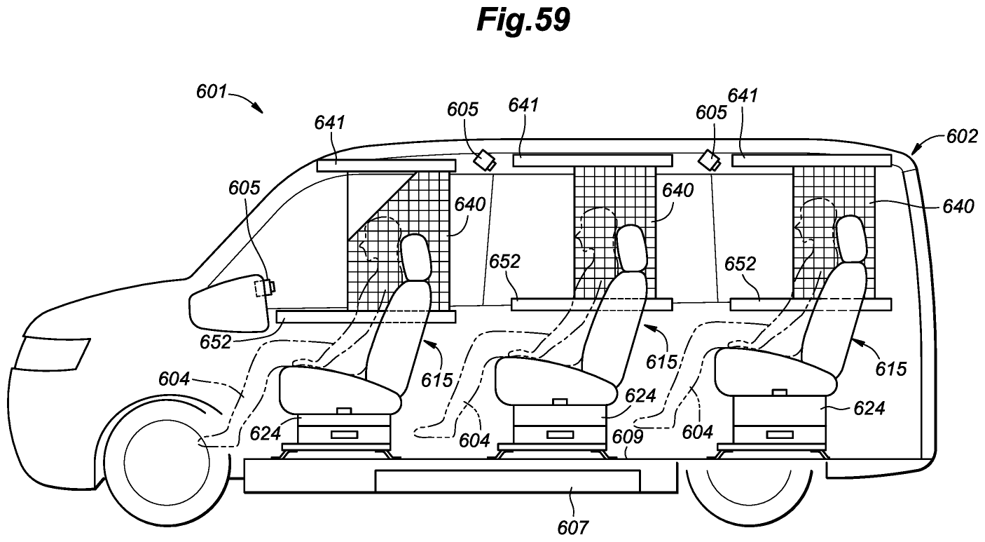

In this way, the support member 640 is configured to be displaceable between the stowed position in which the support member 640 is stowed in the housing 641 and the deployed position in which the support member 640 is fed out from the housing 641. As shown in FIGS. 59-61, in the deployed state, the support member 640 extends in the up-down and front-rear directions and thereby supports the upper body or the head of the occupant 604 seated on the seat 603 from the side (see FIGS. 57-59). To secure the field of vision of the occupant 604, the support member 640 is preferably composed of a net, a light transmissive sheet, or the like, for example. The support member 640 may be composed of a single member or may be composed of multiple members.

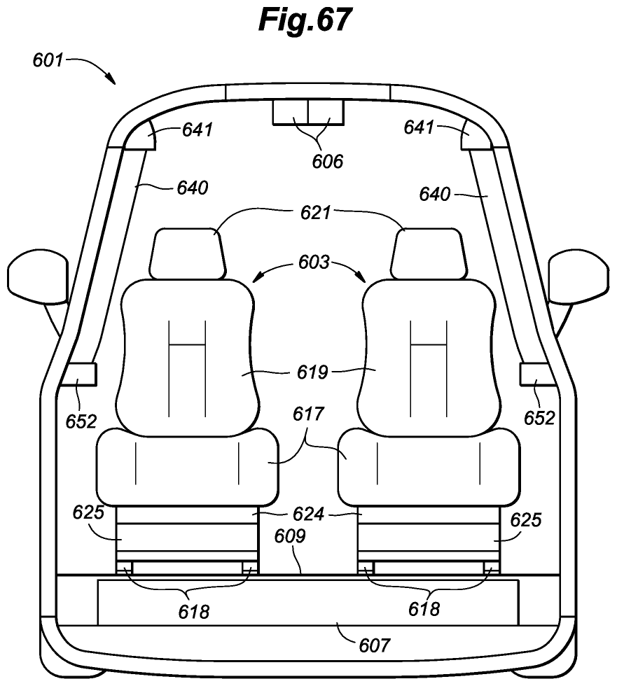

As shown in FIG. 67, the second deployment mechanism 643 deploys the support member 640 in the second state forward. The second deployment mechanism 643 includes a guide rail 652 extending in the front-rear direction and multiple holding parts 653 slidably mounted to the guide rail 652.

The guide rail 652 guides the movement of the support member 640 in the front-rear direction. Preferably, the guide rail 652 has substantially the same length as the housing 641 and extends in parallel with the housing 641. The guide rail 652 is preferably mounted to the side portion or the lower portion of the vehicle body. In the present embodiment, the housing 641 is mounted to the door.

Each of the multiple holding parts 653 includes a holding part main body 654 slidably mounted to the guide rail 652 and a pin 655 extending upward from the holding part main body 654.

The holding part main body 654 moves in the front-rear direction along the guide rail 652. The holding part main body 654 may include a locking mechanism configured to be locked to the guide rail 652 in a predetermined position in the front-rear direction.

The pin 655 is engaged with a corresponding one of the multiple attachment parts 645. For example, the pin 655 is preferably a ring pin. With the engagement of the pin 655 and the attachment part 645, the support member 640 can be deployed in the front-rear direction along the guide rail 652.

Next, deployment operation of the support device 606 configured as described above will be described.

When the motor 650 is driven in the first state of the support member 640, the tube 649 rotates. As a result of the rotation of the tube 649, the support member 640 is fed out downward. Thereby, the support member 640 is deployed in the up-down direction.

When the lower end of the support member 640 reaches the vicinity of the guide rail 652 (the second state), the occupant 604 preferably engages each of the multiple attachment parts 645 with the corresponding pin 655. Thereby, the support member 640 becomes able to support the occupant 604.

The engagement of each attachment part 645 with the corresponding pin 655 may be performed by any other known method. For example, it may be possible to provide each attachment part 645 and the corresponding pin 655 with a pair of magnets so that they are engaged by magnetic force. Also, the vehicle body may be provided with another configuration for fixing the support member 640.

After the attachment parts 645 are engaged with the pins 655, the motor 650 preferably reverse rotates the tube 649 to take up the support member 640. For example, the motor 650 preferably rotates the tube 649 one turn in the take-up direction. Thereby, the support member 640 can be tightened in the up-down direction without loosening. Thus, the support member 640 can reliably support the occupant 604.

When the multiple holding parts 653 move forward along the guide rail 652, the support member 640 is deployed laterally from the second state (the third state). If the support member 640 is further deployed from the third state, the holding part 653 reaches the front end of the guide rail 652, and a fourth state is reached. In the third state, the support member 640 extends more widely in the front-rear direction than in the second state. In the fourth state, the support member 640 extends more widely in the front-rear direction than in the third state.

In this way, the support member 640 can be deployed from the first state, which is the stowed state, to the second state, the third state, and the fourth state.

As shown in FIG. 54, the control device 607 is connected to the occupant detection means 605, the seat sensor 629, the alertness level sensor 630, and the support device 606. Based on the detection result of the occupant detection means 605, the seat sensor 629, and the alertness level sensor 630, the control device 607 controls the support device 606 which is provided to correspond to each seat 603. The control device 607 is an electronic control unit (ECU) composed of a microcomputer, a ROM, a RAM, peripheral circuits, an input/output interface, drivers, etc. The control device 607 may be disposed in an arbitrary position of the vehicle 602. In the present embodiment, the control device 607 is provided in a lower portion of the vehicle body.

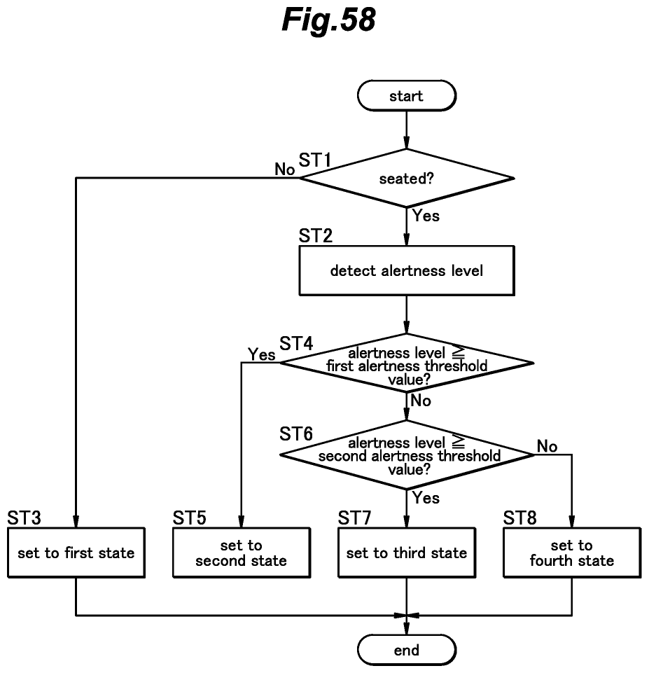

When an ACC power supply of the vehicle 602 is activated, the control device 607 executes a support device control process shown in FIG. 58. In the following, the support device control process will be described with reference to FIG. 58.

The control device 607 first determines whether the occupant 604 is seated on the seat 603 based on the output of the occupant detection means 605 (ST1). When it is determined in ST1 that the occupant 604 is seated on the seat 603 (the result of ST1 is Yes), the control device 607 executes ST2. When it is determined in ST1 that the occupant 604 is not seated on the seat 603 (the result of ST1 is No), the control device 607 drives the support device 606 to set the support member 640 to the first state (ST3).

In ST2, the control device 607 detects the alertness level of the occupant 604. The alertness level is defined to be 0 when the occupant 604 is in a deep sleep and to have an increasing numerical value as the occupant becomes more alert. In the case where the alertness level sensor 630 is the heart rate sensor 636, preferably, the control device 607 compares the current heart rate of the occupant 604 with the heart rate of the occupant 604 at the start of detection and lowers the alertness level depending on the degree of decrease of the heart rate. In the case where the alertness level sensor 630 is the respiration sensor 637, preferably, the control device 607 compares the current respiratory rate of the occupant 604 with the respiratory rate of the occupant 604 at the start of detection and lowers the alertness level depending on the degree of decrease of the respiratory rate. In the case where the alertness level sensor 630 is the pressure sensor 638, preferably, the control device 607 detects the posture of the occupant 604 based on the pressure distribution and calculates the alertness level of the occupant 604 based on the posture. In the case where the alertness level sensor 630 is the brain wave sensor 639, preferably, the control device 607 calculates the alertness level of the occupant 604 based on the brain wave waveform of the occupant 604. Also, the control device 607 may calculate the alertness level of the occupant 604 by using two or more of the heart rate, the respiratory rate, the pressure distribution, and, the brain waves. When the control device 607 has detected the alertness level of the occupant 604 based on the output of the alertness level sensor 630, such as the heart rate, the respiratory rate, the posture, and the brain waves, and the detection has been completed, the control device 607 executes ST4.

In ST4, the control device 607 determines whether the alertness level of the occupant 604 is greater than or equal to a first alertness threshold value. The first alertness threshold value is preferably defined as a value of the alertness level of the occupant 604 when the occupant 604 feels sleepy. When the alertness level is greater than or equal to the first alertness threshold value (the result of ST4 is Yes), the control device 607 drives the support device 606 to set the support member 640 to the second state (ST5). When the alertness level is less than the first alertness threshold value (the result of ST4 is No), the control device 607 executes ST6.

In ST6, the control device 607 determines whether the alertness level of the occupant 604 is greater than or equal to a second alertness threshold value. The second alertness threshold value is preferably defined as a value of the alertness level of the occupant 604 when the occupant 604 is asleep, which is smaller than the first alertness threshold value. When the alertness level is greater than or equal to the second alertness threshold value (the result of ST6 is Yes), the control device 607 drives the support device 606 to set the support member 640 to the third state (ST7). When the alertness level is less than the second alertness threshold value (the result of ST6 is No), the control device 607 drives the support device 606 to set the support member 640 to the fourth state (ST8).

The control device 607 preferably executes the above-described support device control process repeatedly until the ACC power supply of the vehicle 602 is turned off. The control device 607 preferably executes the support device control process at a predetermined time interval. For example, the control device 607 preferably executes the support device control process once a minute.

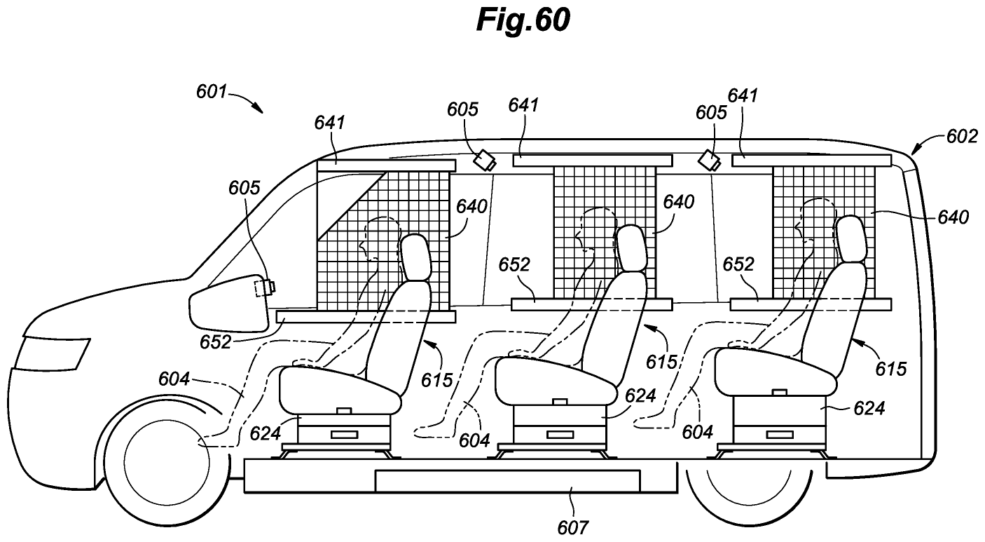

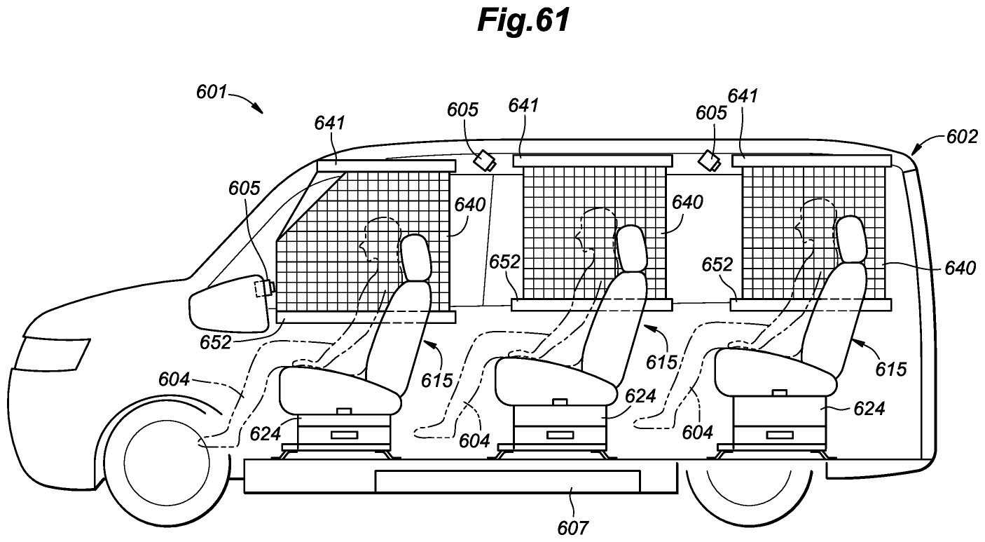

With the configuration described above, the seat system 601 can control the support device 606 based on the alertness level of the occupant 604 to deploy the support member 640 from the first state shown in FIG. 54 to the second state (FIG. 59), the third state (FIG. 60), and the fourth state (FIG. 61). Also, when the occupant 604 is not seated on the seat 603, the support member 640 can be stowed in the housing 641.

### Sixteenth Embodiment

The seat system 601 according to the sixteenth embodiment differs from the seat system 601 according to the fifteenth embodiment in that the control device 607 executes, in the support device control process, ST12 instead of ST2, ST14 instead of ST4, and ST16 instead of ST6. In the following, the configurations same as those of the fifteenth embodiment will be denoted by the same reference signs and the description will be omitted.

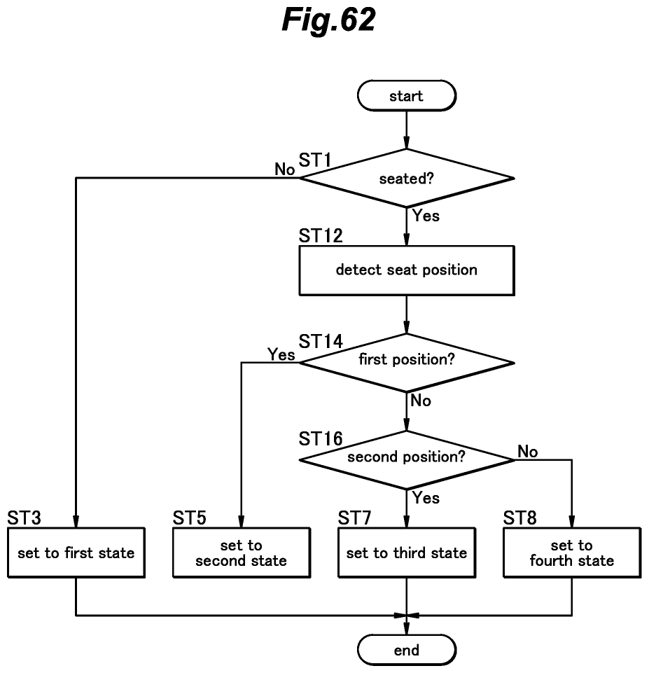

As shown in FIG. 62, when it is determined in ST1 that the occupant 604 is seated on the seat 603 (the result of ST1 is Yes), the control device 607 executes ST12. When it is determined in ST1 that the occupant 604 is not seated on the seat 603 (the result of ST1 is No), the control device 607 executes ST3.

In ST12, the control device 607 detects the seat position of the occupant 604. The control device 607 performs various calculations based on the output of the seat sensor 629 and detects the seat position. For example, in the case where the control device 607 executes the process of ST12 based on the output of the fourth sensor 634, preferably, the control device 607 detects the tilt position of the seat cushion 617. In this case, preferably, the control device 607 detects the tilt position of the seat cushion 617 by comparing the detection result of the fourth sensor 634 provided at the front end of the lower portion of the seat cushion 617 with the output result of the fourth sensor 634 provided at the rear end of the same. When the detection is completed, the control device 607 executes ST14.

In ST14, the control device 607 determines whether the seat position is in a first position. For example, in the case where the control device 607 executes the process of ST14 based on the output of the third sensor 633, preferably, the control device 607 determines whether the seatback 619 is in the first reclining position. When the seat position is in the first position (the result of ST14 is Yes), the control device 607 drives the support device 606 to set the support member 640 to the second state (ST5). When the seat position is not in the first position (the result of ST14 is No), the control device 607 executes ST16.

In ST16, the control device 607 determines whether the seat position is in a second position. For example, in the case whether the control device 607 executes the process of ST16 based on the output of the second sensor 632, preferably, the control device 607 determines whether the seat body 615 is in the second raised position. When the seat position is in the second position (the result of ST16 is Yes), the control device 607 drives the support device 606 to set the support member 640 to the third state (ST7). When the seat position is not in the second position (the result of ST16 is No), the control device 607 determines that the seat position is in a third position and drives the support device 606 to set the support member 640 to the fourth state (ST8).

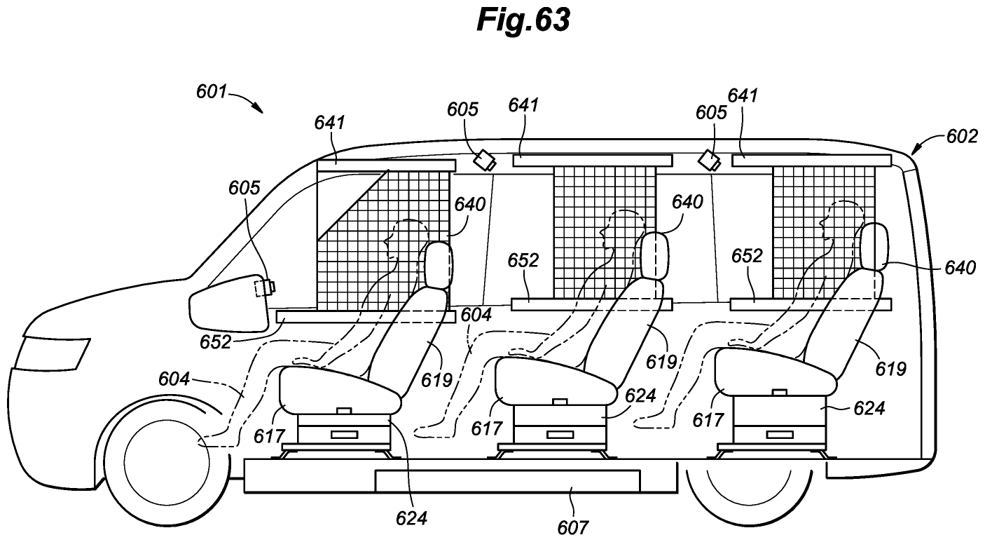

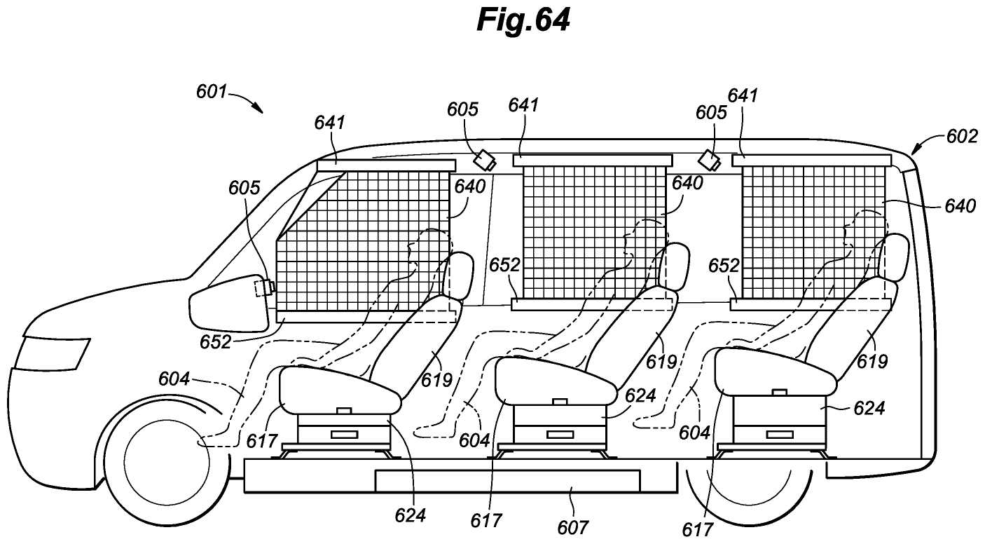

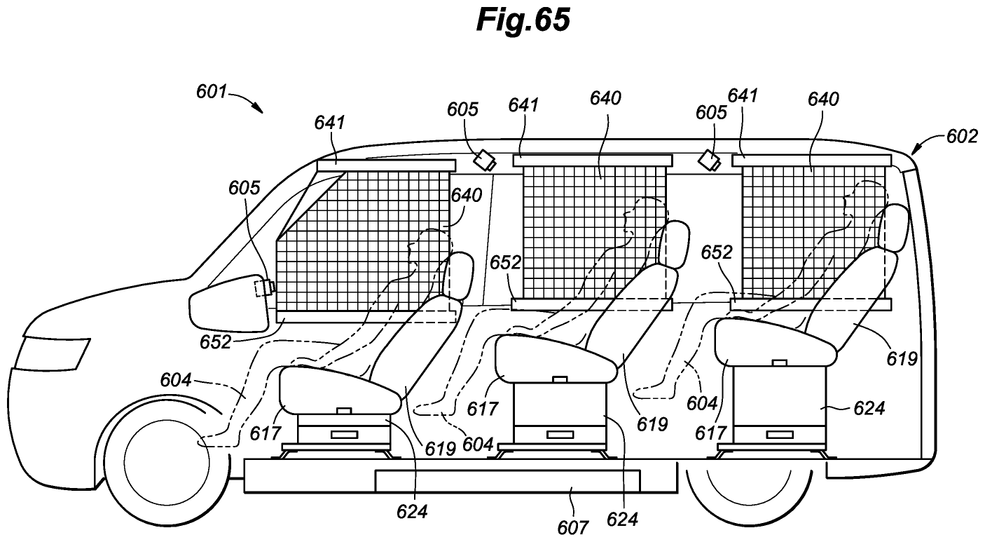

According to this configuration, as shown in FIG. 63 (the second reclining position), FIG. 64 (the third reclining position), and FIG. 65 (the third reclining position and the raised seat position), the control device 607 can control the support device 606 according to the raised position of the seat body 615, the reclining position of the seatback 619, etc.

Though not shown in the drawings, as described above, the control device 607 may control the support device 606 based on the front-rear position of the seat body 615 or the tilt state of the seat cushion 617. The control device 607 may detect the seat position by combining multiple seat sensors 629.

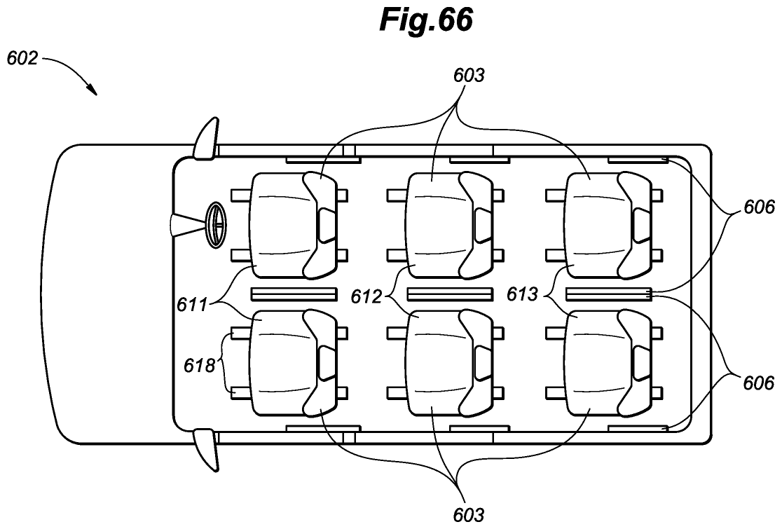

Also, as shown in FIGS. 66 and 67, the support device 606 may be disposed between two seats 603 that are arranged left and right. The support member 640 is preferably provided in a position where the support member 640 when deployed avoids the mounting positions of airbags provided in the seat 603 (for example, left and right side portions of the seatback 619).

Embodiments have been described in the foregoing, but the present invention can be modified in various ways without being limited to the above embodiments. The vehicle 602 may be provided with an input device for receiving input from the occupant 604, and the support device 606 may be controlled according to an operation of the occupant 604 on the input device. The vehicle 602 may be an autonomous vehicle, and the support member 640 may be set to the second state, the third state, or the fourth state in response to switching to autonomous driving.

### LIST OF REFERENCE NUMERALS

1: seat (vehicle seat)
23 pad
24: skin material
26 side frame
27: upper frame
41: device
51: first member (wire member)
52: second member (plate member)
54A: first part
54B: second part
55: bent part
58 upper surface (support surface)
60 speaker
61: case
62: sound absorbing member
71: first hole
72: second hole

1. A vehicle seat, comprising:
left and right side frames extending vertically;
an upper frame extending laterally and connecting upper end portions of the side frames to each other;
a wire member attached to one of the side frames and to the upper frame;
a plate member connected to the wire member and provided with a support surface; and
a device supported by the support surface.

2. The vehicle seat according to claim 1, wherein the plate member is disposed forward of the upper frame and closer to a center of the seat than the one of the side frames is in a left-right direction.

3. The vehicle seat according to claim 1, wherein the wire member is attached to a front portion of the one of the side frames and to a lower portion of the upper frame.

4. The vehicle seat according to claim 1, wherein the plate member is disposed to be spaced from the one of the side frames and the upper frame.

5. The vehicle seat according to claim 1, wherein the wire member and the plate member are formed integrally.

6. The vehicle seat according to claim 1, wherein the wire member is welded to the one of the side frames and to the upper frame.

7. The vehicle seat according to claim 1, wherein the wire member includes a first part extending from the one of the side frames toward the center of the seat in the left-right direction, a second part extending forward from the upper frame, and a bent part formed by connection between the first part and the second part, and
the plate member is attached to an upper portion of the bent part at a surface thereof opposite from the support surface.

8. The vehicle seat according to claim 7, wherein the support surface is slanted forward and toward the one of the side frames in the left-right direction.

9. The vehicle seat according to claim 6, comprising a pad supported by the side frames and the upper frame, and a skin material covering the pad,
wherein the pad has a first hole opened at an upper portion thereof and formed to extend downward,
the skin material has a second hole formed in a position corresponding to the first hole in a front-rear direction and the left-right direction, and
at least a part of the device is inserted in the first hole and the second hole.

10. The vehicle seat according to claim 1, wherein the device comprises a speaker, a sound absorbing member, and a case accommodating the speaker and the sound absorbing member therein and attached to the plate member, and
the sound absorbing member is disposed between the speaker and the case.

11. The vehicle seat according to claim 10, comprising:
another wire member attached to another of the side frames and to the upper frame;
another plate member connected to the wire member and provided with a support surface; and
another device supported by the support surface.
